(19) United States
(12) Patent Application Publication
(10) Pub. No.: US 2007/0004363 A1
(43) Pub. Date: Jan. 4, 2007

(54) Radio lan antenna

(76) Inventors: Takuya Kusaka, Hyogo (JP); Masakatsu Maruyama, Hyogo (JP); Chitaka Manabe, Hyogo (JP); Yoshito Fukumoto, Hyogo (JP); Naoki Tamura, Hyogo (JP)

Correspondence Address: REED SMITH LLP, 3110 FAIRVIEW PARK DRIVE, SUITE 1400, FALLS CHURCH, VA, 22042, US

(21) Appl. No.: 10/556,425

(22) PCT Filed: Apr. 12, 2004
(86) PCT No.: PCT/JP04/05229

§ 371 Date: Nov. 9, 2005

(30) Foreign Application Priority Data
May 12, 2003 (JP) 2003133294

(51) Int. Cl. H04B 1/06; H04B 1/38; H04B 7/00

(52) U.S. Cl. 455/269; 455/559; 455/575.7

(57) ABSTRACT

A high-frequency micro-strip line for transmitting a high-frequency wave for a wireless LAN system has a layered structure where, on a ground layer made of a conductive material, a dielectric layer made of a dielectric material and a signal line made of a conductive material are successively laid. The high-frequency micro-strip line further includes a patch antenna comprising a dielectric plate made of a dielectric material and a patch made of a conductive material, which are successively laid into a layered structure, the patch antenna being electrically connected to the signal line. A wireless-communication RF signal transmission device capable of being applied to such a line is also provided.

### TECHNICAL FIELD

The present invention relates to a high-frequency micro-strip line, a wireless LAN mobile-station terminal antenna, a wireless LAN card for a terminal, a wireless LAN system, and a wireless-communication RF signal transmission device, which are applied to a wireless LAN system forming a radio communication network and are used for propagating signals of high-frequency electromagnetic waves in a radio frequency band (hereinafter also referred to simply as “electromagnetic waves” or “high-frequency waves”).

### BACKGROUND ART

Recently, with the progress toward more advanced information society, a wireless LAN (Local Area Network) system forming a radio communication network in a certain area has been increasingly used in various fields including not only indoor uses, e.g., offices in buildings etc., factories, warehouses and other yards, as well as general houses and business premises, but also uses other than the indoor uses, such as arcades in shopping districts etc., station platforms, airport terminals, and large-sized temporary structures, event sites, etc. in the form of tents or the likes.

In the wireless LAN system, communication is performed between a wireless LAN base unit and a large number of wireless LAN slave units, which are distributed within the area, by using a high-frequency wave in a wide frequency band.

To perform the communication, a high-frequency waveguide (high-frequency line) is essential, and it is usually formed of a tubular waveguide made of a conductive metal, such as stainless, steel, copper or aluminum, or formed of a microwave transmission line, such as a coaxial cable, other than the tubular waveguide.

However, because the tubular waveguide and the coaxial cable used as high-frequency lines have relatively large sectional areas and volumes in themselves, they require a relatively large space when installed. Furthermore, time, labor and an overall cost including an installation cost are increased in proportion to the length of high-frequency lines required in the area.

Furthermore, for connection of antennas for transmitting and receiving high-frequency waves which are directed to the inside of the area, a plurality of branch circuits must be provided on the high-frequency line (waveguide) by cutting the waveguide at intermediate points. Providing the branch circuits on the tubular waveguide or the coaxial cable, however, also pushes up the overall cost to such an extent as comparable to the installation of the high-frequency line itself.

Thus, in situations up to now, the above-described restrictions in the known structures of high-frequency lines have posed limitations in installing and employing the wireless LAN system in target places or various local areas, thereby causing serious limitations in increasing applications of the wireless LAN system.

Stated another way, much more widespread use of the wireless LAN system is expected if a high-frequency line in the form of a strip or the like is realized which requires a not so large space and can be simply installed.

As such a strip-like high-frequency line, there is already known a radiant electric-wave leakage cable or a high-frequency micro-strip line or a micro-strip antenna, which is in the form of a strip-like high-frequency line comprising an outer conductor and an inner conductor with a plurality of radiation elements (antennas and holes) formed at predetermined intervals. Then, electric waves are leaked or radiated from the plurality of radiation elements.

However, that known strip-like high-frequency line has no flexibility and cannot be in itself freely deformed depending on the intention in use. For this reason, although the known strip-like high-frequency line can be used in a linear and micro-sized area on a circuit board, it is not suitable for the case purported by the present invention, in which the wireless LAN system is installed in a certain macro-sized area while deforming the high-frequency line so as to, for example, ride over or bypass obstacles depending on installation conditions in the area. Further, handling of the known strip-like high-frequency line, such as required in the installation work and transportation to the installation place, is also troublesome.

In view of that situation, the inventors have previously proposed a flexible high-frequency micro-strip line (hereinafter also referred to simply as a “high-frequency line”), which comprises a long dielectric layer made of a dielectric material and a pair of ground layers made of a conductive material and sandwiching the dielectric layer. A signal line is disposed in the dielectric layer to extend in the lengthwise direction of the dielectric layer, and an opening for high-frequency coupling is formed in a part of the ground layer.

The proposed high-frequency line is easy to handle in transportation, installation and other works because it has a small thickness, is compact, and can be wound into the form of a coil if the line is made of a flexible material. Also, by attaching a patch antenna to the opening, it is possible to easily attach or detach the antenna to the high-frequency line, and to simply adjust primary characteristics, such as a coupling factor and a gain of the antenna.

However, because of having the sectional structure in which the dielectric layer is sandwiched by the pair of ground layers and the signal line is disposed in the dielectric layer, the proposed high-frequency line has a problem that a relatively short line can be manufactured inexpensively, but the cost in manufacturing a relatively long line is increased with a current level of manufacturing techniques. Assuming, for example, that the wireless LAN system is installed using a single line to cover the length of one room, the single line is required to have a length of 2-5 m or over at minimum. With a current level of manufacturing techniques, however, a limit of the length within which the line can be manufactured inexpensively is about 2 m.

In order to install the wireless LAN system so as to cover the length of the room, therefore, a plurality of lines must be spliced to each other in the lengthwise direction. This gives rise to problems in practical use, such as a leakage and loss of the high-frequency wave at joints, troublesome work required in splicing the lines, and so on.

Further, a plurality of or a large number of branch circuits for connection to slave units or terminals in the area of the wireless LAN system are provided in the form of the openings which are bored in the ground layer for high-frequency coupling. Accordingly, in spite of the proposed high-frequency line employing the patch antenna, another problem arises in that troublesome work for opening and closing the openings without a leakage of the high-frequency wave is required depending on change of the branch circuits.

The present invention has been made in view of the state of the art described above, and its object is to provide a high-frequency micro-strip line for use in a wireless LAN system, which has superior basic characteristics as a high-frequency line in points such as capable of being easily manufactured in long size and allowing a high-frequency wave to propagate with a low loss.

The high-frequency micro-strip line of the present invention has flexibility and can be itself freely deformed depending on the intention in use. Therefore, the present high-frequency micro-strip line is suitable for the case in which the wireless LAN system is installed in a certain macro-sized area while deforming the line so as to, for example, ride over or bypass obstacles depending on installation conditions in the area. Further, handling of the line, such as required in the installation work and transportation to the installation place, is also simple.

FIG. 33 shows, as a front view, an example in which the high-frequency line of the present invention is applied to an indoor wireless LAN system. In FIG. 33, a high-frequency line 1a is disposed to extend along, e.g., an interior ceiling of a building (i.e., in an upper space within a service area). One end of the high-frequency line 1a is formed as a non-reflecting terminator, and a wireless LAN base station (called also a wireless LAN master station or a wireless LAN master unit) 111 is connected to the other end of the high-frequency line 1a via a coaxial cable 12. A plurality of wireless LAN mobile stations (called also mobile station terminals, slave unit groups, or terminal groups) 9a, 9b and 9c communicating with the wireless LAN base station 111 are disposed indoor. The mobile stations 9a, 9b and 9c perform communication with antennas 6 of the wireless LAN base station by using antennas incorporated in terminal wireless LAN cards 105 that are inserted to the respective mobile stations.

To ensure good communication with each of the wireless LAN mobile stations, the antennas of the wireless LAN base stations are constituted by, e.g., patch antennas (planar antennas) 6 disposed on the high-frequency line 1a at certain intervals depending on the layout of the mobile stations 9a, 9b and 9c.

In such a wireless LAN system, however, there is a possibility that, depending on the layout of the wireless LAN mobile stations, crosstalk (i.e., multi-path fading) may occur between high-frequency waves radiated from the patch antennas 6a, 6b adjacent to each other. If the multi-path fading occurs, the high-frequency waves transmitted from adjacent antenna units and each propagating in a concentric pattern cancel each other completely, thus resulting in a communication error. Depending on the position (place) of the wireless LAN mobile station (terminal), data communication is difficult to perform.

As another method for reducing the influence of the multi-path fading, there is a polarization diversity transmission system in which the wireless LAN base station transmits electric waves of two polarized components orthogonal to each other, i.e., circularly polarized waves (with leftward rotation and rightward rotation) or linearly polarized waves (45°-polarized wave and 135°-polarized wave). In such a polarization diversity transmission system, each of the wireless LAN mobile station terminals has, for example, two sets of receiving antennas to receive respectively the two orthogonal polarized components of the transmitted electric waves, and then performs polarization diversity reception by switching over outputs of the receiving antennas or by combining those outputs. That transmission system is disclosed in Japanese Unexamined Patent Application Publication No. 2000-115044.

Even with the polarization diversity transmission system, the receiving state of the wireless LAN mobile station is greatly affected depending on communication environments. In an indoor area with good visibility, for example, the communication is affected only by reflections from the ceiling, walls, a floor, etc., which are made of materials each having a relatively small reflectance, and the effect of the polarization diversity is expected to a large extent. However, the polarization diversity transmission system has a problem of difficulty in carrying out high bit-rate communication due to increased reflections of electric waves in an environment where the distance between the base station antenna and the mobile station terminal antenna is increased (farther away) over, e.g., 10 m. In other words, a larger distance between the two antennas increases a probability that the number of objects interfering visibility between the two antennas and the number of metal-made structures tending to reflect the electric waves are increased, for example, as in the interior of a factory building described later with reference to FIG. 42. Therefore, a signal level receivable by the base station antenna and the mobile station terminal antenna is greatly lowered, and multi-path components are increased. Eventually, a reception S/N is reduced and high bit-rate communication is difficult to perform.

Also, in the case using linearly polarized waves in the polarization diversity transmission system, if good visibility is not given between the base station antenna and the mobile station terminal antenna, electric waves received via multiple paths through reflections are apt to interfere with each other. As a result, a reception S/N is reduced and high bit-rate communication is difficult to realize.

In order to reduce the influence of the multi-path fading without causing those problems, therefore, it is preferable in the wireless LAN base station side to employ circularly polarized high-frequency waves propagating in leftward- and rightward-rotated states instead of the linearly polarized waves. Then, circular polarized antennas are preferably employed as antennas transmitting high-frequency waves in the form of circularly polarized waves.

For that reason, in the example of the wireless LAN system shown in FIG. 33, the antennas in the wireless LAN base station side are constituted by alternately arranging the circular polarized antennas differing in rotating directions of circularly polarized waves from each other. More specifically, the patch antenna 6a in the wireless LAN base station side is constituted as a rightward circular polarized antenna transmitting a right-handed (rightward-rotated) circularly polarized wave, and the patch antenna 6b adjacent to the patch antenna 6a is constituted as a leftward circular polarized antenna transmitting a left-handed (leftward-rotated) circularly polarized wave, whereby the circular polarized antennas differing in rotating directions of circularly polarized waves from each other are arranged alternately.

When those circular polarized antennas are used in the wireless LAN base station side, the plane of polarization is rotated as a matter of course. In such a case, if a horizontal or vertical linear polarized antenna is used as the antenna in each of the wireless LAN cards for the terminals of the wireless LAN mobile stations 9a, 9b and 9c, reception power is reduced about 3 dB as compared with the case using the circular polarized antennas. A dipole antenna generally used in the wireless LAN card for the terminal of the wireless LAN mobile station is the linear polarized antenna. Accordingly, when the circular polarized antennas are used in the wireless LAN base station side, there inevitably occurs the above-mentioned problem of a reduction in reception power. Further, the dipole antenna has a problem that directivity is weak and the influence of the multi-path fading is noticeable particularly in the up-direction toward the wireless LAN base station antenna from the terminal side antenna.

One conceivable solution for that problem is to use circular polarized antennas, as the antennas used in the wireless LAN cards for the terminals of the wireless LAN mobile stations, similarly to the antennas in the wireless LAN base station side. In this case, however, because each of the antennas used in the wireless LAN cards for the terminals is constituted by a single high-frequency line, those antennas must be unified into single type of circular polarized antenna, i.e., the right-handed circular polarized antenna or the left-handed circular polarized antenna.

When the single type of right- or left-handed circular polarized antenna is used in the wireless LAN mobile station terminal side, circularly polarized waves can be received only in a position where the rotating direction of the plane of polarization of the circular polarized antenna in the mobile station terminal side is the same as that of the antenna (circular polarized antenna) in the wireless LAN base station. In other words, the circular polarized antenna in the mobile station terminal side cannot receive circularly polarized waves at all in a position where the other circular polarized antenna (wireless LAN base station antenna) has the opposed rotating direction. This leads inevitably to that, depending on positions of the wireless LAN mobile station terminals, some terminals can receive the circularly polarized waves in some positions, but the other terminals cannot receive them. Also, there is a tendency that, depending on attitudes (bearings and directions) of the circular polarized antennas in the mobile station terminal side, some antennas can transmit and receive the circularly polarized waves at a high level, but the other antennas cannot transmit and receive them at a high level.

Still another problem is that the mobile station terminal side has no means for selecting the best one, as a transmitting and receiving antenna, from among a plurality of antennas disposed in the wireless LAN base station, and it is difficult to select the best antenna in the base station side from the mobile station terminal side.

The present invention has been made in view of the state of the art described above, and its object is to provide a wireless LAN mobile-station terminal antenna, a wireless LAN card for a terminal, and a wireless LAN system, which are capable of performing high bit-rate communication regardless of the position and attitude of the wireless LAN mobile-station terminal antenna, the distance between the wireless LAN base station antenna and the wireless LAN mobile-station terminal antenna, etc. when the wireless LAN base station antenna is constituted as a circular polarized antenna.

Further, in the wireless LAN system described above, communication is performed between a wireless LAN master unit (higher-level unit) and a large number of wireless LAN slave units (lower-level units), which are distributed within a service area, by using electromagnetic waves in a wide frequency band. For example, quasi-microwave bands of 1.9 GHz and 2.4 GHz are assigned to Personal Handyphone System (PHS) and a medium bit-rate wireless LAN, while a quasi-millimeter wave band of 19 GHz and a millimeter wave band of 60 GHz are assigned to a high bit-rate wireless LAN.

Looking at the case of an indoor wireless LAN system as an example, there are usually many obstacles against electromagnetic waves propagating between the master unit and the slave units of the wireless LAN in an indoor space, such as desks, racks, partitions, and business machines. Therefore, the electric field strength of an electromagnetic wave (signal) reaching a target unit while bypassing the obstacles is reduced and the S/N (SN ratio) cannot be obtained at a level enough to demodulate data transmitted to the target unit. As a result, a data error rate is so increased as to repeat transmitting, thus resulting in a lower effective communication bit rate.

Also, even when good visibility is ensured with no obstacles against electromagnetic waves, there is a problem that, due to influences of reflected electromagnetic waves from wall surfaces, a ceiling surface, a floor surface, office fixtures, business machines, etc., the SN ratio cannot be obtained at a level enough to demodulate the transmitted data and the communication bit rate is lowered. Those problems may similarly occur in the wireless LAN system installed in a certain area other than the indoor space.

Regarding the above-mentioned problems, the communication bit rate in a wireless LAN was actually measured in a room having a ceiling height of 3 m and dimensions of 18 m×6 m, in which many desks and chairs are disposed. When a quasi-microwave band of 2.4 GHz was used and a commercially available wireless LAN unit having a high bit-rate data communication capability of 11 Mbps at maximum was employed, it was confirmed that the communication bit rate varied largely depending on positions inside the room and, in some positions, the communication bit rate was lowered to 1/10 of the maximum value.

In order to cope with those influences of reflected electromagnetic waves (i.e., multi-path fading) caused when a radio communication network is formed, the applicant et al. have previously proposed, as disclosed in, e.g., Japanese Unexamined Patent Application Publication No. 2002-204240, a wireless LAN system and a waveguide device (wireless-communication RF signal transmission device) for the wireless LAN system, which are improved in points of suppressing the multi-path fading and avoiding a lowering of the effective communication bit rate.

The proposed wireless-communication RF signal transmission device comprises a waveguide disposed to extend along an upper space in an area where a radio communication network is formed, a wireless LAN master unit connected to the waveguide, and wireless LAN slave units arranged in the area. The waveguide has a plurality of branch circuits (corresponding to the branching/joining means), and antennas for transmitting and receiving electromagnetic waves with directivity toward the area are connected to the branch circuits, whereby the wireless LAN system is constituted.

With that arrangement, even in the presence of obstacles against electromagnetic waves, those obstacles are avoided from impeding communication of the electromagnetic waves among the master unit and the slave units of the wireless LAN system. Also, even though the electromagnetic waves are reflected, influences of the reflected waves are held small.

Further, according to the above-cited Japanese Unexamined Patent Application Publication No. 2002-204240, the antennas for transmitting and receiving electromagnetic waves, which are provided in the branch circuits and the wireless LAN slave units, are given with directivity, to thereby enhance the effect of suppressing the multi-path fading.

That technique is able to suppress the multi-path fading caused by the obstacles impeding communication of electromagnetic waves. That technique is also able to increase uniformity in strength of the electric waves within the communication area.

In the waveguide device (wireless-communication RF signal transmission device) disclosed in the above-cited Japanese Unexamined Patent Application Publication No. 2002-204240, the signal frequency (transmission line frequency) in the transmission line (waveguide) is the same as that of radio signals branched from or joined into the transmission line by the branch circuits (branching/joining means). Accordingly, to employ a radio signal in the band of 2.4 GHz or 5 GHz that has recently been opened for the wireless LAN communication, the transmission line frequency also requires to be set to a similar high-frequency level.

That requirement raises a problem that, because the attenuation rate of a high-frequency signal (RF signal for wireless communication) in the transmission line is generally increased at a higher frequency, the length of the transmission line cannot be set to a sufficiently large value. For example, the attenuation rate in a strip line used as the transmission line may reach 1 dB per 1 m in some cases. To compensate for such a high attenuation rate and to cover a required area, countermeasures are required, for example, by providing amplifiers in the transmission line at certain intervals, or shortening the transmission line and increasing the number of the wireless LAN master stations (higher-level units) so as to ensure a wide service area. Such an increase in the number of units used leads to problems of an increased amount of time and labor required for installation, an increase of energy consumption, and hence an increased system cost.

On the other hand, a total transmission capacity of the system can be increased, as one conceivable example, by connecting a plurality of wireless LAN master units (higher-level units) to the transmission line. To that end, a plurality of modulated RF signals for wireless communication must be multiplexed and transmitted through the transmission line in a frequency multiplexed manner. Although the related art can also connect the plurality of master units to the transmission line, there is a problem that, because the transmission line frequency and the radio frequency correspond to each other in 1:1 relation, the number of waves (signals) capable of being multiplexed in the transmission line is limited to the number of waves which are permitted for use as the radio frequency, thus resulting in a greater limitation.

Further, because each branch circuit (each branching/joining means) does not include the function of frequency discrimination, RF signals for wireless communication transmitted through the transmission line are transmitted to the whole of the area from all the branch circuits. Accordingly, it is impossible to realize flexible design of communication environments, for example, by assigning the wireless LAN master unit (higher-level unit) corresponding to each area where the branch circuit is disposed, for the purpose of efficiently distributing the communication load.

In view of those problems, the present invention provides a wireless-communication RF signal transmission device in which the frequency of a wireless-communication RF signal transmitted through a transmission line is made different from the frequency of a wireless-communication RF signal transmitted via radio toward a lower-level unit from a branch circuit that is branched from the transmission line. Then, a low-frequency RF signal for wireless communication being less attenuated is transmitted through the transmission line, while the frequency of the wireless-communication RF signal transmitted via radio toward the lower-level unit from the branch circuit branched from the transmission line is set to a high frequency suitable for the lower-level unit, whereby signal attenuation in the transmission line can be avoided.

Thus, the present invention has succeeded in reducing attenuation of the RF signal for wireless communication passing through the transmission line even when the line is long. However, laying a single long transmission line so as to penetrate a plurality of rooms partitioned by walls requires a great deal of work cost, particularly in the case of the walls being made of, e.g., reinforced concrete, even if the work of penetrating the walls is physically feasible. Also, in the case of, e.g., an office of a tenant borrowing one or more rooms of a building, the work of penetrating walls cannot be usually performed unless such work is approved by the owner of the building.

Looking at, as another example, the case laying a wireless-communication RF signal transmission line in cars of a railway train, it is very difficult to lay the wireless-communication RF signal transmission line bridging between the cars composing the train. The reason is that the train cars are always swayed relative to each other while running, and the relative positional relationship between the adjacent cars is changed at all times. One conceivable solution is to employ flexible cables only in a coupling zone between the adjacent cars for interconnection. Although newly manufactured cars can be designed so as to bury such flexible cables therein, it is generally quite difficult to additionally install those flexible cables in existing cars, including design to secure cable routes. Further, since the train composition is changed day by day in many cases, the use of the flexible cables to extend the wireless-communication RF signal transmission line is inconvenient with the necessity of work for disconnecting the flexible cables and connecting them again whenever the train composition is changed. Accordingly, the present invention further provides a wireless-communication RF signal transmission device capable of realizing a long transmission line at a low cost without impairing the above-mentioned primary objects of the present invention by relaying an RF signal for wireless communication via radio between wireless-communication RF signal transmission lines installed in a plurality of rooms partitioned by walls or the likes.

In addition, the present invention has been made in view of the state of the art described above, and its primary object is to provide a wireless-communication RF signal transmission device capable of realizing extension of the transmission line length, an increase of the transmission capacity, and flexible design of communication environments.

### DISCLOSURE OF THE INVENTION

To achieve the above objects, the present invention is purported to provide a high-frequency micro-strip line for transmitting a high-frequency wave for a wireless LAN system, wherein the high-frequency micro-strip line has a layered structure in which a dielectric layer made of a dielectric material and a signal line made of a conductive material are successively laid on a ground layer made of a conductive material, and the signal line is electrically coupled to patch antennas each comprising a dielectric plate made of a dielectric material and a patch made of a conductive material which are successively laid into a layered structure.

The present invention resides in a high-frequency line in the form of a strip (thin plate) and has the layered structure in which the dielectric layer and the signal line are successively laid on the ground layer. Therefore, a relatively simple structure is realized and a long-size line can be easily manufactured. As a result, when the high-frequency micro-strip line is applied to a wireless LAN system, superior basic characteristics as a high-frequency line can be ensured in points such as a larger length coverable by a single line, a smaller number of joints for splicing the lines to each other, and a smaller loss of a high-frequency wave transmitted through the line.

It has been prevalently thought that, when the ground layer is disposed on only one side as in the structure of the present invention, one surface of the dielectric layer on which the ground layer is not disposed is entirely left open, and the loss of the high-frequency wavy is so increased as making the line failed to function as an efficient high-frequency line. As a result of actually fabricating and testing the high-frequency line of the present invention, however, the inventors have confirmed that, even when the ground layer is not disposed on one surface of the dielectric layer as in the sectional structure of the high-frequency line of the present invention, the loss of the high-frequency wave from the surface of the dielectric layer on which the ground layer is not disposed is hardly generated by appropriately setting the dielectric constant and the dielectric loss of the dielectric layer.

Also, in the present invention, several or a large number of high-frequency wave transmitting and receiving antennas for connection to slave units or terminals in a service area are constituted as detachable patch antennas direction to face the area.

Therefore, openings and branch circuits provided in the ground layer for high-frequency coupling are no longer required, and antennas can be simply and easily installed just by detachably attaching the patch antennas. Hence, when installation of antennas themselves or installation points of the antennas must be modified depending on conditions in the area when the line is installed or used, or change of the conditions, such a modification can be performed, as desired, just by detaching and attaching the patch antennas with no leakage of the high-frequency wave without modifying the high-frequency line itself.

In addition, since the high-frequency line of the present invention has a relatively small sectional area and volume, it requires a relatively small space when installed, thus resulting in that time, labor and an overall cost including an installation cost can be suppressed to lower levels even when the high-frequency line required in the area is long. Furthermore, corresponding to communication slave units in the area, the patch antennas serving as openings for high-frequency coupling can be simply disposed on the high-frequency line in optional positions (desired places within the area).

When the high-frequency line is made of a material with flexibility, the high-frequency line is flexible in itself. In a wireless LAN system within a certain area, therefore, the high-frequency line can be freely, optionally installed and removed depending on installation conditions within the area in any places including such a place where the installation of the high-frequency line is desired, but it is hard to carry out work for the installation, etc. Further, since the flexible high-frequency line can be wound into the form of a coil as required, handling of the high-frequency line, such as required in the installation work and transportation to the installation site, is facilitated.

The present invention has the above-described features as a basis and includes preferable modes as follows.

According to one mode of the present invention, the patch antenna is disposed just upward of the signal line. With this feature, the width of the ground layer and hence the width of the high-frequency line can be narrowed so that a more compact structure is realized.

According to another mode of the present invention, the patch antenna is disposed near the signal line, and the patch antenna is coupled to the signal line by a feeder. This feature gives a phase difference to high-frequency waves fed to the patch antennas, and hence controls directivity of predetermined (particular or selected) ones of the patch antennas.

According to still another mode of the present invention, a coupling ratio between the predetermined one or more of the patch antennas and the signal line can be adjusted by changing a relative position of a center axis of the predetermined patch antenna with respect to a center axis of the signal line.

According to still another mode of the present invention, the aforesaid relative position of the center axis of the predetermined patch antenna is changed by changing a direction of the predetermined patch antenna in a plane. This feature enables the coupling ratio between the predetermined one or more of the patch antennas and the signal line to be adjusted with ease.

With the present invention, the directivity of the predetermined patch antenna is controlled by giving a phase difference to high-frequency waves fed to the patch antennas, whereby connection to target slave units or terminals can be realized with the best communication sensitivity.

According to still another mode of the present invention, the directivity of the predetermined patch antenna can be simply controlled by giving the above-mentioned phase difference by adjusting an interval between the predetermined ones of the patch antennas.

Also, the directivity of the predetermined patch antenna can be simply controlled by giving the above-mentioned phase difference by adjusting a length of the feeder for the predetermined patch antenna.

An end of the high-frequency micro-strip line may be shaped to have a predetermined slope angle in plan view, and two high-frequency micro-strip lines may be spliced to each other at respective ends each having the predetermined slope angle. This feature enables the high-frequency micro-strip lines to be easily spliced to each other with no leakage.

Other modes of the present invention are as follows.

The high-frequency micro-strip line has a bent portion in match with a shape of a service area (namely, the line is used while bending it). With this feature, it is possible to provide good communication quality even in an area with no good visibility from the master unit, and to ensure good communication quality in the entire area.

A certain spacing is left between a surface of the patch antenna and an installation surface of the high-frequency micro-strip line, and a radiating section of the patch antenna is isolated at surroundings thereof. With this feature, it is possible to increase a level of signals transmitted and received, to improve a communication S/N, and to maintain stable quality.

The patch antennas are constituted as two or more kinds of patch antennas for transmitting and receiving high-frequency waves having different frequencies, respectively. As an alternative, as defined in claim 13, the patch antennas are constituted as rectangular patch antennas for transmitting and receiving high-frequency waves having different frequencies, respectively. With one of those features, the high-frequency micro-strip line is capable of ensuring good communication quality for each of the plurality of high-frequency waves having different frequencies.

Opposite ends of the high-frequency micro-strip line including the patch antennas electrically coupled thereto are connected to coaxial cables via coaxial connectors, and the high-frequency micro-strip line thus connected serves as a high-frequency micro-strip line type antenna in the interconnected coaxial cables. This feature is effective in suppressing losses or reflections of high-frequency waves, which occur at bent portions of the high-frequency micro-strip line formed so as to ride over large projections on the ceiling, such as beams, permitting radio communication in any places within an office at a high bit-rate, and realizing communication environments free from unevenness in communication quality.

The thus-constructed high-frequency micro-strip line of the present invention is suitably applied to an indoor wireless LAN system with the service area set in an indoor space. As a matter of course, the high-frequency micro-strip line is also applicable to other certain areas including not also spaces in structures, such as arcades, platforms, terminals, and large-sized temporary structures, event sites, etc. but also outdoor spaces.

To achieve the above object of permitting a high bit-rate communication, the present invention is purported to provide a wireless LAN antenna for communicating a high-frequency wave for a wireless LAN system with respect to a wireless LAN base station including antennas constituted as a plurality of circular polarized antennas which differ in polarization-plane rotating directions from each other and are disposed on a high-frequency line at intervals between the antennas, wherein the wireless LAN antenna has a structure in which high-frequency micro-strip lines each having a dielectric layer and a signal line successively laid on a ground layer are arranged adjacent to each other substantially in parallel, wherein the plurality of circular polarized antennas differing in polarization-plane rotating directions are arranged alternately at intervals therebetween on each of the high-frequency micro-strip lines, and wherein the circular polarized antenna elements differing in polarization-plane rotating directions are arranged adjacent to each other on the high-frequency micro-strip lines substantially in the same positions. That wireless LAN antenna according can be used as any of a base station antenna and a mobile station antennal in a wireless LAN.

Further, the present invention provides a wireless LAN antenna used in a wireless LAN system for communicating a high-frequency wave for a wireless LAN system between a wireless LAN base station and a wireless LAN mobile station, wherein the wireless LAN antenna comprises a high-frequency line having a high-frequency micro-strip line structure in which a dielectric layer and a signal layer are successively laid on a ground layer, and a plurality of circular polarized antenna elements which are disposed on the high-frequency line and differ in polarization-plane rotating directions from each other, wherein the plurality of circular polarized antenna elements differing in polarization-plane rotating directions are disposed on the high-frequency line at intervals therebetween, the circular polarized antenna elements being disposed on both sides of the high-frequency line.

In that mode, the high-frequency line may have a high-frequency micro-strip line structure in which a plurality of signal lines are laid on a base plate made up of a ground layer and a dielectric layer.

The circular polarized antenna elements may be arranged on the plurality of signal lines substantially in the same positions.

Preferably, the circular polarized antenna elements arranged on the plurality of signal lines substantially in the same positions are the circular polarized antenna elements differing in polarization-plane rotating directions from each other.

Preferably, the wireless LAN system includes a control unit for controlling transmitting/receiving states of the plurality of the circular polarized antenna elements.

The control unit may be a control circuit for changing over the transmitting/receiving states of the plurality of circular polarized antenna elements.

Preferably, the high-frequency line has, by way of example, a high-frequency micro-strip line structure in which a plurality of signal lines are laid on a base plate made up of a ground layer and a dielectric layer, and the control unit is, by way of example, a control circuit for changing over connected/disconnected states of the plurality of signal lines disposed on the base plate.

Also, the present invention provides a wireless LAN card for a terminal wherein the terminal antenna having any of the above-mentioned features, including preferable modes mentioned below, is incorporated in the wireless LAN card for the terminal, which is used in a wireless LAN mobile station.

Further, the present invention provides a wireless LAN system forming a radio communication network between a wireless LAN mobile station including the terminal antenna having any of the above-mentioned features, including preferable modes mentioned below, and a wireless LAN base station including antennas constituted as a plurality of circular polarized antenna elements which differ in polarization-plane rotating directions from each other and are alternately disposed on a high-frequency line at intervals between the antenna elements.

With the above feature of the present invention, a plurality of circular polarized antennas differing in polarization-plane rotating directions from each other, e.g., antennas transmitting a right-handed circularly polarized wave and a left-handed circularly polarized wave, are present in both of the wireless LAN base station and the wireless LAN mobile station terminal. Looking at the installation space as a three-dimensional space, therefore, the circular polarized antennas having the same polarization-plane rotating direction are always present in both of the wireless LAN base station and the wireless LAN mobile station terminal with good visibility between the wireless LAN base station and the wireless LAN mobile station terminal in spite of the presence of an obstacle 118 between them. As a result, when the wireless LAN base station antenna includes the circular polarized antennas, high bit-rate communication can be realized regardless of the position and attitude of the wireless LAN mobile-station terminal antenna, the distance between the wireless LAN base station antenna and the wireless LAN mobile-station terminal antenna, etc.

Further, in the wireless LAN mobile-station terminal antenna of the present invention, it is basically just required to prepare at least two high-frequency micro-strip lines, and the circular polarized antennas differing in polarization-plane rotating directions from each other, which are disposed on the high-frequency line. This results in a more compact and simple structure. Consequently, the terminal antenna of the present invention can be easily applied to an antenna of the wireless LAN card for the terminal or the like, which is used in the mobile station, etc.

Thus, while the wireless LAN mobile-station terminal antenna and the wireless LAN system of the present invention are suitably applied to an indoor wireless LAN system with the area forming the radio communication network set in an indoor space, they can also realize high bit-rate communication in arcades, platforms, terminals, buildings, factories, event sites, and other large-sized structures.

By further providing, in the wireless LAN mobile-station terminal antenna of the present invention, a switch for electrically controlling the transmitting/receiving states of the antenna, an additional advantage is obtained in that, from among a plurality of antennas disposed in the wireless LAN base station, optimum one can be more easily selected as a transmitting/receiving antenna.

Still further, the present invention provides a wireless-communication RF signal transmission device for transmitting RF signals for wireless communication transmitted and received between predetermined higher-level unit and lower-level unit, wherein the wireless-communication RF signal transmission device comprises one or more transmission lines directly or indirectly connected to the higher-level unit and transmitting RF signals for wireless communication; branching/joining means disposed on the transmission lines at a plurality of points for branching and joining RF signals for wireless communication with respect to the transmission lines; a radio antenna disposed for each of the branching/joining means for transmitting and receiving RF signals for wireless communication with respect to the lower-level unit via radio; and a radio antenna disposed at one or more points between the predetermined higher-level unit and the one or more transmission lines and between the plurality of transmission lines for transmitting and receiving the wireless-communication RF signals communicated therebetween.

With that feature, even when the transmission line is extended over a long distance, an RF signal for wireless communication can be processed, e.g., amplified, in a communicating section disposed midway the line and including the radio antenna. Therefore, a wireless-communication RF signal transmission device with less or no attenuation of the RF signal for wireless communication can be provided.

In the present invention, the wireless-communication RF signal transmission device may further comprise frequency upconversion means and/or up-signal amplifying or attenuating means connected between the higher-level unit or the transmission line and the radio antenna, the frequency upconversion means converting a frequency of the wireless-communication RF signal of a transmitted up-signal and outputting the frequency-converted RF signal for wireless communication, the up-signal amplifying or attenuating means changing the intensity of the up-signal; and frequency downconversion means and/or down-signal amplifying or attenuating means connected between the higher-level unit or the transmission line and the radio antenna, the frequency downconversion means converting a frequency of the wireless-communication RF signal of a transmitted down-signal and outputting the frequency-converted RF signal for wireless communication, the down-signal amplifying or attenuating means changing the intensity of the down-signal.

With that mode, even the transmission line is extended long, the amplifying or attenuating means is able to compensate for attenuation of the RF signal for wireless communication, or to appropriately modify the excessive intensity of an electric wave, or to change the frequency of the RF signal for wireless communication per transmission line, thus resulting in an advantage that the width of frequency in use can be increased.

Also, this application provides a wireless-communication RF signal transmission device for transmitting RF signals for wireless communication transmitted and received between predetermined higher-level unit and lower-level unit, wherein the wireless-communication RF signal transmission device comprises a transmission line connected to the higher-level unit and transmitting RF signals for wireless communication; branching/joining means disposed on the transmission line at a plurality of points for branching and joining RF signals for wireless communication with respect to the transmission line; a radio antenna disposed for each of the branching/joining means for transmitting and receiving RF signals for wireless communication with respect to the lower-level unit via radio; frequency downconversion means connected between each of the branching/joining means and the corresponding radio antenna, converting a frequency of the wireless-communication RF signals branched by the branching/joining means, and outputting the frequency-converted wireless-communication RF signal to the radio antenna; and frequency upconversion means connected between each of the branching/joining means and the corresponding radio antenna, converting a frequency of the wireless-communication RF signal received by the radio antenna, and outputting the frequency-converted wireless-communication RF signal to the branching/joining means.

With that mode, the frequency of the wireless-communication RF signal in the transmission line (i.e., the transmission line frequency) can be made different from the frequency of the wireless-communication RF signal transmitted from and received by the radio antenna (i.e., the radio frequency). By setting the transmission line frequency to be lower than the radio frequency, therefore, a transmission loss of the wireless-communication RF signal in the transmission line can be suppressed. Hence, the length of the transmission line can be drastically increased in comparison with the case where the radio frequency is the same as the transmission line frequency as in the known system.

Further, it is possible to not only optionally set combinations of the transmission line frequency and the radio frequency which are used in a plurality of branch sections (communication-wave branching/joining sections) in the transmission line, but also to set the number of (kinds) of transmission line frequencies used to be larger than the number of (kinds) of radio frequencies used. As a result, regardless of the number of (kinds) of radio frequencies which are subjected to large limitations on usable bands, RF signals for wireless communication containing many signals (channel signals) of different transmission line frequencies in superimposed relation can be propagated through the communication line so that signal collisions can be avoided and a drastic increase of signal transmission capacity of the transmission line can be obtained. Furthermore, radio communication environments can be more flexibly designed in points such as setting the radio frequency to differ from each other between the radio antennas in adjacent areas, to thereby prevent interference between electric waves.

The down- and frequency upconversion means can be constituted in various ways.

For example, the frequency downconversion means and the frequency upconversion means may comprise one frequency oscillator; separate frequency mixers for mixing inputted RF signals for wireless communication and an oscillation signal from the one frequency oscillator; and separate band-pass filters for receiving output signals from the frequency mixers.

With that feature, even when the wireless-communication RF signal branched from the transmission line contains a plurality of channel signals (RF signals for wireless communication) of different frequencies in superimposed relation, only the desired channel signals can be discriminated by the band-pass filters. In addition, a simpler structure sharing one frequency oscillator by both the down- and frequency upconversion means can be obtained.

Also, each of the frequency downconversion means and the frequency upconversion means may comprise first and second frequency oscillators variable in oscillation frequency; a first frequency mixer for mixing an inputted RF signal for wireless communication and an oscillation signal from the first frequency oscillator; a band-pass filter for receiving output signals from the first frequency mixer; and a second frequency mixer for mixing an output signal from the band-pass filter and an oscillation signal from the second frequency oscillator.

In that mode, frequency conversion is performed in two stages such that the first frequency mixer executes frequency conversion (first stage) for discriminating the desired channel signal (channel frequency), and the second frequency mixer executes frequency conversion (second stage) for matching with the frequency in the counterpart side (output side).

With that feature, even when the wireless communication RF signal branched from the transmission line contains a plurality of channel signals (RF signals for wireless communication) of different frequencies in superimposed relation, only the desired channel signals can also be discriminated by the band-pass filters. In addition, adaptation for practical conditions can be made just by changing setting of the oscillation frequency in each frequency oscillator depending on the frequency used (discriminated) as an input/output signal with no need of replacing the band-pass filters. Hence, it becomes easy to optionally set desired one of combinations between the transmission line frequency and the radio frequency to be used. By employing, e.g., a synthesizer as each frequency oscillator, flexible adaptation can be realized in point of enabling the frequency combination to be set in a site where the wireless-communication RF signal transmission device is disposed.

When the TDD method using the same radio frequency in the transmitting side and the receiving side is employed as the communication method in a communication system to which the wireless-communication RF signal transmission device is applied, there is a possibility that a transmitted signal (RF signal for wireless communication in the down-direction) may creep into the side of the frequency upconversion means circuit, and the crept signal (RF signal for wireless communication) may further creep into the down-side frequency converting means, thereby forming a loop. If such a loop is formed, communication quality deteriorates as in the event of multi-path fading. That problem can be solved in various ways.

For example, the wireless-communication RF signal transmission device may further comprise one or both of a first circulator and a second circulator, the first circulator interconnecting the branching/joining means, the frequency downconversion means, and the frequency upconversion means, the second circulator interconnecting the radio antenna, the frequency downconversion means, and the frequency upconversion means.

With that feature, the transmitting direction of the RF signal for wireless communication can be substantially regulated by the circulators. More specifically, the first circulator can regulate the transmitting direction of the RF signal for wireless communication to the direction from the branching/joining means toward the frequency downconversion means, and to the direction from the frequency upconversion means toward the branching/joining means. The second circulator can regulate the transmitting direction the frequency downconversion means to the radio antenna, and to the direction from the radio antenna toward the frequency upconversion means. As a result, it is possible to prevent the RF signal for wireless communication from creeping and generating a loop, and to maintain good communication quality.

Also, the wireless-communication RF signal transmission device may further comprise one or both of a transmission line-side switch and an antenna-side switch, the transmission line-side switch changing over connection of the branching/joining means to one of the frequency downconversion means and the frequency upconversion means, the antenna-side switch changing over connection of the radio antenna to one of the frequency downconversion means and the frequency upconversion means, each of the switches being changed over in accordance with a predetermined changeover signal from the higher-level unit.

According to the TDD method, transmitting and receiving timings (i.e., timings at which a down-signal and an up-signal are generated) are usually controlled from the higher-level unit side. With the above feature, therefore, the switches can be changed over such that the RF signal for wireless communication is caused to flow into only the frequency downconversion means during generation of the wireless-communication RF signal in the down-direction, and the RF signal for wireless communication is caused to flow into only the frequency upconversion means during generation of the wireless-communication RF signal in the up-direction. As a result, the RF signals for wireless communication in the down- and up-directions are avoided from creeping into the opposite side, whereby the formation of the loop can be prevented.

Further, the wireless-communication RF signal transmission device may further comprise an antenna-side switch for changing over connection of the radio antenna to one of the frequency downconversion means and the frequency upconversion means, signal intensity detecting means for detecting the signal intensity of the wireless-communication RF signal in the frequency downconversion means; and switch control means for changing over the antenna-side switch in accordance with a result detected by the signal intensity detecting means.

With that feature, since the switch is changed over depending on whether the wireless-communication RF signal in the down-direction is generated (detected), the RF signal for wireless communication is prevented from creeping from one side to the other side by the switch control means autonomously changing over the switch with no need of laying a separate signal line extended from the higher-level unit for supply of the changeover signal.

In the case providing the antenna-side switch, the provision of a circulator for interconnecting the branching/joining means, the frequency downconversion means, and the frequency upconversion means is more effective in preventing the creeping of the RF signal for wireless communication.

Still further, the wireless-communication RF signal transmission device may further comprise a transmission line-side switch for changing over connection of the branching/joining means to one of the frequency downconversion means and the frequency upconversion means; a circulator interconnecting the radio antenna, the frequency downconversion means, and the frequency upconversion means; signal intensity detecting means for detecting the signal intensity of the wireless-communication RF signal in the frequency upconversion means; and switch control means for changing over the transmission line-side switch in accordance with a result detected by the signal intensity detecting means.

With that feature, since the switch is changed over depending on whether the wireless-communication RF signal in the up-direction is generated (detected), the RF signal for wireless communication is prevented from creeping from one side to the other side by the switch control means autonomously changing over the switch with no need of laying a separate signal line extended from the higher-level unit for supply of the changeover signal.

Moreover, the antenna-side switch and the transmission line-side switch may be autonomously changed over depending on whether the wireless-communication RF signals in both the down-direction and the up-direction are generated (detected). In such a case, the wireless-communication RF signal transmission device further comprises a transmission line-side switch for changing over connection of the branching/joining means to one of the frequency downconversion means and the frequency upconversion means; an antenna-side switch for changing over connection of the radio antenna to one of the frequency downconversion means and the frequency upconversion means, first signal intensity detecting means for detecting the signal intensity of the wireless-communication RF signal in the frequency downconversion means; second signal intensity detecting means for detecting the signal intensity of the wireless-communication RF signal in the frequency upconversion means; and switch control means for changing over the switches in accordance with results detected by the first and second signal intensity detecting means.

If a time from the detection of a signal by the signal intensity detecting means to changeover of each of the switches into the predetermined on/off state is longer than a time required for the signal (RF signal for wireless communication) to reach each of the switches, a preamble portion at the head of the signal is not normally transmitted.

Such a problem can be overcome by disposing delay means at one or both of points between the frequency downconversion means and the antenna-side switch and between the frequency upconversion means and the transmission line-side switch for delaying transmission of the RF signal for wireless communication.

With that feature, by appropriately setting a delay time given by the delay means, changeover of the route connection is completed simultaneously or just before arrival of the RF signal for wireless communication to each of the switches, and therefore missing of the signal head portion can be avoided.

The transmission line may be, for example, one of a tubular waveguide, a coaxial cable, and a strip line.

The wireless-communication RF signal transmission device is applicable the case where communication between the higher-level unit and the lower-level unit is performed based on the TDD method.

Further, by giving directivity to the radio antenna described above, it is possible to compensate for attenuation of radio waves and to increase the communication distance. In addition, a possibility of interfering with or being interfered by radio waves of other antennas can be reduced.

As described above, the wireless-communication RF signal transmission device according to the present invention, when there are a plurality of transmission lines, RF signals for wireless communication can be prevented from attenuating due to an increase in total distance of the transmission lines by installing a radio antenna between the transmission lines. This advantage can also be obtained between the higher-level unit and the transmission line.

According to another aspect of the present invention, the frequency of the wireless-communication RF signal in the transmission line (i.e., the transmission line frequency) can be made different from the frequency of the wireless-communication RF signal transmitted from and received by the radio antenna (i.e., the radio frequency). By setting the transmission line frequency to be lower than the radio frequency, therefore, a transmission loss of the wireless-communication RF signal in the transmission line can be suppressed. Hence, the length of the transmission line can be drastically increased in comparison with the case where the radio frequency is the same as the transmission line frequency as in the known system.

Further, it is possible to not only optionally set combinations of the transmission line frequency and the radio frequency which are used in a plurality of branch sections (communication-wave branching/joining sections) in the transmission line, but also to set the number of (kinds) of transmission line frequencies used to be larger than the number of (kinds) of radio frequencies used. As a result, regardless of the number of (kinds) of radio frequencies which are subjected to large limitations on usable bands, RF signals for wireless communication containing many signals (channel signals) of different transmission line frequencies in superimposed relation can be propagated through the communication line so that signal collisions can be avoided and a drastic increase of signal transmission capacity of the transmission line can be obtained. Furthermore, radio communication environments can be more flexibly designed in points such as setting the radio frequency to differ from each other between the radio antennas in adjacent areas, to thereby prevent interference between electric waves, or allocating separate higher-level units (master units) having different transmission line frequencies from each other corresponding to the individual branch sections (radio communication areas).

Additionally, by regulating the transmitting directions of down- and up-RF signals for wireless communication with a circulator or a switch, the RF signals for wireless communication are prevented from creeping and forming a loop between the down-side and the up-side, and communication quality can be maintained.

### BRIEF DESCRIPTION OF THE DRAWINGS

FIG. 1 is a plan view showing one embodiment of a high-frequency line of the present invention.

FIG. 2 is a sectional view taken along the line A-A in FIG. 1.

FIG. 3 is a sectional view showing another embodiment of the high-frequency line of the present invention.

FIG. 4 is a sectional view showing still another embodiment of the high-frequency line of the present invention.

FIG. 5 shows one embodiment a patch antenna in the present invention; specifically, FIG. 5A is a plan view of the antenna and FIG. 5B is an explanatory view of the antenna.

FIG. 6 shows, in a plan view, other embodiments; specifically, FIGS. 6A through 6D are plan views of patch antennas.

FIG. 7 is a perspective view showing one embodiment in which the high-frequency line of the present invention is applied to an indoor wireless LAN system.

FIG. 8 is a perspective view showing one control mode for a patch antenna coupling ratio of the high-frequency line of the present invention.

FIG. 9 is a perspective view showing another control mode for a patch antenna coupling ratio of the high-frequency line of the present invention.

FIG. 10 is a graph for explaining a control result of the patch antenna coupling ratio obtained in FIG. 9.

FIG. 11 is a front view showing another embodiment in which the high-frequency line of the present invention is applied to an indoor wireless LAN system.

FIG. 12 is a front view partly showing the high-frequency line of the present invention shown in FIG. 7.

FIG. 13 is a plan view showing one embodiment for controlling antenna directivity in the high-frequency line of the present invention.

FIG. 14 is a plan view showing another embodiment for controlling antenna directivity in the high-frequency line of the present invention.

FIG. 15 is a plan view showing one embodiment of a joint portion between the high-frequency lines of the present invention.

FIG. 16 shows another embodiment of a joint portion between the high-frequency lines of the present invention; specifically, FIG. 16A is a plan view and FIG. 16B is a sectional view.

FIG. 17 is a plan view showing an office having an L-shaped floor plan.

FIG. 18 is a plan view showing an office having a channel-shaped floor plan.

FIG. 19 is a plan view showing one embodiment in which the high-frequency line of the present invention is applied to the office having an L-shaped floor plan.

FIG. 20 is a plan view showing one embodiment in which the high-frequency line of the present invention is applied to the office having a channel-shaped floor plan.

FIG. 21 is a three-dimensional view of the embodiment of FIG. 19.

FIG. 22 shows one embodiment in which the high-frequency line of the present invention is applied to an office having a pillar; specifically, FIG. 22A is a perspective view and FIG. 22B is a plan view.

FIG. 23 is an explanatory view showing one embodiment in which the known high-frequency line is applied to an office partitioned into rooms.

FIG. 24 is an explanatory view showing one embodiment in which the high-frequency line of the present invention is applied to an office partitioned into rooms.

FIG. 25 shows still another embodiment of the high-frequency line of the present invention; specifically, FIG. 25A is a plan view and FIG. 25B is a sectional view.

FIG. 26 is a plan view showing still another embodiment of the high-frequency line of the present invention.

FIG. 27 is a perspective view showing one example of the high-frequency line shown in FIG. 26.

FIG. 28 is a perspective view showing another example of the high-frequency line shown in FIG. 26.

FIG. 29 is a perspective view showing one embodiment in which the high-frequency line of the present invention and a coaxial cable are combined with each other.

FIG. 30 shows one embodiment of an antenna unit 25 shown in FIG. 29; specifically, FIG. 30A is a front view and FIG. 30B is a side view.

FIG. 31 shows another embodiment of the antenna unit 25 shown in FIG. 29; specifically, FIG. 31A is a front view and FIG. 31B is a side view.

FIG. 32 shows one embodiment of an antenna unit 25a shown in FIG. 29; specifically, FIG. 32A is a front view and FIG. 32B is a side view.

FIG. 33 is a front view showing one embodiment of a wireless LAN system as a basis of the present invention.

FIG. 34 shows one embodiment of a base station high-frequency line as a basis of the present invention; specifically, FIG. 34A is a perspective view and FIG. 34B is a sectional view.

FIG. 35 is a perspective view showing one embodiment of a base station antenna as a basis of the present invention.

FIG. 36 is a perspective view showing one embodiment of a mobile station terminal antenna of the present invention.

FIG. 37 is a perspective view showing another embodiment of the mobile station terminal antenna of the present invention.

FIG. 38 is a front view showing one embodiment of a wireless LAN system using the mobile station terminal antenna of the present invention.

FIG. 39 is a front view showing still another embodiment of the mobile station terminal antenna of the present invention.

FIG. 40 is a front view showing still another embodiment of the mobile station terminal antenna of the present invention.

FIG. 41 is a front view showing still another embodiment of the mobile station terminal antenna of the present invention.

FIG. 42 is an explanatory view showing one example in which the wireless LAN system is applied to the interior of a factory building.

FIG. 43 is a plan view of one embodiment of a wireless-communication RF signal transmission device according to the present invention, the view looking, from above, a wireless-communication RF signal transmission line installed in three rooms partitioned by walls.

FIG. 44 is a plan view looking, from above, a plurality of cars to which the wireless-communication RF signal transmission device according to one embodiment of the present invention is applied and in each of which the wireless-communication RF signal transmission line is installed.

FIG. 45 schematically shows a wireless LAN system using a wireless-communication RF signal transmission device X according to an embodiment of the present invention.

FIG. 46 is a block diagram schematically showing a branch section in the wireless-communication RF signal transmission device X according to the embodiment of the present invention.

FIG. 47 is a block diagram schematically showing a branch section in a wireless-communication RF signal transmission device X1 according to a first embodiment of the present invention.

FIG. 48 is a block diagram schematically showing a branch section in a wireless-communication RF signal transmission device X2 according to a second embodiment of the present invention.

FIG. 49 is a block diagram schematically showing a branch section in a wireless-communication RF signal transmission device X3 according to a third embodiment of the present invention.

FIG. 50 is a block diagram schematically showing a branch section in a wireless-communication RF signal transmission device X4 according to a fourth embodiment of the present invention.

FIG. 51 is a block diagram schematically showing a branch section in a wireless-communication RF signal transmission device X5 according to a fifth embodiment of the present invention.

FIG. 52 is a block diagram schematically showing a branch section in a wireless-communication RF signal transmission device X6 according to a sixth embodiment of the present invention.

FIG. 53 is a table showing logics in changeover of switches in the wireless-communication RF signal transmission device X6 according to the sixth embodiment of the present invention.

FIG. 54 is a block diagram schematically showing a branch section in a wireless-communication RF signal transmission device X7 according to a seventh embodiment of the present invention.

FIG. 55 is a block diagram schematically showing a branch section in a wireless-communication RF signal transmission device X8 according to an eighth embodiment of the present invention.

FIG. 56 schematically shows a wireless LAN system according to a ninth embodiment of the present invention.

FIG. 57 represents one example of estimation results of signal levels of transmission signals between a master unit and a slave unit in a general wireless LAN.

FIG. 58 is a block diagram showing an example of a wireless LAN antenna according to an embodiment of the present invention.

FIG. 59 is a view showing the structure of the wireless LAN antenna shown in FIG. 58.

FIG. 60 is a perspective view showing the antenna structure, shown in FIG. 59, in an assembled state.

FIG. 61 is a sectional view showing a double-sided antenna as a modification of the wireless LAN antenna according to the embodiment of the present invention.

FIG. 62 is a perspective view of the double-sided antenna shown in FIG. 61.

FIG. 63 is a perspective view showing another example of the double-sided antenna.

FIG. 64 is a perspective view showing one embodiment of a wireless LAN base station using the double-sided antenna.

FIG. 65 is a perspective view showing another embodiment of the wireless LAN base station using the double-sided antenna.

FIG. 66 is a set of perspective views showing different patterns of electric waves radiated from the wireless LAN base station shown in FIG. 64.

FIG. 67 is a set of perspective views showing different patterns of electric waves radiated from the wireless LAN base station shown in FIG. 65.

FIG. 68 is a set of plan views showing the patterns of electric waves shown in FIGS. 64 and 65.

FIG. 69 is a sectional view showing a one-sided type antenna structure of the wireless LAN antenna according to the embodiment of the present invention.

FIG. 70 is a sectional view showing a double-sided type antenna structure of the wireless LAN antenna according to the embodiment of the present invention.

FIG. 71 is a perspective view showing one example of the known wireless LAN system forming a plurality of network groups.

FIG. 72 is a perspective view showing another example of the known wireless LAN system forming a plurality of network groups.

FIG. 73 is a plan view showing cover areas where communication is feasible by the wireless LAN system shown in FIG. 72.

### BEST MODE FOR CARRYING OUT THE INVENTION

The present invention will be described in more detail below with reference to the accompanying drawings.

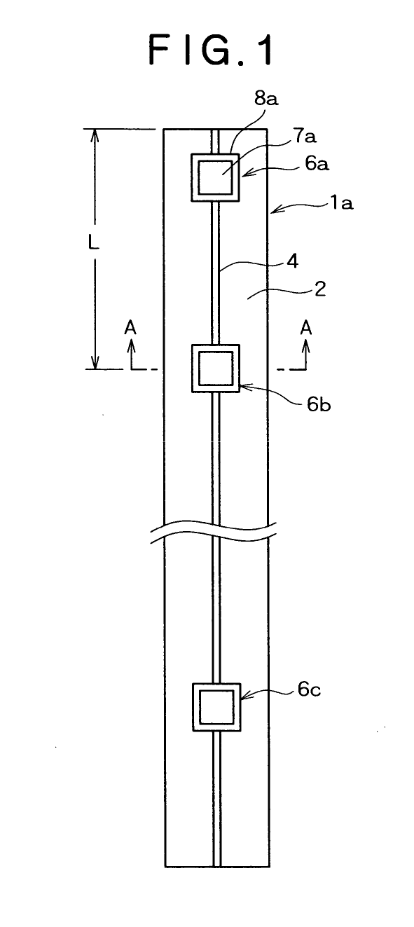

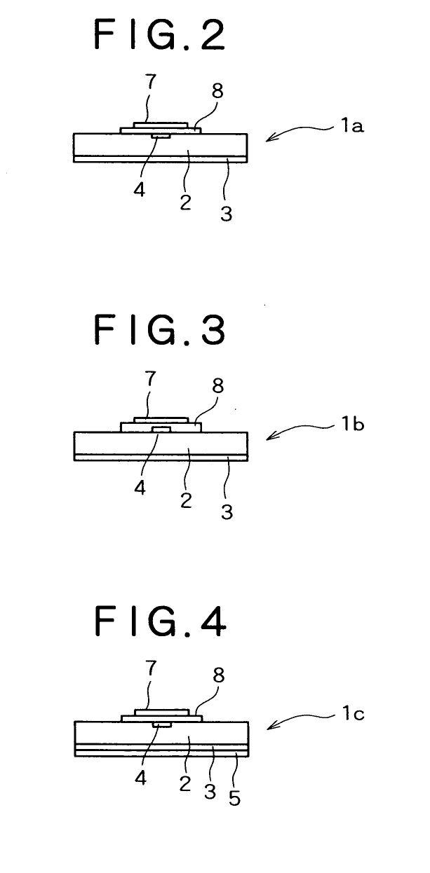

Referring to FIG. 1, a high-frequency line 1a of the present invention is in the form of a long thin plate having a length required for a wireless LAN system in a service area. The structure of the high-frequency line 1a in the direction of section (thickness) thereof is shown in FIG. 2. More specifically, on a ground layer 3 made of a conductive material, a dielectric layer 2 made of a dielectric material and a signal line 4 made of a conductive material and inducing a high-frequency wave are successively laid in the order named, thereby providing a layered flexible structure.

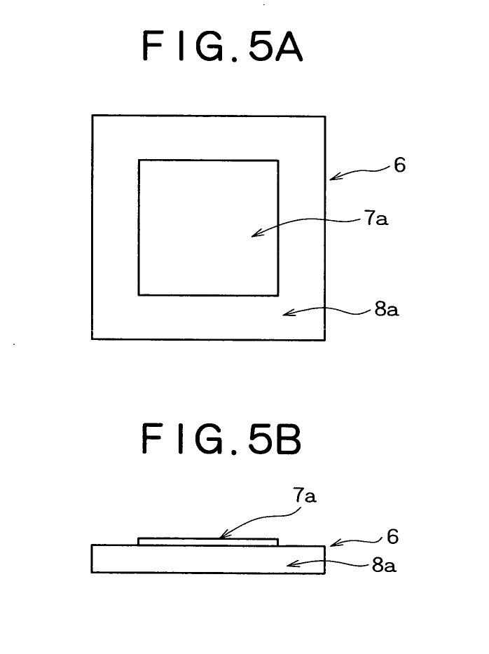

As shown in FIGS. 5A and 5B, by way of example, a patch antenna comprises a dielectric plate 8 made of a dielectric material and a patch 7 made of a conductive material, which are successively laid into a layered structure. Then, as shown in FIGS. 2-4, the patch antenna is disposed on the signal line 4 and is electrically coupled to the signal line 4. Further, as shown in FIG. 1, a plurality of patch antennas 6a-6c are disposed on the signal line 4 at predetermined intervals indicated by L, for example. The number of the patch antennas can be freely set; namely one or more patch antennas are selected, as required, depending on an application.

As represented by the high-frequency line 1a shown in FIG. 2, the signal line 4 may be embedded in the dielectric layer 2 and extended in the lengthwise direction of the high-frequency line 1a. Alternatively, as represented by a high-frequency line 1b shown in FIG. 3, the signal line 4 may be disposed to project above or rest on the dielectric layer 2 and extended in the lengthwise direction of the high-frequency line 1b.

The dielectric layer 2 is appropriately selected so as to meet conditions that losses of the high-frequency wave are not caused when no ground layer is disposed on the surface of the dielectric layer 2 at the same side as the signal line 4 and this surface side is entirely left open. In general, losses of the high-frequency wave from a high-frequency line are mainly divided into a radiation loss, a conductor loss, and a dielectric loss. To reduce the radiation loss among them, the dielectric layer 2 preferably has a higher dielectric constant. The dielectric constant is decided depending on the dielectric constant of the dielectric material itself of the dielectric layer 2 and the thickness of the dielectric layer 2. Therefore, the dielectric material and the thickness of the dielectric layer 2 are preferably selected so as to increase the dielectric constant. However, flexibility of the line is reduced as the dielectric constant of the material and the thickness of the dielectric layer increase. Taking into account those conditions, an optimum material and thickness of the dielectric layer are selected when flexibility is needed. Also, the conductor loss is reduced as the signal line 4 has a higher electrical conductivity. Therefore, an optimum electrical conductivity of the signal line 4 is preferably decided in consideration of the electrical conductivity required for the high-frequency line. Further, the dielectric loss is decided depending on the dielectric material itself of the dielectric layer 2, and therefore a material having a lower dielectric loss is preferably selected.

The dielectric layer 2 is required to have a certain width and thickness from the viewpoint of the relationship between the frequency of a signal required in the wireless LAN system and the losses of the high-frequency wave. From this aspect, assuming, for example, a standard indoor wireless LAN system used in an office or the like to be a basis, the dielectric layer 2 preferably has a thickness of about 0.1-2.0 mm and a width of about 10-50 mm.

Thus, as the dielectric material of the dielectric layer 2, it is preferable to select a material causing no radiation loss of the high-frequency wave and having a low dielectric loss on the premise of the width and thickness of the dielectric layer 2, which are selected from the above-mentioned preferable ranges. The dielectric material itself is preferably selected from among dielectric resin materials, such as Teflon (registered trademark), polyimide, polyethylene, polystyrene, polycarbonate, vinyl, and Mylar, and is used as a sole or mixed composition of one or more materials each having a low dielectric tangent of not more than 0.02, for example, which is an index (parameter) representing the dielectric loss. Those dielectric resin materials are able to maintain desired flexibility necessary for the high-frequency line of the present invention with proper setting of conditions, such as a composition.

The overall thickness of the high-frequency line of the present invention is preferably as thin as possible not more than 2 mm for the purpose of reducing the sectional area and volume of the high-frequency line. From this aspect, the thickness of each of the ground layer 3 and the signal line 4 is also preferably as thin as possible. The thickness of the ground layer 3 is preferably not more than 0.2 mm if the strength of a thin plate constituting the ground layer 3 is guarantied. Also, the width of the ground layer 3 is set corresponding to the width of the dielectric layer 2 because the ground layer 3 covers the dielectric layer 2 to suppress the losses of the high-frequency wave.

The conductive material of the ground layer 3 is appropriately selected to be a metallic good conductive material from among metals and alloys, such as copper, aluminum, tin, gold, nickel and solder, and is used in any of various forms including a composite or a layered structure of some of the metals and alloys, or a plating thereof on a resin base or the like. Among those materials, a metallic material is preferable because it can be easily machined into a thin plate and can provide a thin plate having flexibility in match with the dielectric material and exhibiting the required thin-plate strength.

The signal line 4 for inducing a high-frequency wave is formed of a thin wire or a thin plate made of a material also selected from the above-mentioned metallic good conductive materials.

Thus, since the high-frequency line 1a of the present invention is thin and flexible, it can be easily handled in manufacturing, transportation, installation, etc. in the form of a coil into which the long high-frequency line is wound, instead of the long plate form. In addition, the high-frequency line 1a has superior basic characteristics as a high-frequency line in points of, e.g., a low loss of the high-frequency wave propagating through the line.

A high-frequency line 1c of FIG. 4 shows another embodiment in which an adhesive layer 5, such as a double-sided adhesive tape or sheet made of the known adhesive material, is affixed to a lower side (surface) of the ground layer 3 of the high-frequency line 1a shown in FIG. 2. In the case employing the adhesive layer 5, the adhesive layer 5 is appropriately affixed to the whole or a part of the ground layer 3 in the lengthwise and/or widthwise direction thereof depending on positions where adhesion of the line is required. The adhesive layer 5 enables the high-frequency line to be freely and more easily installed and removed in arbitrary or desired places depending on installation conditions within the area.

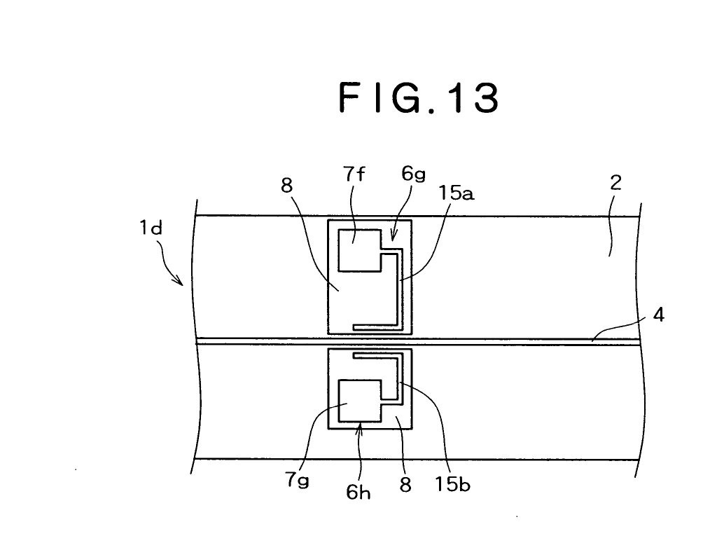

Each of the patch antennas 6a-6c according to the present invention, which are disposed on the high-frequency line shown in FIG. 1, comprises a radiation plate (patch) 7a made of a metallic conductive material and radiating a high-frequency wave, and a dielectric (plate) 8a interposed between the radiation plate 7a and the dielectric layer 2, as shown in FIG. 5. Means for electrically coupling the patch antenna and the signal line can be practiced in any other appropriate manner than arranging the patch antenna on the signal line as shown in FIG. 1. For example, as shown in FIG. 13 described later, the patch antenna may be arranged aside the signal line 4, and a feeder may be disposed for electrical coupling between them.

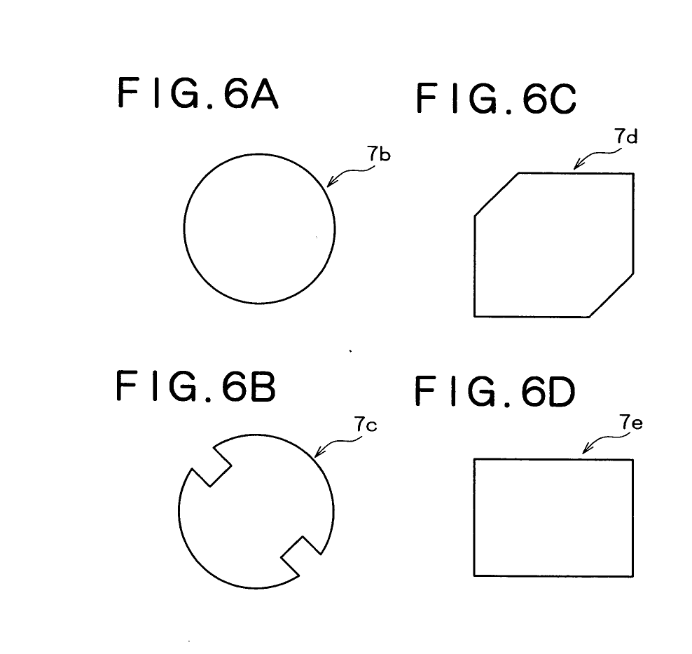

Instead of the planar square form of the radiation plate 7 shown in FIGS. 1-4, other desired antenna shapes can also be selected depending on the arrangement of slave units or terminals and the receiving conditions within the area, as shown in plan views of various radiation plates shown in FIGS. 6A-6D. FIG. 6A shows a circular radiation plate 7b, and FIG. 6B shows a substantially circular radiation plate 7c partly cut out. FIG. 6C shows a substantially quadrilateral radiation plate 7d partly cut out at corners, and FIG. 6D shows a rectangular radiation plate 7e.

The conductive material of the radiation plate (patch) 7a can be selected to be the same metallic material as that used for the conductive material to form the ground layer of the high-frequency line. Also, the dielectric material of the dielectric 8a can be selected to be the same as the dielectric resin material having a low loss and used to form the dielectric layer of the high-frequency line.

With the patch antenna thus constructed, the antenna can be easily attached to and detached from the high-frequency line. Accordingly, even in the case where the antenna arrangement of the wireless LAN system must be changed depending on, e.g., change in layout of the office, it is just basically required to attach and detach the patch antennas depending on a new layout. In other words, work for installing the high-frequency line itself again is not required so long as the entire area can be covered by the high-frequency line of the present invention, which is already installed.

Further, in the case requiring a modification of the used radio frequency with respect to primary characteristics of the antenna, such as the coupling ratio and gain, that modification can be easily performed by adjusting conditions on the patch antenna side, such as the material properties and thickness of the radiation plate and the dielectric, or by employing other patch antennas adjusted to be adapted for the required conditions.

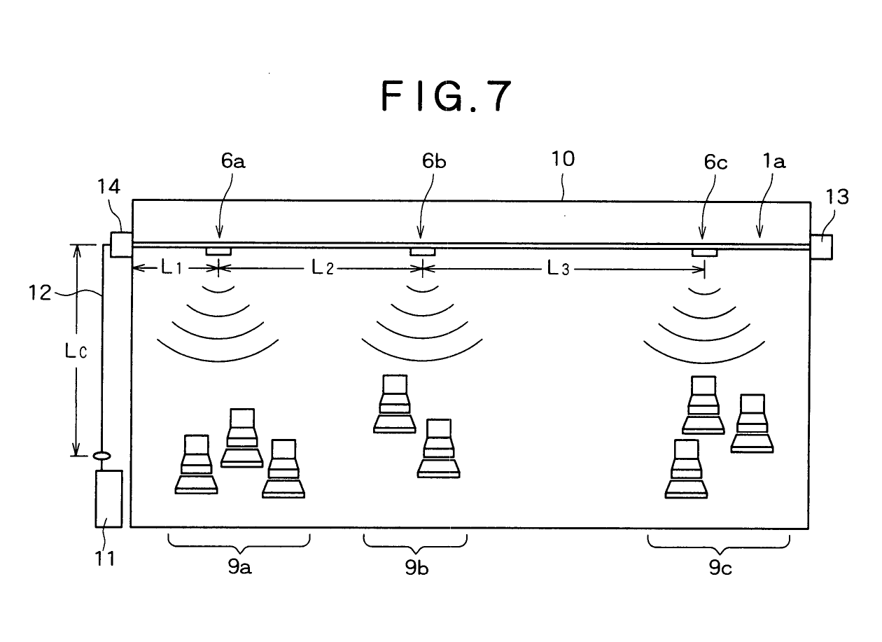

FIG. 7 is a front view showing an embodiment in which the high-frequency line 1a of the present invention, shown in FIG. 1, is applied to an indoor wireless LAN system. Referring to FIG. 7, the high-frequency line 1a is disposed to extend along an interior ceiling of a building 10 (i.e., in an upper space within the area). One end of the high-frequency line 1a is formed as a non-reflecting terminator 13, and a wireless LAN master unit 11 is connected to the other end of the high-frequency line 1a via a coaxial cable 12. A plurality of wireless LAN slave unit groups (terminal groups) 9a, 9b and 9c communicating with the wireless LAN master unit are disposed indoor.

Then, depending on the layout of the wireless LAN slave unit groups 9a, 9b and 9c (which are disposed at irregular intervals in FIG. 7), the patch antennas 6a, 6b and 6c are disposed on the high-frequency line 1a at irregular intervals L2, L3 to be able to ensure good communication with each corresponding wireless LAN slave unit group (within the area). Stated another way, the patch antenna 6a is disposed corresponding to the slave unit group 9a, the patch antenna 6b is disposed corresponding to the slave unit group 9b, and the patch antenna 6c is disposed corresponding to the slave unit group 9c so that good communication is ensured for each wireless LAN slave unit group.

Additionally, when the high-frequency line of the present invention is applied to the wireless LAN system, the surface of the high-frequency line may be painted or covered with a pouch in match with the painting or ornaments within the area or the indoor space, or for the purpose of corrosion resistance, etc.

Even with the high-frequency line of the present invention, the attenuation rate of the high-frequency wave transmitted through the high-frequency line inevitably differs depending on positions (places) where the patch antennas are attached to the high-frequency line. In order to ensure good communication for each slave unit, therefore, the coupling ratio between the patch antenna and the high-frequency line must be adjusted to an optimum coupling ratio depending on the place where the patch antenna is attached to the high-frequency line (i.e., the attenuation degree of the high-frequency wave).

More specifically, in FIG. 7, the coupling ratio between the patch antenna 6a and the high-frequency line 1a is calculated to obtain a value that is required when the high-frequency radio wave is radiated from the patch antenna 6a for communication with the slave unit group 9a in a neighboring area. Assuming now that the output power of the wireless LAN master unit 11 is P (dB/m), the length of the coaxial cable 12 is Lc (m), the attenuation rate of the high-frequency wave is Ac (dB/m), and the distance between the patch antenna 6a and one end 14 of the high-frequency line 1a is L1, power Pa (dB/m) to be radiated from the patch antenna 6a is calculated from the following formula at a certain maximum distance to the slave unit group 9a:
Pa=(P−Lc×Ac−L1×Am)×C1
[where Am is the attenuation rate (dB/m) of the high-frequency line, and C1 is the coupling ratio between the patch antenna 6a and the high-frequency line 1a required at the point of the patch antenna 6a]

When the coupling ratio between the actually attached patch antenna 6a and the high-frequency line 1a is much larger than the required coupling ratio C1, the power radiated from the patch antenna is wasted. Conversely, when the actual coupling ratio is much smaller than the required coupling ratio C1, the radiated power is insufficient and a communication area is narrowed. This results in a possibility that a communication failure may occur at some of the slave units. For that reason, the coupling ratio between the patch antenna and the high-frequency line must be adjusted to an optimum coupling ratio.

The coupling ratio between the patch antenna and the high-frequency line can be adjusted by (1) changing the relative position of a center axis of the patch antenna to a center axis of the signal line of the high-frequency line, and (2) adjusting the conditions of the patch antenna, such as the material properties and thickness of the radiation plate and the dielectric of the patch antenna. Of those methods, the method (1) can be practically performed by changing a direction of the relevant patch antenna in a plane so as to change the above-mentioned relative position.

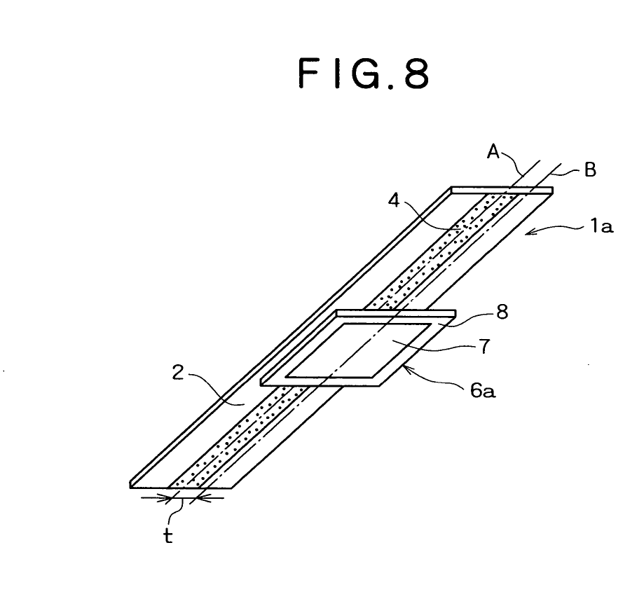

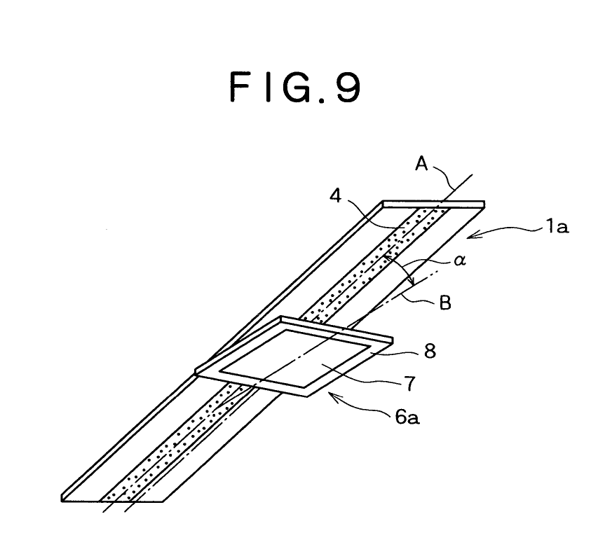

Such a practical manner of changing the direction of the relevant patch antenna in a plane so as to change the above-mentioned relative position is illustrated in FIGS. 8 and 9 as perspective views of the high-frequency line 1a. Referring to FIGS. 8 and 9, A represents the (lengthwise) center axis of the signal line 4 or the high-frequency line 1a in the lengthwise direction thereof, and B represents the center axis of the patch antenna 6a in the lengthwise direction of the high-frequency line 1a. FIG. 8 shows the case where the above-mentioned relative position is changed by shifting the center axis B of the patch antenna 6a from the center axis A of the signal line 4 by a distance t in parallel. Also, FIG. 9 shows the case where the above-mentioned relative position is changed by turning the center axis B of the patch antenna 6a to be horizontally shifted from the center axis A of the signal line 4 by an angle α.

The parallel moving manner shown in FIG. 8, however, has a limitation in adjusting the coupling ratio between the patch antenna and the high-frequency line because the distance t and the change of the above-mentioned relative position are restricted due to limitations on the widths of the high-frequency line 1a and the signal line 4. On the other hand, the turning method shown in FIG. 9 is free from those restrictions and enables the coupling ratio to be adjusted over a relatively large range.

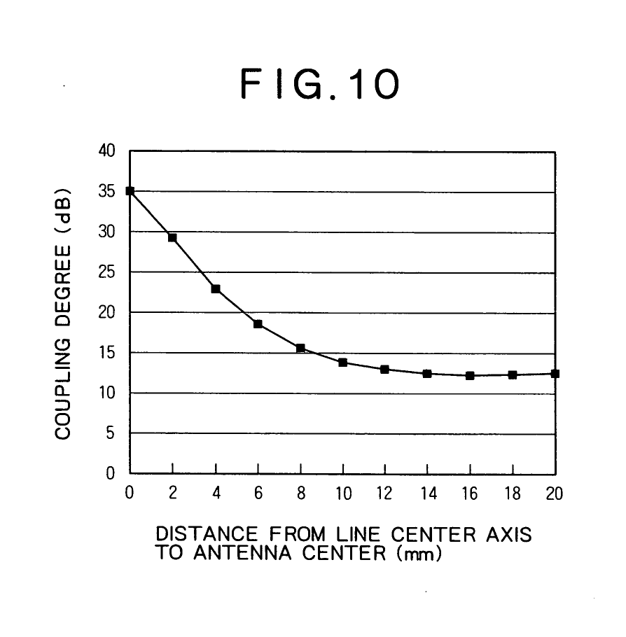

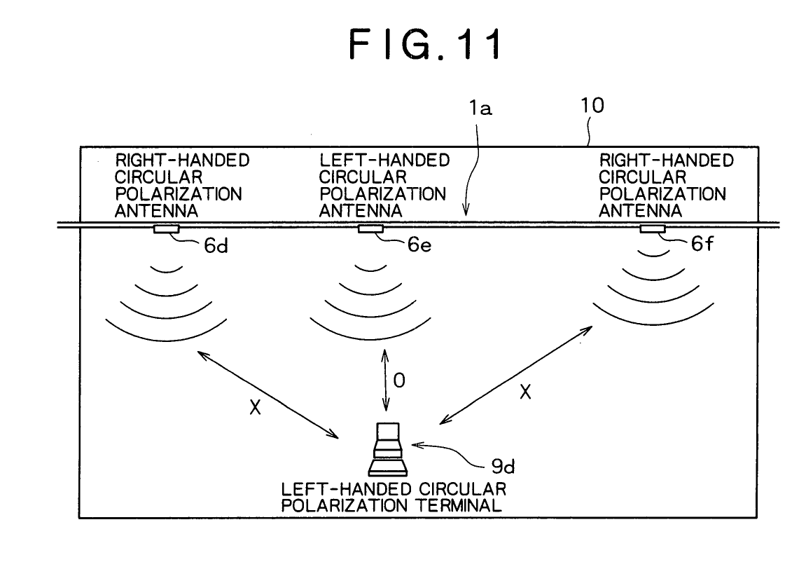

FIG. 10 shows change of the coupling ratio between the patch antenna and the high-frequency line when the distance from a center point of the patch antenna 6a to the center axis A of the signal line 4 or the high-frequency line 1a is changed by the turning manner shown in FIG. 9. As seen from FIG. 10, it is confirmed that the coupling ratio is reduced as the distance from the center point of the patch antenna 6a to the center axis A increases, and therefore the coupling ratio is adjustable.

In the wireless LAN system of FIG. 7, crosstalk between high-frequency waves radiated from adjacent two of the patch antennas 6a, 6b and 6c may occur depending on the layout of the wireless LAN slave unit groups. To cope with such a problem, circular polarized antennas 6d, 6e and 6f transmitting waves circularly polarized in opposite directions are alternately disposed as shown in FIG. 11. More specifically, in the embodiment of FIG. 11, the patch antenna 6e is constituted as a left-handed circular polarized antenna, and the patch antennas 6d, 6f adjacent to the patch antenna 6a are each constituted as a right-handed circular polarized antenna, to thereby prevent crosstalk of the high-frequency waves radiated from the patch antennas 6d, 6f with the high-frequency wave received by a left-handed circular polarization terminal 9d corresponding to the patch antenna 6e. Also, even when the wireless LAN antenna of the terminal 9d is a linear polarized antenna, it can receive resultant waves of the high-frequency waves radiated from the patch antennas 6e, 6d and 6f while those waves are prevented from canceling each other.

A description is now made of a method for establishing connection to a target slave unit or terminal in the area with the best communication sensitivity by giving a phase difference between the high-frequency waves fed to the patch antennas, to thereby control directivity of the relevant patch antenna.

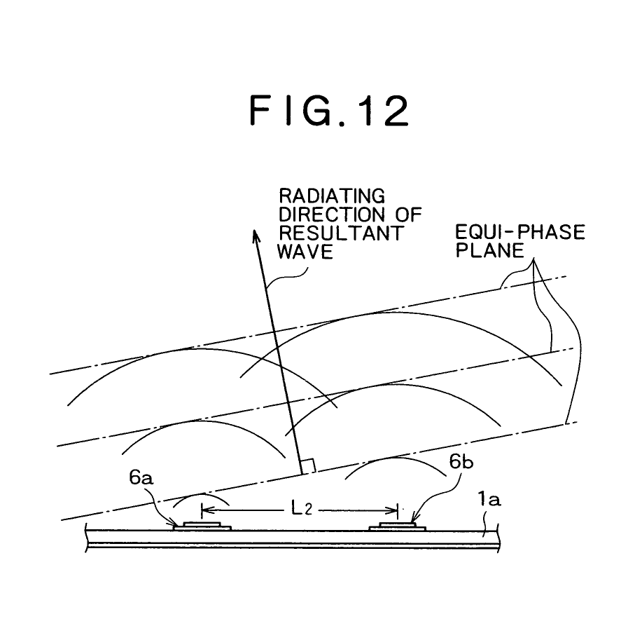

Taking FIG. 12 as an example, electric waves are usually radiated from the patch antennas 6a, 6b in the front direction. However, when the slave unit group or terminal is not positioned just in front of (or under) the high-frequency line 1a, or when the high-frequency line 1a is itself installed near a wall and hence the slave unit group or terminal is not positioned just in front of the high-frequency line 1a, the electric wave is wastefully radiated in the undesired direction not toward the slave unit group or terminal, thus resulting in lower efficiency. For that reason, the radiating direction of the electric wave must be controlled to make the electric wave propagated toward the slave unit group or terminal by controlling directivity of the relevant patch antennas.

The directivity of the relevant patch antennas can be controlled by adjusting the phase of a high-frequency signal fed to the patch antenna. One method for adjusting the phase of the fed signal is to adjust the relationship between the effective wavelength in the high-frequency line and the installation interval of the patch antennas. The phase difference between high-frequency signals fed to the patch antennas is given as a phase difference corresponding to the interval of the patch antennas installed in the high-frequency line. Assuming, for example, that the effective wavelength in the high-frequency line 1a is λ and the installation interval L of the patch antennas 6a, 6b is 1.25×λ in FIG. 12, the electric waves radiated from those patch antennas have a phase difference of 1.25 wavelength. Because of one cycle corresponding to 2 π, the phase difference at the patch antenna 6b is 0.5 π (or 2.5 π) on condition that the phase difference at the patch antenna 6a is 0.

FIG. 12 shows how the high-frequency waves are radiated from the patch antennas 6a, 6b in such a situation. FIG. 12 is a front view partly showing the high-frequency line 1a shown in FIG. 7. As shown, a resultant wave (indicated by an arrow) as a combination of the high-frequency waves radiated from the patch antennas 6a, 6b is radiated in an direction (as indicated by the arrow) offset from the direction forward of the antennas depending on the phase difference. In other words, the directivity of the relevant patch antennas can be controlled toward any desired direction by adjusting the installation interval of the patch antennas in relation to the effective wavelength in the high-frequency line. However, this adjusting method is able to control the antenna directivity only in the direction in which the high-frequency line is disposed to face. Also, this adjusting method is applicable to the case where the distance L2 between the patch antennas 6a, 6b is within several times the wavelength.

As another method for adjusting the phase of the fed signal, the following description is made on a method capable of controlling the antenna directivity toward any desired direction regardless of the direction in which the high-frequency line is disposed to face. As shown in FIG. 13 that is a plan view of the high-frequency line, patch antennas 6g, 6h are disposed on both sides of the signal line 4 (near the signal line 4). Patches 7f, 7g are electrically coupled to the signal line 4 via feeders 15a, 15b, respectively. Then, the lengths of the feeders 15a, 15b are adjusted to differ from each other (in FIG. 13, the feeder 15a has a larger length than the feeder 15b). As a result, the directivity of each patch antenna can be freely controlled by adjusting the phases of signals fed to the patch antennas 6g, 6h.

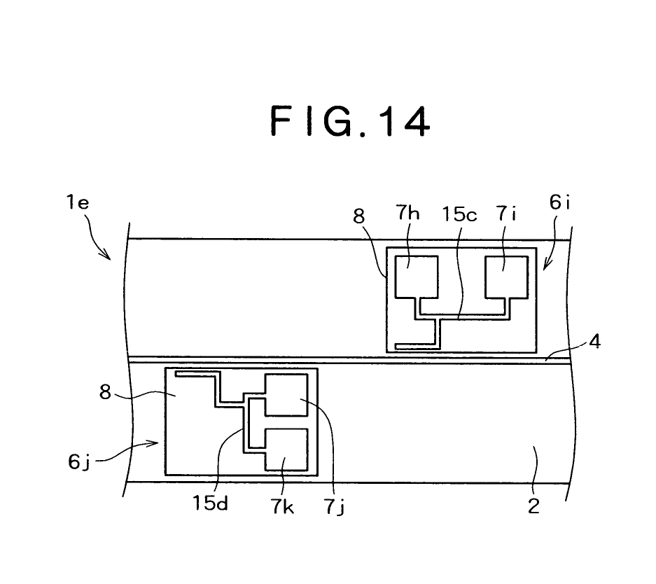

FIG. 14 is a plan view showing patch antennas prepared by arranging the plurality of patch antennas, shown in FIG. 13, in a proper combination beforehand in accordance with a desired offset angle. More specifically, patch antennas 6i, 6j are disposed on both sides of the signal line 4 at positions shifted from each other. Then, the phases of signals fed to the patch antennas 6i, 6j are adjusted by adjusting respective lengths of feeders 15c, 15d connected to patches 7h, 7i, 7k and 7j, or respective lengths of branched lines of the feeder 15c, or respective lengths of branched lines of the feeder 15d. As a result, the directivity of each patch antenna can be freely controlled. In other words, the antenna directivity can be freely controlled in each position from which the high-frequency wave is radiated, by preparing the patch antennas 6g, 6h, 6i and 6j beforehand and attaching them in a proper combination (as required) adapted for control of the desired direction of the antenna directivity.

Preferable embodiments for splicing the high-frequency lines of the present invention to each other will be described below. As described above, the high-frequency lines of the present invention can be each manufactured in length of 2-5 m or over. Stated another way, the high-frequency line of the present invention can be manufactured in such a length that a single line is able to cover the length of an area for the wireless LAN system. Depending on conditions within the area, however, the high-frequency lines of the present invention require to be spliced to each other in the lengthwise direction thereof when adjacent rooms or floors (stocks) are interconnected. In that case, it is required to prevent a leakage or loss of the high-frequency wave at a joint portion, or to eliminate intricacy in splicing work.

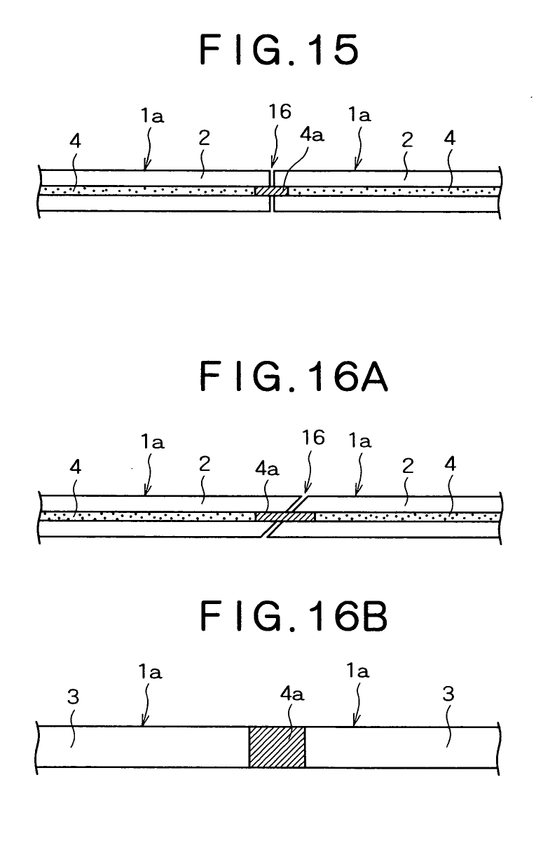

FIG. 15 is a plan view showing one embodiment foe splicing the high-frequency lines to each other in the lengthwise direction thereof. Referring to FIG. 15, in a joint portion 16, the high-frequency lines 1a have planar ends which are planar perpendicularly to the lengthwise direction of the high-frequency lines 1a. Numeral 4a denotes a short signal line in the form of a thin sheet made of a conductive metal, such as a copper foil, and used for splicing the signal lines 4 of the high-frequency lines 1a to each other. With this splicing method, a high-frequency signal propagating from one high-frequency lines 1a via the signal line 4 tends to partly cause a wave reflected at the joint portion 16 where the high-frequency lines 1a are discontinuous. The reflected wave may become a multi-path component in the wireless LAN system and may increase an error rate of communicated data though depending on the amount of the reflected wave.

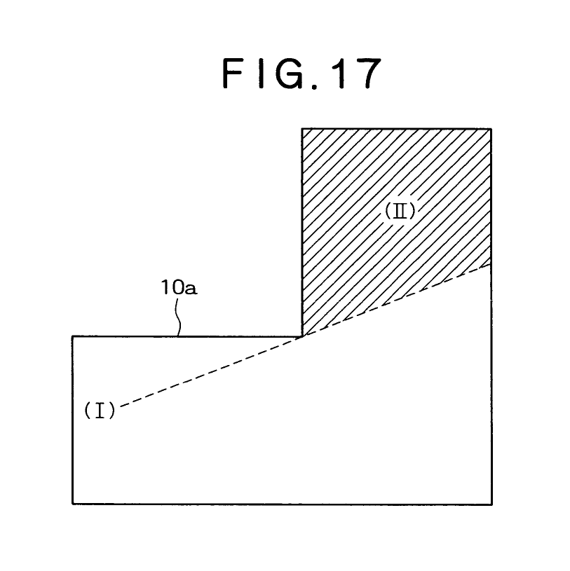

FIG. 16 shows another preferable embodiment of a splicing method for reducing the amount of the wave reflected at the joint portion 16. FIG. 16A is a plan view looking the joint portion between the high-frequency lines from the surface side, and FIG. 16B is a sectional view looking the joint portion, shown in FIG. 16A, from the rear side. As seen from FIGS. 16A and 16B, the splicing method shown in FIG. 16 is similar to the method shown in FIG. 15 in that the signal lines 4 of the high-frequency lines 1a are spliced to each other using the short signal line 4a. In the embodiment shown in FIG. 16A, however, the planar ends of the high-frequency lines 1a are formed to have a predetermined slope angle. The planar ends having the predetermined slop angle are joined to each other to constitute the joint portion 16 having the predetermined slop angle relative to the lengthwise direction of the high-frequency lines 1a.

With the thus-constituted joint portion 16 having the predetermined slop angle, although the high-frequency signal is partly reflected at the discontinuous surface of the sloped joint portion 16, the reflected waves are avoided from having exactly the same phase and are dispersed as waves having different phases because the incident waves are reflected at different positions. As a result, the reflected waves having different phases cancel each other, and this effect reduces the total amount of the reflected waves. Incidentally, the signal line 4a (conductor) used for slicing the high-frequency lines is not required to have a planar slope angle. Also, the signal line 4a is electrically connected to the signal line 4 of each high-frequency line 1a by soldering or mechanical pressing.

Further, the high-frequency line of the present invention has the effect of enabling the high-frequency line to be easily installed in an area where good visibility is not given from a master unit toward slave units due to the presence of obstacles, such as walls, pillars, and steel racks. By employing the high-frequency micro-strip line of the present invention while it is shaped so as to have bent portions (by bending or curving) in match with the shape of the service area, good communication quality can be presented even in the area where good visibility is not given from a master unit toward slave units, and good communication quality can be realized in the entire area.

With the known wireless LAN antenna, there is a high possibility that, even on the same floor, the communication quality is deteriorated and the communication bit rate is lowered in an area having no good visibility. In contrast, the high-frequency micro-strip line of the present invention is flexible and can be used not only as a straight high-frequency line, but also in the form bent in the desired direction, e.g., horizontally or vertically, by bending the high-frequency line itself in match with the shape of the area, i.e., the layout of the area having no good visibility, (such that the high-frequency line is shaped to have bent portions). Accordingly, good communication quality can be presented even in the area where good visibility is not given from the master unit toward the slave units, and good communication quality can be realized in the entire area.

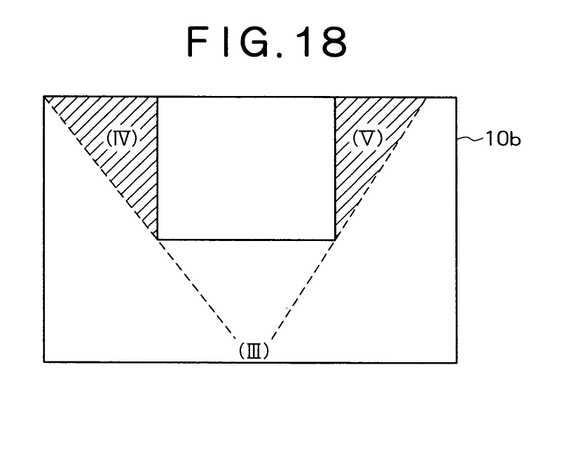

That effect will be described in more detail below. When a wireless LAN master station is installed in an office or other room 10a, 10b having an L- or channel-shaped floor plan (area) as shown in FIG. 17 or 18, there has hitherto been a possibility that, if the master station is installed in a position I or III, communication is disabled or the communication bit rate is lowered in a hatched zone II, IV or V where good visibility is not given toward the master station. To ensure good communication quality in the whole of the office or other room 10a, 10b including an area with no good visibility toward the master station as shown in FIG. 17 or 18, therefore, a difficulty arises in covering the entire area by one master station, and a plurality of master stations are required to cover the area having no good visibility toward the master station.

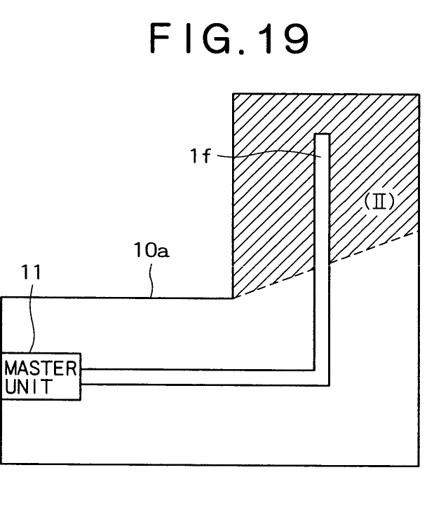

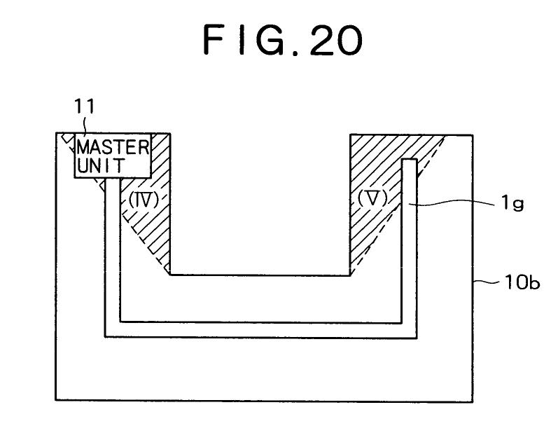

In contrast, because of having flexibility, the high-frequency micro-strip line of the present invention can be used while bending line itself in match with the floor plan of the office or other room 10a, 10b having an L- or channel-shaped area, as shown in FIG. 19 or 20. More specifically, the high-frequency line of the present invention is itself bent horizontally at, e.g., 90 degrees (so as to have a 90-degree bent portion) in match with the shape of the hatched zone II, IV or V where good visibility is not given toward the master station. By employing the high-frequency line of the present invention thus bent into an L-shape 1f in FIG. 19 or a channel-shape 1g in FIG. 20, good communication can be ensured while covering the hatched zones II, IV and V as well. Thus, by bending (curving) the high-frequency line of the present invention in an appropriate direction or at an appropriate angle in match with the office floor plan or shape and installing it, the entire area of the office where good communication is to be ensured can be covered by only one master station.

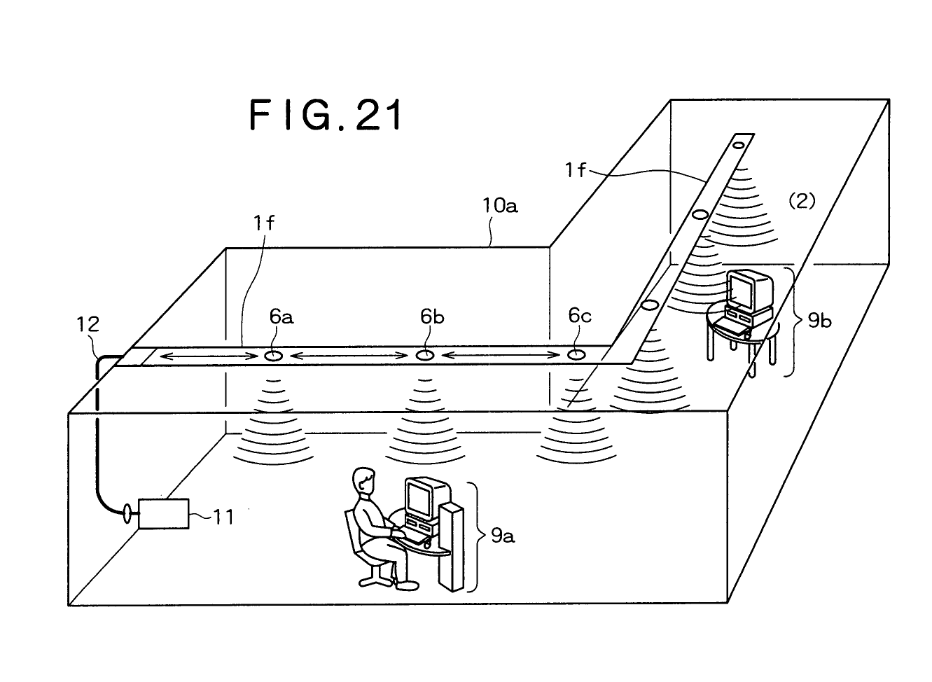

FIG. 21 three-dimensionally shows the L-shaped office 10a of FIG. 19. Referring to FIG. 21, the high-frequency line 1f is disposed to extend in an upper space within the area, e.g., along the backside or an interior surface of the ceiling of the building 10a. One end of the high-frequency line 1f is formed as a non-reflecting terminator, and a wireless LAN master unit 11 is connected to the other end of the high-frequency line via a coaxial cable 12. Depending on the layout of wireless LAN slave unit groups 9a and 9b, a patch antenna 6a, etc. are disposed on the high-frequency line 1f in one-to-one relation to the slave unit group 9a, etc.

The high-frequency line 1f is bent into an L-shape and arranged in match with the area shape of the hatched zone II having no good visibility. Therefore, high communication quality can be ensured for not only the wireless LAN slave unit group (terminal group) 9a having good visibility from the wireless LAN master unit 11, but also the wireless LAN slave unit group 9b disposed in the hatches zone II, i.e., in an area where good visibility is not given from the wireless LAN master unit 11.

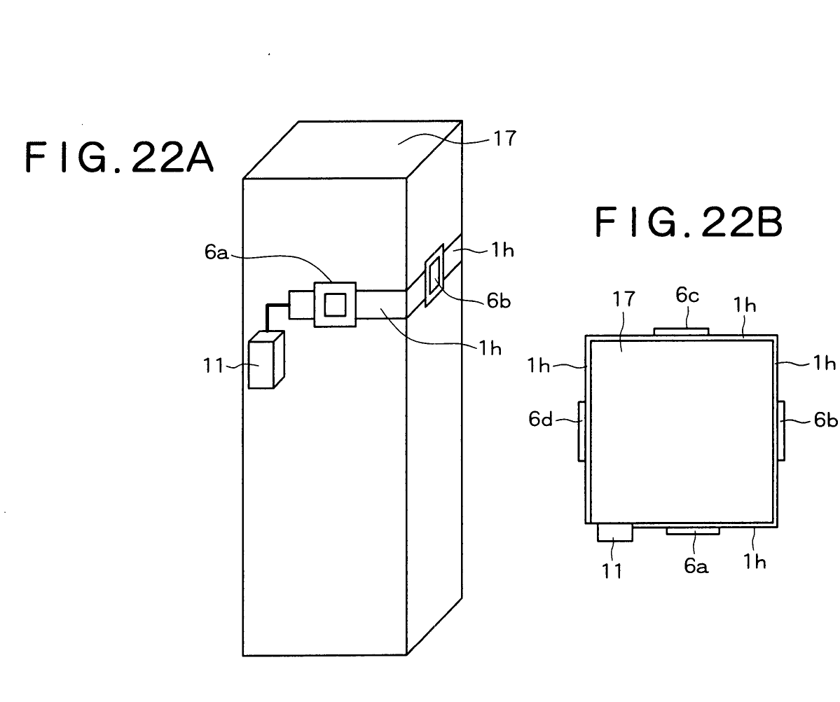

FIGS. 22A and 22B show another embodiment. FIG. 22 shows the case that a large pillar 17 having a rectangular cross-section is present in a service area. In this case, the pillar 17 generates the so-called shadow place where electric waves do not reach directly. To avoid the occurrence of the shadow place, as shown in FIGS. 22A and 22B, a high-frequency line 1h is bent three times at 90 degrees to have four bent portions such that the line is wound over four peripheral surfaces of the pillar 17. Then, one of the patch antennas 6a, 6b, 6c and 6d is disposed on the high-frequency line 1h for each of four directions (in each side of the pillar 17), and the line 11h is connected to one master unit 11. With that arrangement, all 360-degree directions can be covered about the pillar 17 and any shadow place is not caused in the area.

Thus, since the high-frequency line of the present invention in a combination of a strip line and patch antennas has a highly flexible structure and can be easily deformed, the advantages are obtained in that the line can be deformed depending on the floor plan of an area to be communicated, a high throughput can be uniformly realized over the entire area, and the number of required master stations can be minimized. Other advantages are that radio frequency channels can be efficiently used and the same frequency channel can be repetitively used in a wide area while reducing a degree of the influence of interference (crosstalk).

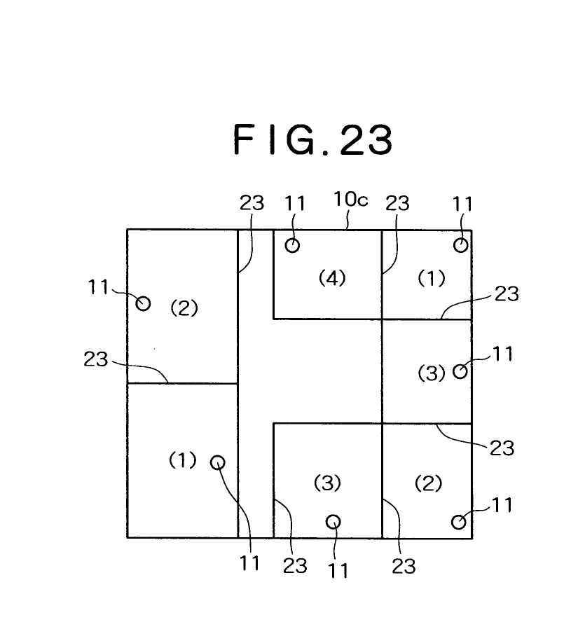

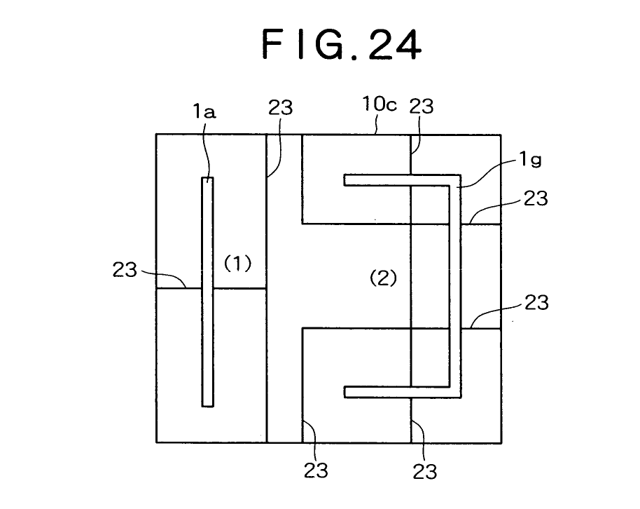

FIGS. 23 and 24 show examples of channel arrangement. In the case using the known high-frequency line, as shown in FIG. 23, because an entire floor space is partitioned by several walls 23, one frequency channel is required for each room in a floor plan 10c partitioned by the walls 23, etc. Therefore, the same channel must be used in neighboring rooms in a repetitive manner. This raises a problem that interference is apt to occur between rooms I, between rooms II, and between rooms III where the same channel is used, and radio waves of the same channel existing nearby tend to become interference noises. To prevent such a problem, the wireless LAN master station 111 requires to be installed in each of the rooms.

In contrast, as shown in FIG. 24, the high-frequency line of the present invention can be installed in a free combination of, e.g., the linear high-frequency line 1a and the high-frequency line 1g having portions bent into a channel shape. Accordingly, it is possible to cover the whole of the floor layout 10c and to ensure high communication quality with a less number of channels without causing influences of crosstalk and interference.

As described above, the high-frequency line of the present invention can be installed by relatively easy work of attaching the line to the ceiling or the backside of the ceiling depending on a service area. When a ceiling material is made of plaster or the like as often used in offices, high-frequency wave in a band of 2.45 GHz are just slightly attenuated and fairly pass through the ceiling.

In that case, it is preferable to not only hold a certain spacing between the surface of the high-frequency line or the surface of the patch antenna of the present invention and the surface on which the high-frequency line is installed (e.g., the ceiling surface or the backside surface of the ceiling), but also to isolate a radiating section of the patch antenna at the surroundings thereof. That arrangement is effective in reducing the amount of the high-frequency wave reflected by the material of a different nature, such as the ceiling material.

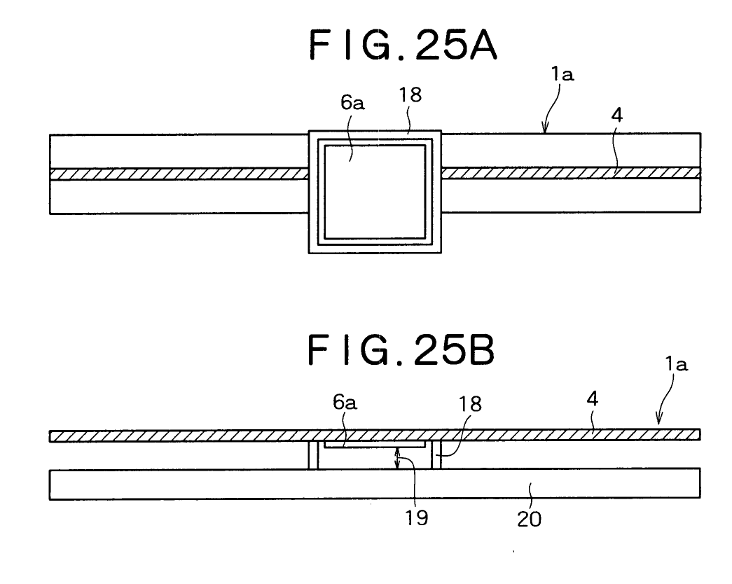

That embodiment of the high-frequency line of the present invention is shown in FIGS. 25A and 25B which are a plan view and a sectional view, respectively. In the high-frequency line of the present invention shown in FIG. 25, an insulator 18 is disposed around a radiating section of the patch antenna 6a, and the insulator 18 also serves as a spacer for holding a gap 19 between the surface of the patch antenna 6a and the surface of a ceiling material 20. This arrangement is able to increase the amount of high-frequency power passing through the ceiling material 20 in comparison with the case of the patch antenna being disposed in direct contact with the ceiling surface or the backside surface of the ceiling. The reason is that, because the shape of the patch antenna is designed so as to radiate a high-frequency wave into air from the antenna, a transmission path formed from the antenna to air and then from air to the ceiling material can reduce the amount of the high-frequency wave reflected by the ceiling material in comparison with a transmission path formed just from the antenna to the ceiling material. As a result, a level of the transmitted/received signal can be increased and the communication S/N can be improved, whereby stable quality can be held.

While the description has been made above in connection with the high-frequency line of the present invention using primarily one kind of high-frequency wave, the high-frequency line of the present invention is also applicable to a system using two or more kinds of high-frequency waves having different frequencies. The following description is made on embodiments in which the high-frequency line of the present invention is applied to a system using two or more kinds of high-frequency waves.

The high-frequency line of the present invention is able to not only employ only one kind of high-frequency wave in a 2.45-GHz band, but also simultaneously employ (transmit or transmit/receive) a plurality of high-frequency waves having different frequencies, e.g., a high-frequency wave in a 5.2-GHz band in addition to the high-frequency wave in the 2.45-GHz. Also, with more widespread use of the wireless LAN system forming a radio communication network in the society, a possibility of simultaneously employing different frequency bands or employing a larger number of frequencies or channels is increased as a matter of course. To cope with such a case, the patch antenna connected to the signal line of one high-frequency line is preferably made to be adaptable for (capable of transmitting and receiving) each of the high-frequency waves having different frequencies.

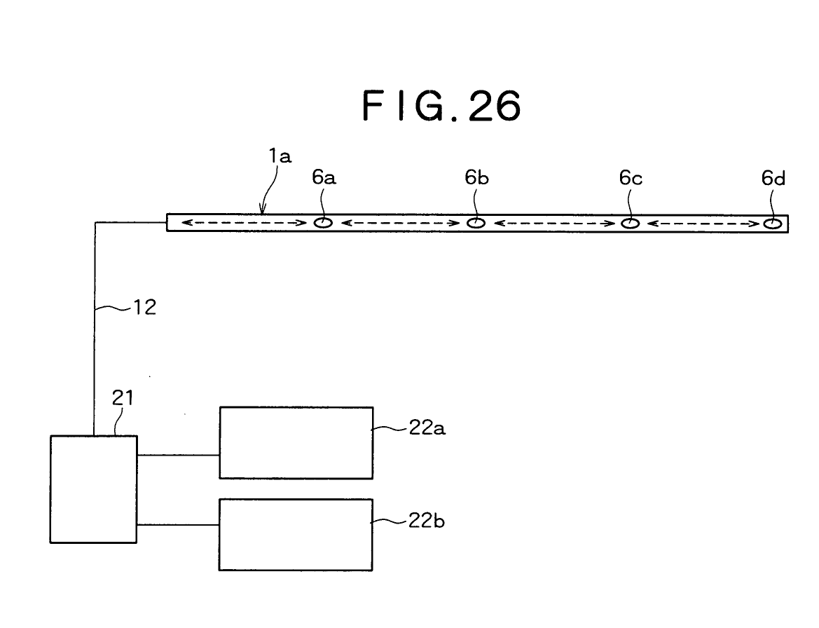

FIG. 26 is a front view of an indoor wireless LAN system according to the embodiment in which a plurality of high-frequency waves having different frequencies are employed at the same time. Referring to FIG. 26, the high-frequency line 1a is disposed as in the embodiment shown in FIG. 7. In order to transmit (transmit and receive) two kinds of high-frequency waves in the 2.45-GHz band and the 5.2-GHz band by the high-frequency line 1a, a 2.45-GHz band wireless LAN access point 22a and a 5.2-GHz band wireless LAN access point 22b are connected to a combining/distributing unit 21 (disposed in the master unit not shown) for combining and distributing the two kinds of high-frequency waves.

With such an arrangement, the two kinds of wireless LAN signals (high-frequency waves) in the 2.45-GHz band and the 5.2-GHz band combined by the combining/distributing unit 21 are transmitted through the single high-frequency line 1a in two ways as indicated by dotted arrows. Then, as in the embodiment shown in FIG. 7, the signals of the two frequencies are transmitted from and received by the patch antennas 6a, 6b, 6c and 6d, which are disposed on the high-frequency line 1a with respective electrical coupling ratios properly adjusted, for communication with slave units (not shown) connected to user's personal computers.

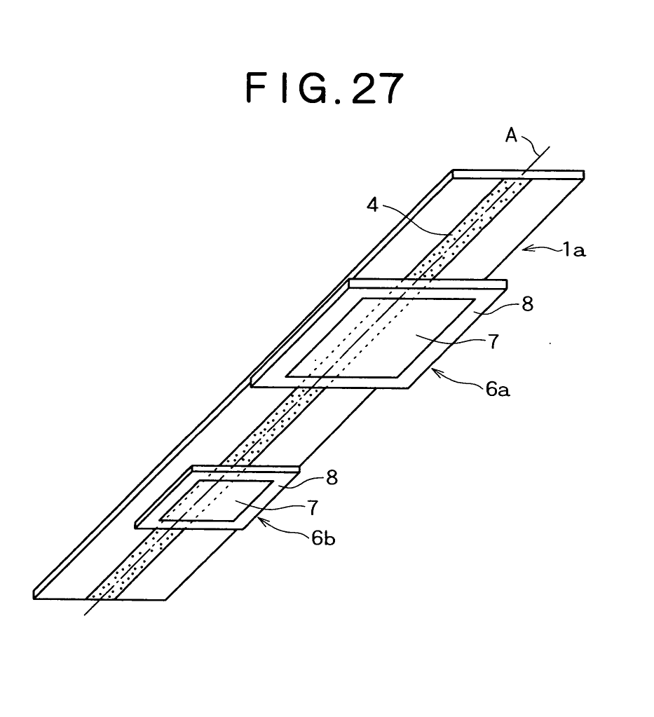

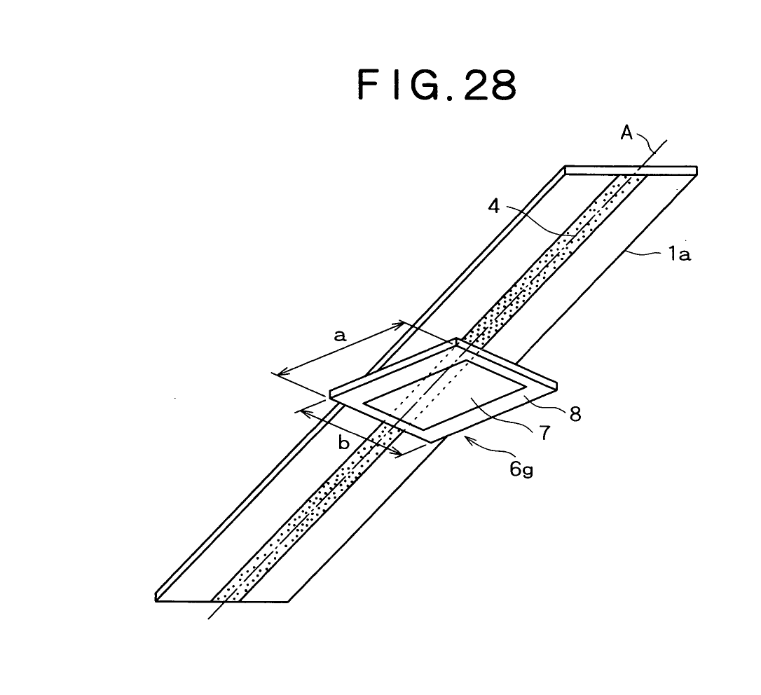

In the embodiment of FIG. 26 simultaneously employing a plurality of high-frequency waves having different frequencies, the patch antennas 6a, 6b, 6c and 6d disposed on the high-frequency line 1a with respective electrical coupling ratios properly adjusted are constituted as shown in FIGS. 27 and 28 so that good communication is ensured for each of the plurality of high-frequency waves having different frequencies.

FIGS. 27 and 28 are perspective views of the high-frequency line 1a. The high-frequency line 1a shown in FIGS. 27 and 28 has the same basic construction as that shown in FIGS. 7 and 8. Referring first to FIG. 27, the patch antenna 6a is adapted for a lower frequency in, e.g., the 2.45-GHz band, and the patch antenna 6b is adapted for a higher frequency in, e.g., the 5.2-GHz band. In other words, FIG. 27 shows an embodiment in which two kinds of patch antennas, i.e., the patch antenna 6a for a lower frequency and the patch antenna 6b for a higher frequency, are alternately arranged. A way of arranging the two kinds of patch antennas is appropriately decided or selected depending on the frequency of the high-frequency wave used in the slave unit, etc. corresponding to each patch antenna.

The lower-frequency patch antenna 6a and the higher-frequency patch antenna 6b are similar to the patch antenna shown in FIGS. 7 and 8 in points that each patch antenna comprises a radiation plate (patch) 7 made of a metallic conductive material and radiating a high-frequency wave, and a dielectric (plate) 8, and that each patch antenna has a square shape in plan view. However, the higher-frequency patch antenna 6b is formed to have a smaller area (size) adapted for the high-frequency wave in, e.g., the 5.2-GHz band than that of the lower-frequency patch antenna 6a for, e.g., the 2.45-GHz band.

Regardless of whether the transmitted high-frequency wave has a higher frequency or a lower frequency, assuming the effective wavelength of each high-frequency wave in the high-frequency line 1a to be λ, a gain of the antenna is increased and the high-frequency wave can be transmitted and received at a high-level by setting the dimension (length) of one side of each square patch antenna to ½ of λ.

The lower-frequency patch antenna 6a having a larger area does not react with the higher frequency wave in, e.g., the 5.2-GHz band, and hence gives no influences upon the higher-frequency patch antenna 6b. Also, the higher-frequency patch antenna 6b does not react with the lower frequency wave in, e.g., the 2.45-GHz band, and hence gives no influences upon the lower-frequency patch antenna 6a. Therefore, the coupling ratios of the two kinds of patch antennas 6a, 6b can be adjusted independently of each other. The coupling ratio can be adjusted, as described above, by changing the thickness of the dielectric 8 of the patch antenna, or by controlling the shift amount of the patch antenna from the lengthwise center axis A of the signal line 4 (high-frequency line 1a) or the rotational angle of the patch antenna in the horizontal direction, to thereby change the above-mentioned relative position.

While the above description is made on the embodiment using two kinds of patch antennas, FIG. 28 shows another embodiment using one kind of the patch antenna. A patch antenna 6g shown in FIG. 28 is adapted for both a lower frequency and a higher frequency. The structure of the patch antenna 6g shown in FIG. 28 is the same as that of the above-described patch antenna except for that the former is rectangular in plan view. Stated another way, in the patch antenna 6g, the dielectric 8 has a rectangular shape having a longer side a and a shorter side b, and the radiation plate (patch) 7 also has a corresponding rectangular shape having a longer side and a shorter side.

In this embodiment, the longer side a of the patch antenna 6g is decided depending on the frequency of the lower frequency wave, and the shorter side b is decided depending on the frequency of the higher frequency wave. Thus, the longer side a of the patch antenna 6g is adapted for the lower frequency, and the shorter side b is adapted for the higher frequency. In this patch antenna 6g, the longer side a gives no influences upon the higher frequency wave, and the shorter side b gives no influences upon the lower frequency wave. Accordingly, by employing the rectangular patch antenna 6g having the shorter side b of about 18 mm and the longer side a of about 40 mm, for example, one patch antenna 6g permits high-frequency waves of two frequencies to be transmitted and received, i.e., the higher-frequency wave in the 5.2-GHz band by the shorter side b and the lower-frequency wave in the 2.45-GHz band by the longer side a. In other words, one patch antenna 6g is able to cover two frequencies. Thus, in the high-frequency line for transmitting high-frequency waves having two different frequencies, it is possible to transmit and receive the high-frequency waves having two different frequencies independently of each other by using one kind of rectangular patch antenna.

The patch antenna 6g may be disposed on the high-frequency line 1a solely or in a proper combination with the above-described patch antennas 6a, 6b. Also, the coupling ratio of the patch antenna 6g can be adjusted, as described above, by changing the thickness of the dielectric 8 of the patch antenna, or by controlling the shift amount of the patch antenna from the lengthwise center axis A of the signal line 4 (high-frequency line 1a) or the rotational angle of the patch antenna in the horizontal direction, to thereby change the above-mentioned relative position.

The above-described patch antennas can be used in various combinations. The patch antennas 6a, 6b shown in FIG. 27 and the patch antenna 6g shown in FIG. 28 are in common quadrilateral (rectangular) to transmit and receive linearly polarized radio waves. On the other hand, for the purpose of realizing communication less affected by the direction of polarization, a circular polarized antenna having, e.g., the above-described circular radiation plate 7b shown in FIG. 6A, may be disposed solely or in combination with any other type of antenna. Further, for the purpose of providing both vertical and horizontal polarization components, an antenna having, e.g., the above-described radiation plate 7d shown in FIG. 6C, in which two diagonal corners of a quadrilateral patch are partly cut out, may be disposed solely or in combination with any other type of antenna.

A description is now made of embodiments in which the high-frequency line (micro-strip line) of the present invention is used as a high-frequency line antenna for a coaxial cable.

With the above-described embodiments of the high-frequency line of the present invention, the line can be easily installed when the ceiling is flat, such as a systematic ceiling, but a difficulty arises in installing the line, for example, when a beam is projected from the ceiling.

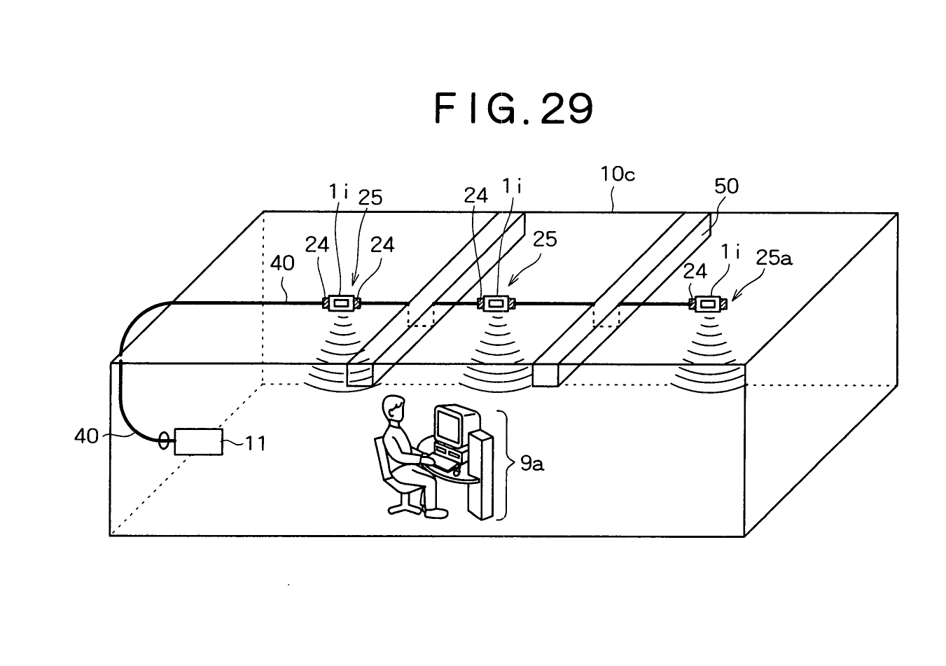

When the ceiling is not flat and a beam 50 or the like is projected to cause a level difference as in, e.g., an indoor space 10c shown in FIG. 29, the high-frequency line of the present invention must be bent along wall surfaces of the beam 50, as shown in FIG. 22 referenced above, so that the line is fixed in place. As described above with reference to FIG. 22, the high-frequency line having flexibility can be bent along wall surfaces. In the case riding over a small-height beam, it is easy to bend the high-frequency line along wall surfaces of such a beam. In the case riding over a large-height beam, however, the high-frequency line must be installed while bending it to a shape as close as possible to the shapes of the ceiling and the beam from the standpoints of an appropriate external appearance and aesthetic view. Therefore, the latter case leads to a problem that the curvature of the bent high-frequency line is inevitably reduced and the loss amount of the transmitted high-frequency wave or the amount of the reflected high-frequency wave is so increased as to be problematic in practical use in a bent portion having a small curvature. Unlike a coaxial cable entirely covering a signal line with a ground surface, the high-frequency line of the present invention has the ground surface in only one side of the signal line and its characteristics are easily affected upon bending.

Such a situation can be coped with by combining the high-frequency line of the present invention and the coaxial cable with each other. In other words, the above-mentioned problem can be overcome without excessively deteriorating the line characteristics by using the coaxial cable as a high-frequency line itself and using the high-frequency line of the present invention as an antenna for the coaxial cable.

The high-frequency line serving as an antenna unit for transmitting and receiving a high-frequency signal including data for radio communication is easily connectable, via a coaxial connector, to the coaxial cable for transmitting the high-frequency signal. This results in an advantage of flexible maintenance of an antenna system. More specifically, a high-frequency signal can be easily taken out in any desired portion through the coaxial connector and connected to a measuring device, such as a spectrum analyzer or a wattmeter, for checking whether the high-frequency signal is normal. Also, even when an abnormality is found, the abnormality can be eliminated by replacing only the antenna unit or the coaxial cable.

Accordingly, by connecting the high-frequency line, which is disposed on the ceiling of the office and serves as an antenna, to an external antenna terminal of a wireless LAN master unit (access point) via the coaxial cable, even when the indoor ceiling or wall is irregular with the presence of a large-height beam or the like, high bit-rate radio communication can be performed at any place in the office and communication environments free from fluctuations in communication quality can be realized as with the above-described high-frequency line of the present invention.

FIG. 29 is a perspective view of an indoor space, showing the embodiment in which the high-frequency line of the present invention and the coaxial cable are used in a combined manner. Referring to FIG. 29, a plurality of antenna units 25 are connected to an external antenna terminal of a wireless LAN master unit (access point) 11 via a coaxial cable 40. More specifically, a plurality of antenna units 25 are connected to the coaxial cable 40 that is disposed on the ceiling of the office (indoor space 10c) while being bent so as to extend along wall surfaces of beams 50. Each of the antenna units 25 comprises a coaxial connector 24 used for connection to the coaxial cable 40, and a high-frequency line 1i connected to the coaxial connector 24 and serving as an antenna. Then, the antenna unit 25 transmits and receives a wireless LAN high-frequency signal to and from the indoor space.

The coaxial cable is not required to be a particular or special one. For example, the coaxial cable may be a 3D or 5D standard cable having impedance of 50 Ω and a diameter of not larger than about 10 mm.

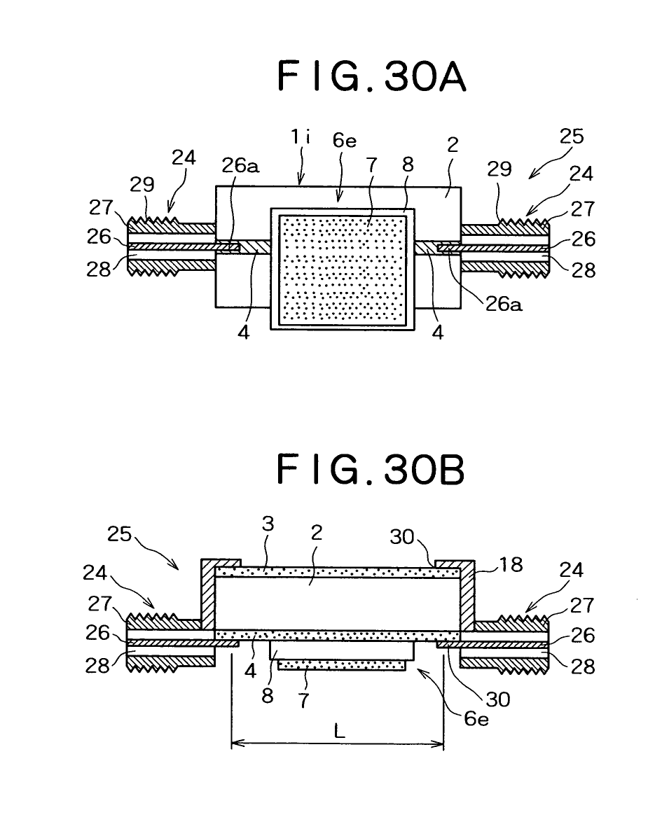

FIG. 30 shows one embodiment of the structure of the antenna unit 25 for transmitting and receiving the high-frequency signal in FIG. 29. FIG. 30A is a front view and FIG. 30B is a side view. The high-frequency line 1i constituting the antenna unit 25 including a patch antenna 6e has basically the same construction as the high-frequency line described above. More specifically, the high-frequency line 1i has a layered flexible structure in which a ground layer 3 made of a conductive material, a dielectric layer 2 made of a dielectric material, and a signal line 4 made of a conductive material and inducing a high-frequency wave are successively laid in the direction of section (thickness) of the line. Also, the patch antenna 6e disposed to be electrically coupled to the high-frequency line 1i comprises a radiation plate (patch) 7 made of a metallic conductive material and radiating a high-frequency wave, and a dielectric (plate) 8 interposed between the radiation plate 7 and the dielectric layer 2.

The coaxial connector 24 has a structure in which, for example, a central conductor 26 is disposed to extend through a hollow portion 28 of a tubular member 27 having a screw 29 formed on its outer surface and engaging with a screw (not shown) formed on the coaxial cable 40. The coaxial connector 24 is connected to each of opposite ends of the high-frequency line 1i by connecting an end 26a of the central conductor 26 of the coaxial connector 24 to a corresponding end of the signal line 4 of the high-frequency line 1i by using, e.g., a solder 30, and by connecting an insulating member 18 disposed at an end of the coaxial connector 24 to the ground layer 3 of the high-frequency line 1i by using, e.g., a solder 30. Note that, although a plastic casing is usually disposed to protect an antenna of the antenna unit 25, it is not shown in FIG. 30.

A length L between points at which the high-frequency line 1i contacts the central conductors 26 of the coaxial connectors 24 on both sides is preferably decided to meet the following relationship so that reflected components of the high-frequency wave caused with the connection between them cancel each other and causes no adverse influences:
2×L=(n−½)×λg
(where n=1, 2, 3, . . . and λg: wavelength of the high-frequency wave transmitted through the high-frequency line)

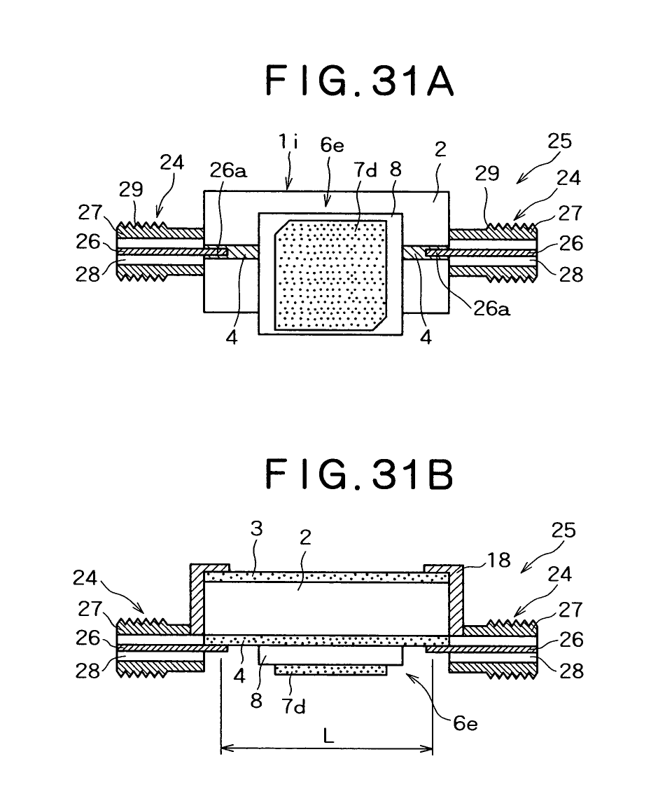

FIG. 31 shows, as another embodiment of the antenna unit 25 for transmitting and receiving the high-frequency signal in FIG. 29, an antenna unit structure using a patch antenna for transmitting and receiving a circularly polarized wave. FIG. 31A is a front view and FIG. 31B is a side view. The structure of the antenna unit 25 is basically the same as that shown in FIG. 30 except for that, to transmit and receive the circularly polarized wave, the patch antenna 6e has a substantially quadrilateral radiation plate 7d partly cut out at corners as shown in FIG. 6C. Then, as shown in FIG. 29, the patch antennas 6e for right-handed circular polarization and left-handed circular polarization are alternatively connected to the coaxial cable 40.

With that arrangement, when the high-frequency signal is received by the wireless LAN terminal used by a subscriber, high-frequency waves (indicated by concentric arc-shaped lines in FIG. 29) transmitted from the antenna units 25 adjacent to each other are avoided from canceling each other completely. As a result, a communication error is less apt to occur, and high bit-rate data communication can be performed in any place.

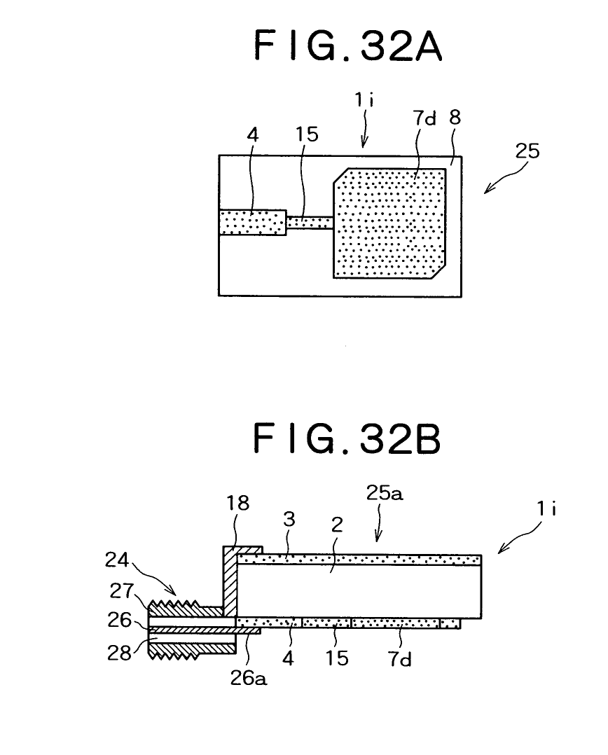

FIG. 32 shows one embodiment of an antenna unit 25a employed at an end terminal of the high-frequency line of the present invention (or the coaxial cable 40) in FIG. 29. FIG. 32A is a front view and FIG. 32B is a side view. In FIG. 32, because the antenna unit 25a is connected to the end terminal of the coaxial cable 40, it differs from the antenna unit 25 shown in FIGS. 30 and 31 in that the coaxial connector 24 is connected to only one end of a high-frequency line 1j. Also, a patch antenna having a substantially quadrilateral radiation plate 7d partly cut out at corners is disposed directly on a dielectric layer 2 of the high-frequency line 1j so that the high-frequency wave inputted to the antenna unit 25a can be all radiated into an indoor space. In addition, as in the embodiments shown in FIGS. 13 and 14, the radiation plate 7d is electrically coupled to a signal line 4 of the high-frequency line 1j via a feeder 15 with proper impedance matching.

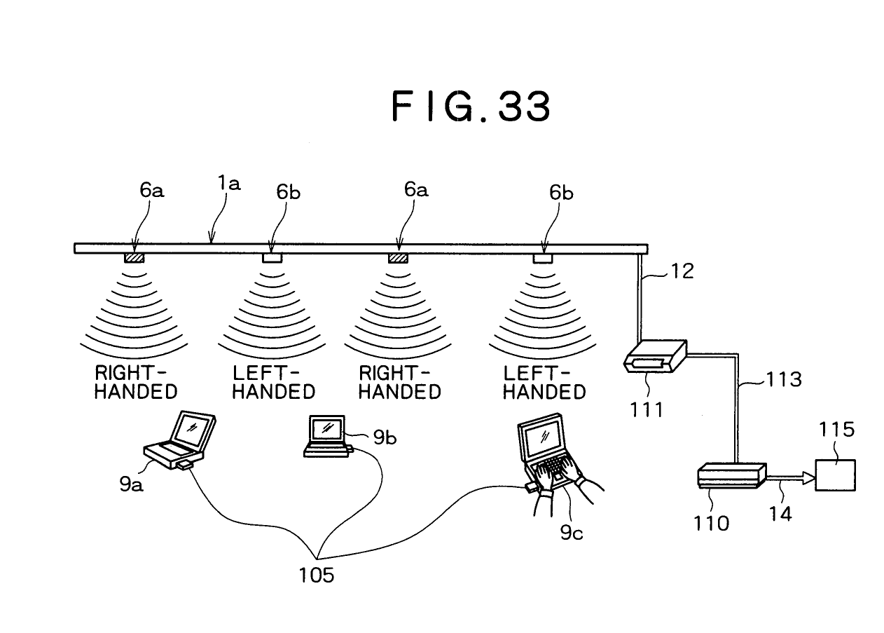

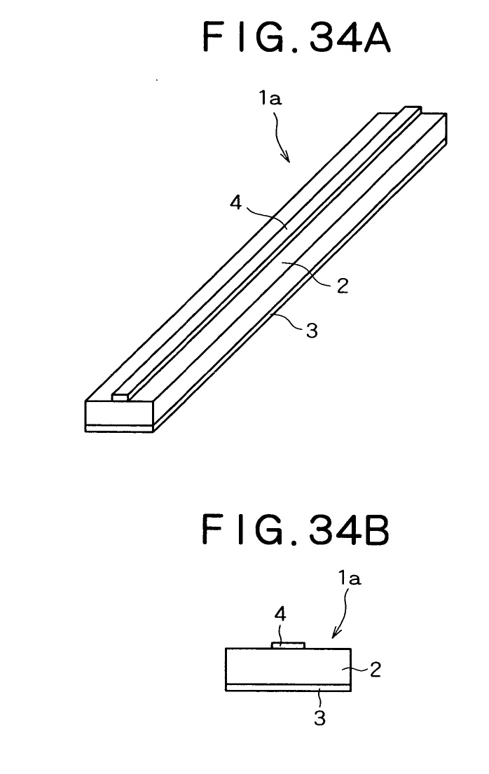

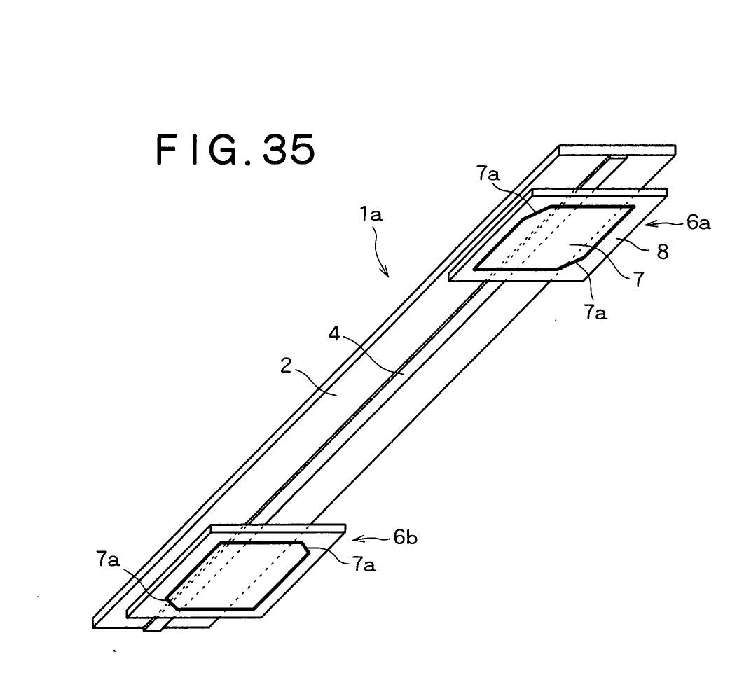

A wireless LAN system according to another embodiment of the present invention to which the above-described high-frequency micro-strip line is applicable will be described below with reference to the drawings. FIG. 33 illustrates the basic conception of an indoor wireless LAN system to which the present invention is applied. FIG. 34 shows a high-frequency line for a wireless LAN base station, which can be used in this wireless LAN system and is in the simplified form of the high-frequency line shown in FIGS. 1-32; specifically, FIG. 34A is a perspective view of a high-frequency line 1a and FIG. 34B is a sectional view of the high-frequency line 1a. FIG. 35 is a perspective view showing a circular polarized antenna for the wireless LAN base station to which the above-described high-frequency line is applicable. In this aspect of the present invention, constructions except for a wireless LAN mobile-station terminal antenna, i.e., details of the wireless LAN base station, details of the high-frequency micro-strip line and the circular polarized antenna of the wireless LAN base station, and details of the wireless LAN mobile station itself, are basically the same as those described above.

First, the wireless LAN system according to this aspect of the present invention is constructed as shown in FIG. 33. The wireless LAN system shown FIG. 33 is on an assumption of use in an indoor space, such as an ordinary office or business premise. In FIG. 33, a high-frequency line 1a constituting a wireless LAN base station antenna is disposed to extend along, e.g., an interior ceiling. To ensure good visibility toward wireless LAN mobile-station terminal antennas, the wireless LAN base station antenna is preferably positioned at a top of the indoor space (or in an upper space within a service area), for example, at the ceiling.

One end of the high-frequency line 1a is formed as a non-reflecting terminator, and a wireless LAN base station (called also a wireless LAN master station or a wireless LAN master unit) 111 is connected to the other end of the high-frequency line 1a via a coaxial cable 12. The wireless LAN base station is connected to a HUB (multi-port repeater having terminals connected in a star-like shape, i.e., a LAN component unit having signal reproducing and relaying functions) 110 via an Ethernet cable 113 and is further connected to an external network 115 via a connection line 14.

On the other hand, a plurality of wireless LAN mobile stations (mobile station terminals such as personal computers) 9a, 9b and 9c serving as slave units to communicate with the wireless LAN base station 111 are disposed indoor. The mobile stations 9a, 9b and 9c perform communication with later-described antennas 6 (6a, 6b, 6c, . . . ) of the wireless LAN base station by using antennas incorporated in terminal wireless LAN cards 105 that are inserted to the respective mobile stations.

As the wireless LAN base station antennas, a plurality of circular polarized antennas, such as the patch antennas 6, are alternately disposed on the high-frequency line 1a at certain intervals depending on the layout of the mobile stations 9a, 9b and 9c so that good communication is ensured with respect to the wireless LAN mobile stations. Then, in the wireless LAN base station antennas, the rotating directions of circularly polarized waves radiated from adjacent two of the patch antennas 6a, 6b and 6c are set to differ from each other in order to eliminate influences of multi-path fading caused by crosstalk between high-frequency waves radiated from the adjacent patch antennas. More specifically, the patch antenna 6a is constituted as a rightward circular polarized antenna with a right-handed rotating direction, and the patch antenna 6b adjacent to the patch antenna 6a is constituted as a leftward circular polarized antenna with a left-handed rotating direction. Those two kinds of circular polarized antennas are arranged alternately.

Next, FIG. 34 shows, in more detail, components of the wireless LAN base station antenna as a basis of the present invention. The following description is made on, as a preferred embodiment of the high-frequency line constituting the wireless LAN base station antenna, the structure of a high-frequency micro-strip line in which a dielectric layer and a signal line are successively laid on a ground layer. In the present invention, the high-frequency line constituting the wireless LAN base station antenna can also be formed of a tubular waveguide made of a conductive material, such as stainless, steel, copper or aluminum, or any other microwave transmission lines than the tubular waveguide, such as a coaxial cable. However, those tubular waveguide and other lines are inferior in various characteristics, e.g., thickness, flexibility and workability in installation, to the high-frequency micro-strip line 1a shown in FIG. 34.

Referring to FIG. 34A, the high-frequency line 1a constituting the wireless LAN base station antenna is in the form of a long thin plate having a length required for the wireless LAN system in a service area. As shown in FIGS. 34A and 34B, the structure of the high-frequency line 1a in the direction of section (thickness) thereof is the same as that of the high-frequency micro-strip line described above. More specifically, on a ground layer 3 made of a conductive material, a dielectric layer 2 made of a dielectric material and a signal line 4 made of a conductive material and inducing a high-frequency wave are successively laid in the order named, thereby providing a layered structure. The signal line 4 is disposed to extend in the lengthwise direction of the high-frequency line 1a. With that structure, the high-frequency line 1a has flexibility. Additionally, any known adhesive material or adhesive layer, such as a double-sided adhesive tape or sheet, may be affixed to a bottom surface of the high-frequency line 1a for the purpose of facilitating installation and removal of the high-frequency line 1a.

FIG. 35 shows one example of a more detailed structure of the wireless LAN base station antenna as a basis of the present invention. In FIG. 35, the wireless LAN base station antenna is constituted as a patch antenna.

The patch antenna basically comprises, by way of example, a dielectric layer 8 made of a dielectric material and a patch (radiation plate) 7 made of a conductive material, which are successively laid into a layered structure. Then, the patch antenna is disposed on the signal line 4 of the high-frequency line 1a shown in FIG. 34 and is electrically coupled to the signal line 4.

The conductive material of the patch 7 can be the same as the metallic material used for the conductive material to form the ground layer of the high-frequency line. Also, the dielectric material of the dielectric layer 8 can be selected to be the same as the metallic material used as the conductive material to form the dielectric of the high-frequency line.

Means for electrically coupling the patch antenna 6 and the signal line 4 of the high-frequency line 1a can be practiced in any other appropriate manner than arranging the patch antenna 6 on the signal line. For example, the patch antenna 6 may be arranged aside the signal line 4, and a feeder may be disposed for electrical coupling between them.

With the patch antenna 6 thus constructed, the antenna can be easily attached to and detached from the high-frequency line. Accordingly, even in the case where the antenna arrangement of the wireless LAN system is changed depending on, e.g., change in layout of the office, it is just basically required to attach and detach the patch antennas depending on a new layout. In other words, work for installing the high-frequency line itself again is not required so long as the entire area can be covered by the high-frequency line of the present invention, which is already installed. Further, in the case requiring a modification of the used radio frequency with respect to primary characteristics of the antenna, such as the coupling ratio and gain, that modification can be easily performed by adjusting conditions on the patch antenna side, such as the material properties and thickness of the radiation plate and the dielectric, or by employing other patch antennas adjusted to be adapted for the required conditions.

For the purpose of reducing the influences of multi-path fading when the above-mentioned patch antenna is used, the patch antenna in the wireless LAN base station side is constituted by a circular polarized antenna as a basis of the present invention, and a plurality of circular polarized antennas differing in polarization-plane rotating directions from each other, e.g., a rightward circular polarized antenna with a right-handed rotating direction and a leftward circular polarized antenna with a left-handed rotating direction, are arranged alternately at an interval between them.

To make each of the patch antennas serve as a circular polarized antenna with a proper polarization-plane rotating direction, as shown in FIG. 35, two diagonal angled portions (corners) of the patch 7 having a quadrilateral (rectangular) shape is chamfered (cut out) (as indicated by 7a). In FIG. 35, of two patch antennas adjacent to each other, the patch antenna 6a is constituted as a rightward circular polarized antenna with a right-handed rotating direction, and the patch antenna 6b is constituted as a leftward circular polarized antenna with a left-handed rotating direction. To that end, as shown in FIG. 35, the patch antenna 6a serving as the rightward circular polarized antenna is shaped such that two diagonal upper left and lower right corners are cut out as viewed on the drawing, and the patch antenna 6b serving as the leftward circular polarized antenna is shaped such that two diagonal upper right and lower left corners are cut out as viewed on the drawing.

By changing the orientations of those two diagonal corners of the patch 7 which are cut out, the polarization-plane rotating direction of each antenna, i.e., whether the circular polarized antenna transmits a right-handed circularly polarized wave or a left-handed circularly polarized wave, can be controlled. Note that the planar shape of the patch (radiation plate) 7 and the control of the polarization-plane rotating direction of each antenna are not limited to the quadrilateral shape and cutting-out of corners as shown FIG. 35, and the desired circular polarized antenna can also be obtained with any other suitable options. Also, the patch can be selectively formed into an appropriate shape so long as the polarization-plane rotating direction of the antenna is controllable.

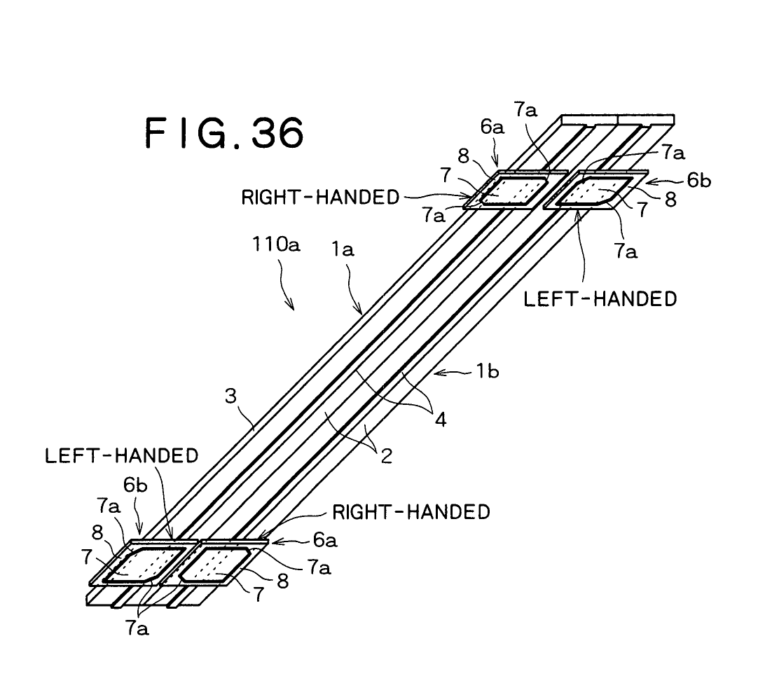

On the basis of the above-described structure of the wireless LAN base station antenna, embodiments of the wireless LAN mobile-station terminal antenna according to the present invention, which is employed as an antenna incorporated in the terminal wireless LAN card or the like, will be described below with reference to FIGS. 36-40.

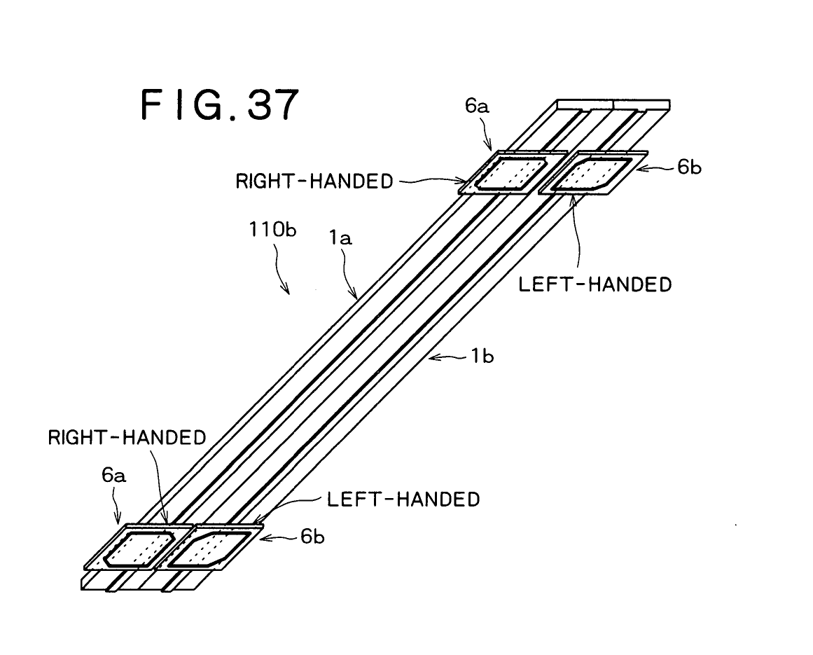

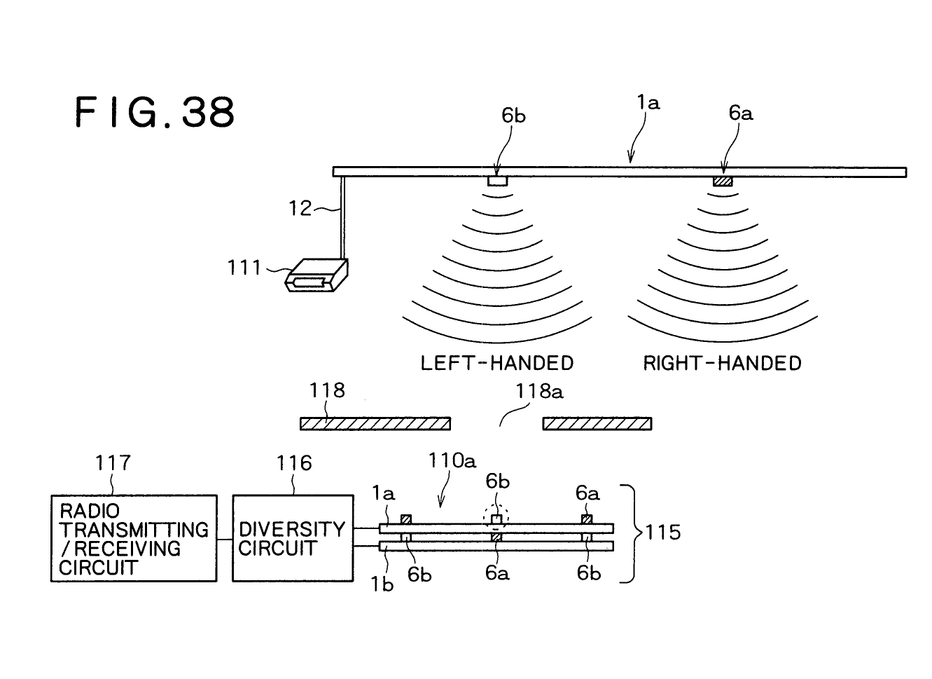

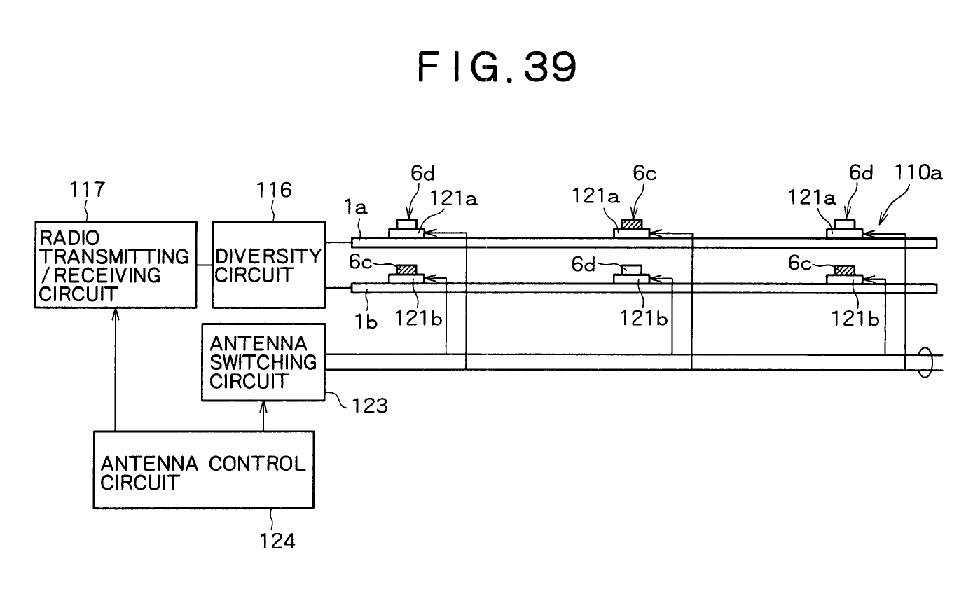

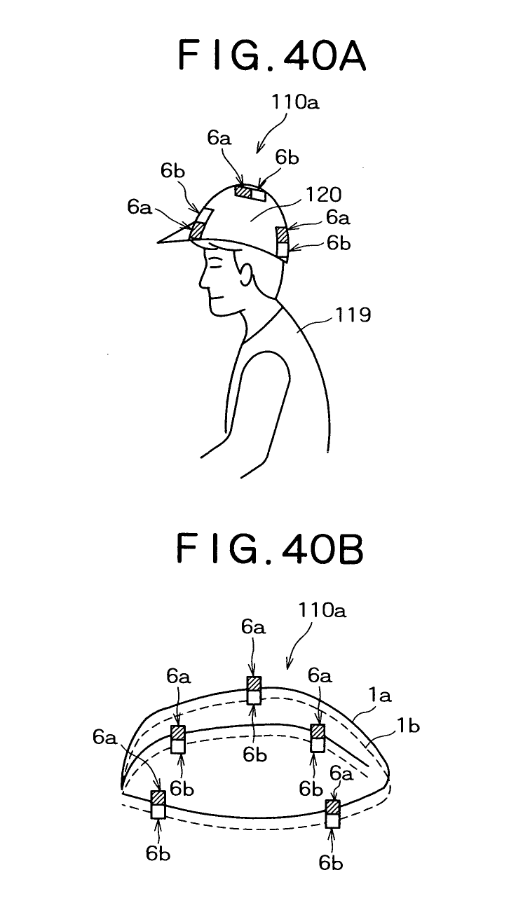

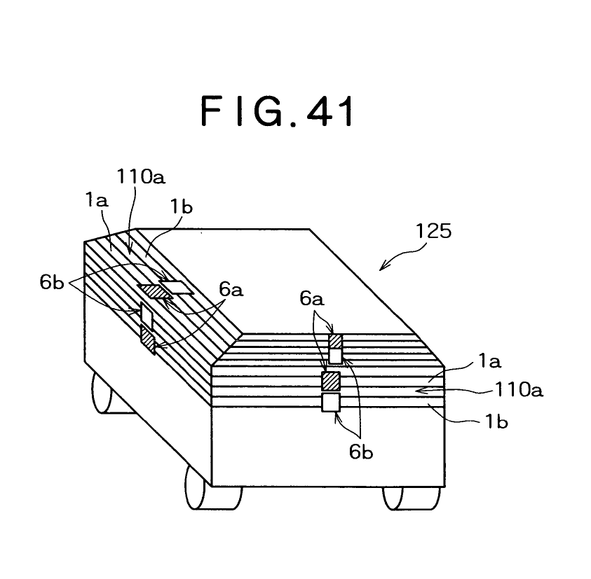

FIGS. 36 and 37 are perspective views showing the embodiments of the wireless LAN mobile-station terminal antenna of the present invention. FIG. 38 is a front view showing a wireless LAN system of the present invention to which the wireless LAN mobile-station terminal antenna of the present invention is applied. FIG. 39 is a front view showing another preferable embodiment of the wireless LAN mobile-station terminal antenna of the present invention. FIG. 40 is an explanatory view showing still another preferable embodiment of the wireless LAN mobile-station terminal antenna of the present invention. FIG. 41 is a perspective view showing still another preferable embodiment of the wireless LAN mobile-station terminal antenna of the present invention.

First, a wireless LAN mobile-station terminal antenna 110a of the present invention, shown in FIG. 36, is featured in basically comprising high-frequency lines 1a, 1b disposed adjacent to each other in parallel, and a plurality of patch antennas 6a, 6b constituted as circular polarized antennas and disposed on each of the high-frequency lines at certain intervals. Thus, since the wireless LAN mobile-station terminal antenna 110a includes the plurality of patch antennas 6a, 6b, it is possible to receive a signal (sent from the base station antenna) at a high level regardless of the position or place where the mobile station terminal is located, or of whether the mobile station terminal is moving. The mobile station terminal antenna of the present invention requires at least two high-frequency lines disposed adjacent to each other in parallel. When the two high-frequency lines are enough to suppress the multi-path fading and to obtain the effect of restraining a reduction in transmitting and reception power caused depending on the position of the mobile station terminal antenna, there is no need of using three or more high-frequency lines.

Each of the high-frequency lines 1a, 1b of the mobile station terminal antenna 110a has a structure in which a dielectric layer 2 and a signal line 4 are successively laid on a ground layer 3. In other words, the structure of the high-frequency lines 1a, 1b of the mobile station terminal antenna is basically the same as that of the high-frequency line 1a of the wireless LAN base station described above with reference to FIG. 34.

Also, each of the patch antennas 6a, 6b, i.e., the circular polarized antennas constituting the mobile station terminal antennas, is formed by successively laying a dielectric layer 8 made of a dielectric material and a patch (radiation plate) 7 made of a conductive material. Thus, they have the same structures as the patch antennas 6a, 6b of the wireless LAN base station described above with reference to FIG. 35. Those patch antennas are disposed on the respective signal lines 4 of the high-frequency lines 1a, 1b and are electrically coupled to the respective signal lines 4. Further, in the circular polarized antennas serving as the patch antennas, the planar shape of the patch (radiation plate) 7 and the manner of controlling the polarization-plane rotating direction of each antenna (e.g., cutting-out of corners) can also be selected, as required, similarly to the patch antennas 6a, 6b of the wireless LAN base station described above with reference to FIG. 35.

The wireless LAN mobile-station terminal antenna 110a of the present invention, shown in FIG. 36, is further featured in that the patch antennas 6a, 6b constituted as the circular polarized antennas differing in polarization-plane rotating directions are disposed adjacent to each other substantially in the same positions on the two high-frequency lines 1a, 1b. Looking at one of the two high-frequency lines 1a, 1b, therefore, the circular polarized antennas differing in polarization-plane rotating directions from each other, i.e., the rightward circular polarized antenna 6a with a right-handed rotating direction and the leftward circular polarized antenna 6b, are arranged alternately at an interval between them.

Thus, in FIG. 36, of the patch antennas adjacent to each other, the antenna 6a is constituted as the rightward circular polarized antenna with a right-handed rotating direction and the antenna 6b is constituted as the leftward circular polarized antenna with a left-handed rotating direction. Then, to make each of the patch antennas serve as a circular polarized antenna with a leftward or rightward rotating direction, as shown in FIG. 35, two diagonal angled portions (corners) of the patch 7 having a quadrilateral (rectangular) shape is cut out as in the patch antennas 6a, 6b of the wireless LAN base station described above with reference to FIG. 35.

FIG. 37 shows a modification. A wireless LAN mobile-station terminal antenna 110b of the present invention, shown in FIG. 37, differs from the wireless LAN mobile-station terminal antenna 110a of the present invention, shown in FIG. 36, in that, as a result of replacing one paired patch antennas 6a, 6b in arrangement, the patch antennas 6a, 6b substantially in the same position on the two high-frequency lines 1a, 1b as those in FIG. 36 have the polarization-plane rotating directions of the circularly polarized waves opposite to those in FIG. 36.

FIG. 38 shows another embodiment in which the wireless LAN mobile-station terminal antenna 110a of the present invention, shown in FIG. 36, is applied to, for example, an antenna incorporated in the wireless LAN card for the terminal or the like and to the wireless LAN system. In FIG. 38, the wireless LAN base station 111 has the same construction as that shown in FIG. 33. FIG. 38 shows a condition where an obstacle 118 impeding visibility is present between the wireless LAN base station antennas 6a, 6b and the wireless LAN mobile-station terminal antennas 6a, 6b.

According to this aspect of the present invention, a plurality of circular polarized antennas differing in polarization-plane rotating directions from each other are present in both of the wireless LAN base station and the wireless LAN mobile station terminal. Looking at the installation space as a three-dimensional space, therefore, the circular polarized antennas having the same polarization-plane rotating direction are always present in both of the wireless LAN base station and the wireless LAN mobile station terminal with good visibility between them in spite of the presence of the obstacle 118. In the case of FIG. 38, good visibility is obtained through an open space 118a without being blocked by the obstacle 118 toward the wireless LAN base station antenna between the antenna 6b (with left-handed circular polarization) in the wireless LAN base station side and the antenna 6b (with left-handed circular polarization, i.e., the antenna located at the center in the drawing and surrounded by a dotted line) disposed on the high-frequency line 1a of the wireless LAN mobile-station terminal antenna 110a. Thus, in the mobile-station terminal antenna 110a shown in FIG. 38, reception power is maximized at the antenna 6b (with left-handed circular polarization) that is located at the center in the drawing and surrounded by a dotted line. Note that, because the leftward and rightward polarization-plane rotating directions of the antennas differ depending on a viewing direction, FIG. 38 is illustrated on an assumption of looking in the same direction.

In FIG. 38, numeral 116 denotes a diversity circuit, and 117 denotes a radio transmitting/receiving circuit connected to the diversity circuit 116. The diversity circuit 116 is disposed between the high-frequency lines 1a and 1b, and is constituted as an electric circuit. The diversity circuit 116 serves as a switch for changing over (selecting) one of two circuits, i.e., the two high-frequency lines 1a, 1b, to transmit and receive a radio signal so that the patch antenna providing a maximum reception power can be selected in the wireless LAN mobile-station terminal antenna 110a. Those mechanism and function are incorporated in each of the terminal wireless LAN cards 105 for the wireless LAN mobile stations shown in FIG. 33.

A more detailed example of the switch for electrically controlling the transmitting and receiving functions of the circular polarized antennas will be described below with reference to FIG. 39. In FIG. 39, numeral 116 denotes a diversity circuit, and 117 denotes a radio transmitting/receiving circuit connected to the diversity circuit 116. Further, numeral 123 denotes an antenna switching circuit, and 124 denotes an antenna control circuit. The antenna switching circuit 123 is connected via control lines 122 to antenna switches 121a, 121b that are disposed respectively in the wireless LAN mobile-station terminal antennas 6a, 6b on the high-frequency lines 1a, 1b. Those components constitute the above-mentioned switches for the circular polarized antennas.

When an electric signal is applied, the antenna switches 121a, 121b are turned on to establish electrical conduction, and the circular polarized antennas 6a, 6b corresponding to those antenna switches are operated. Conversely, when an electric signal is turned off, the circular polarized antennas 6a, 6b are not operated. The antenna control circuit 124 executes control for changing over the antenna switches 121a, 121b in turn to transmit data from the mobile-station terminal antenna side to the base station side, evaluating communication quality in the transmitting process, and operating the circular polarized antenna that provides a minimum incidence of communication errors.

That control provides the effect as follows. In up-direction communication from the mobile station terminal antenna side to the base station side, power transmitted from the mobile station terminal antenna can be concentrated to an optimum antenna of the mobile station terminal. Also, in down-direction communication from the base station side to the mobile station terminal antenna side, power received by the mobile station terminal antenna can be concentrated to an optimum antenna of the mobile station terminal. Thus, an advantage can be obtained in point capable of always selecting the mobile station terminal antenna that provides maximum transmitting and reception powers.

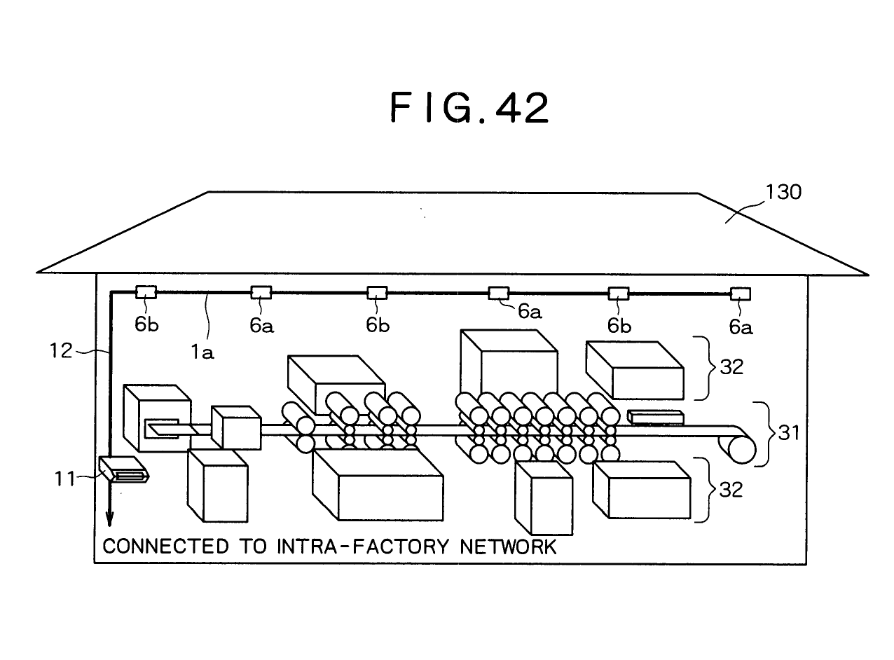

While the above description is made on an example of applications of the present invention to the ordinary indoor wireless LAN system, an example of application of the present invention to a large-sized building, e.g., a factory, will be described below. Assume here the case where, as shown in a perspective view of FIG. 42, the wireless LAN mobile station antenna and the wireless LAN system of the present invention is applied to a wide building area, such as a rolling factory in a steelmaking plant or a mechanical machining factory. In this case, there are three major problems to be solved as given below.

(1) In a factory 130, there are many metal-made structures (such as manufacturing apparatuses and various machines represented by the ceiling, walls, and a rolling machine 31) which are apt to reflect electric waves. Accordingly, when radio communication is performed with the wireless LAN system using the base station antennas disposed in the factory 130 along the ceiling, multi-paths representing waves reaching a receiving point from a transmitting point via various transmission routes tend to generate in addition to a direct wave. Therefore, a signal level receivable by the base station antennas and the mobile station terminal antennas is greatly reduced and multi-path components are increased, thus resulting in a lower reception S/N and a difficulty in high bit-rate communication. Although such a problem similarly arises in the ordinary indoor wireless LAN system described above, the problem becomes more noticeable because of the presence of many metal-made structures in the factory 130.

(2) In the factory 130, there are many large-sized structures 32 and other projections having medium heights. Also, movements of ceiling cranes and other apparatuses impede visibility between the antennas and make it difficult to ensure good visibility from the base station antennas disposed along the ceiling in many cases. Accordingly, positions capable of receiving signals and positions not capable of receiving signals are inevitably caused depending on the positions of the wireless LAN mobile station terminals. Although such a problem similarly arises in the ordinary indoor wireless LAN system described above, the problem becomes more noticeable because movements of the mobile stations and positions of the mobile station terminals are largely changed in the factory 130.

(3) Assuming the case where workers engaged in operation, maintenance, etc. perform work in the factory 130 while performing radio communication via mobile terminals utilizing the wireless LAN system, the terminal antennas are preferably movable (wearable) with the workers. In this case, however, the attitude (bearing and direction) of the circular polarized antenna in the mobile station terminal side is changed depending on the attitude of the worker performing the work or moving around. Under such a situation, there also tend to occur the condition capable of transmitting and receiving a signal at a high level, and the condition not capable of transmitting and receiving a signal at a high level. Although such an attitude problem similarly arises in the ordinary indoor wireless LAN system described above, the problem can be said as being specific to the large-sized building, i.e., the factory 130, in which movements of the mobile stations and positions of the mobile station terminals are largely changed in three-dimensional way with the work performed in the factory.

Means for solving the above-mentioned problems will be described below one by one.

The problem of above (1) can be solved by arranging the wireless LAN base station antennas to locate in an upper space of the building, e.g., along the ceiling, and by installing the high-frequency lines in which the antennas transmitting right-handed circularly polarized waves and the antennas transmitting left-handed circularly polarized waves, i.e., the circular polarized antennas differing in polarization-plane rotating directions, are arranged alternately. Stated another way, by arranging the wireless LAN base station antennas to locate in the upper space of the building, good visibility can be ensured toward each wireless LAN mobile-station terminal antenna moving in the factory, and therefore signal components resulting from direct waves are increased. Also, by using, as the wireless LAN base station antenna, the circular polarized antenna propagating a leftward- or rightward-rotated circularly polarized wave instead of the linear polarized antenna, because the polarization-plane rotating direction of the high-frequency, which has been reflected once by the metal-made wall of the structure or the like, is changed, the reflected wave entering the wireless LAN mobile-station terminal antenna is reduced and the influence of multi-path fading is reduced even with the presence of many structures reflecting the high-frequency wave.

The problem of above (2) can be solved by arranging the wireless LAN mobile-station terminal antennas according to the present invention as follows; namely by arranging the high-frequency micro-strip lines each having the above-described structure adjacent to each other substantially in parallel, arranging a plurality of circular polarized antennas differing in polarization-plane rotating directions alternately at certain intervals between them in each of the high-frequency micro-strip lines, and arranging the circular polarized antennas differing in polarization-plane rotating directions adjacent to each other on the high-frequency micro-strip lines substantially in the same positions. In other words, as described with reference to FIG. 38, the antennas of the wireless LAN mobile station terminals and the wireless LAN base station according to the present invention are arranged such that the plurality of circular polarized antennas differing in polarization-plane rotating directions are present in both of the wireless LAN base station and the wireless LAN mobile station terminals. Looking at the installation space as a three-dimensional space, therefore, the circular polarized antennas having the same polarization-plane rotating direction are always present in both of the wireless LAN base station and the wireless LAN mobile station terminal with good visibility between them in spite of the presence of the obstacle 118.

Then, by changing over the switch, described above with reference to FIGS. 38 and 39, for electrically controlling the transmitting and receiving functions of the circular polarized antennas, one of the mobile station terminal antennas is selected which provides a higher level of a transmitted/received signal (power) in radio communication transmitted from the wireless LAN base station or transmitted to the wireless LAN base station. The circular polarized antennas are disposed in a plurality of places in each of the base station side and the mobile station terminal side. With good visibility ensured between the antennas in the base station side and the mobile station terminal side in at least one position for each side, therefore, communication at a high level can be realized regardless of the place where the mobile station terminal is present, without being affected by the place (position) of the mobile station terminal.

An embodiment for solving the problem of above (3) will be described below. FIG. 40 shows the embodiment in which the mobile station terminal antenna of the present invention is incorporated in a worker's helmet. FIG. 40A shows a state where a mobile station terminal antenna 110a of the present invention is incorporated in a helmet 120 put on the head of a worker 119. FIG. 40B shows the mobile station terminal antenna 110a incorporated in the helmet 120. In FIG. 40B, the mobile station terminal antenna 110a (high-frequency lines 1a, 1b), shown in FIGS. 36 and 37, is looped into a circular shape along an inner periphery of the helmet 120 such that the looped antenna is incorporated in the helmet 120 of FIG. 40A. The structure of the mobile station terminal antenna 110a, i.e., the structure in which the patch antennas 6a, 6b constituted as circular polarized antennas differing in polarization-plane rotating directions are arranged adjacent to each other on the two high-frequency lines 1a, 1b substantially in the same positions, is the same as that described above with reference to FIGS. 36 and 37. In addition, the point that the rightward circular polarized antenna 6a with a right-handed rotating direction and the leftward circular polarized antenna 6b are arranged alternately is also the same as that described above with reference to FIGS. 36 and 37, when looking at the single high-frequency line 1a or 1b.

Though not shown in FIG. 40, the mobile station terminal antenna 110a further includes a switch changing-over unit, such as the diversity circuit 116, similarly to the antenna shown in FIG. 38. Also, a terminal unit for operating the mobile station terminal antenna 110a may be put on or near the worker's body, e.g., a pocket of a working uniform or an easily accessible place, so that the worker is able to easily manipulate the terminal unit as required.

As seen from FIGS. 40A and 40B, by looping the mobile station terminal antenna 110a (high-frequency lines) of the present invention into a circular shape, the circular polarized antennas 6a, 6b disposed on the high-frequency lines 1a, 1b are oriented in different normal directions from each other. Therefore, even when the attitude (bearing and direction) of each of the circular polarized antennas in the mobile station terminal side is changed depending on the attitude of the worker performing the work or moving around, the mobile station terminal antenna with good visibility from the wireless LAN base station antenna is always present. Accordingly, a signal can be transmitted and received at a high level even when the attitude of the mobile station terminal antenna is changed.

Further, the helmet incorporating the mobile station terminal antenna therein is advantageous in that, since the worker is no longer required to hold the mobile station terminal antenna with the hand, the worker can more easily perform the intended work and higher safety during the work is ensured.

FIG. 41 is a perspective view showing another embodiment of the mobile station terminal antenna of the present invention for solving the problem of above (3). FIG. 41 assumes the case where, for example, data for production management is transferred from and to a relatively large cart, such as a push car or a carriage, to and from the wireless LAN mobile station terminal antenna. Referring to FIG. 41, numeral 125 denotes a cart. Along side surfaces of the cart 125, the mobile station terminal antenna 110a (high-frequency lines 1a, 1b) of the present invention is looped, e.g., twice as in the worker's helmet shown in FIG. 40.

As a result, similarly to the case of FIG. 40B, the circular polarized antennas 6a, 6b disposed on the high-frequency lines 1a, 1b are oriented in different normal directions from each other. Therefore, even when the attitude (bearing and direction) of each of the circular polarized antennas in the mobile station terminal side is changed depending on the attitude of the cart 125 during work or transport, the mobile station terminal antenna with good visibility from the wireless LAN base station antenna is always present on any of the side surfaces of the cart 125. Accordingly, a signal can be transmitted and received at a high level even when the attitude of the antenna on the cart 125 is changed.

The mobile station terminal antenna 110a may be disposed on a top surface of the cart 125. For the reason that the top surface of the cart 125 is used as a workbench or to carry loads in many cases, however, the mobile station terminal antenna 110a is disposed on the side surfaces of the cart 125 in the embodiment of FIG. 41 to be kept from becoming an obstacle when the top surface of the cart 125 is used. Though not shown, the mobile station terminal antenna 110a in FIG. 41 also includes a switch changing-over unit, such as the diversity circuit 116, similarly to the antenna shown in FIG. 38.

A description is now made on examples of the layers constituting the high-frequency micro-strip line 1a of the wireless LAN base station, the high-frequency micro-strip lines 1a, 1b of the mobile station terminal antenna 110a, the patch antennas, etc. which have been described above.

First, the dielectric layer 2 of each of the high-frequency lines shown in FIGS. 34-37 is appropriately selected so as to meet conditions that losses of the high-frequency wave are not caused when no ground layer is disposed on the surface of the dielectric layer 2 at the same side as the signal line 4 and this surface side is entirely left open. In general, losses of the high-frequency wave from a high-frequency line are mainly divided into a radiation loss, a conductor loss, and a dielectric loss. To reduce the radiation loss among them, the dielectric layer 2 preferably has a higher dielectric constant. The dielectric constant is decided depending on the dielectric constant of the dielectric material itself of the dielectric layer 2 and the thickness of the dielectric layer 2. Therefore, the dielectric material and the thickness of the dielectric layer 2 are preferably selected so as to increase the dielectric constant. However, flexibility of the line is reduced as the dielectric constant of the material and the thickness of the dielectric layer increase. Taking into account those conditions, an optimum material and thickness of the dielectric layer are selected when flexibility is needed.

Also, the conductor loss is reduced as the signal line 4 has a higher electrical conductivity. Therefore, an optimum electrical conductivity of the signal line 4 is preferably decided in consideration of the electrical conductivity required for the high-frequency line. Further, the dielectric loss is decided depending on the dielectric material itself of the dielectric layer 2, and therefore a material having a lower dielectric loss is preferably selected. The dielectric layer 2 is required to have a certain width and thickness from the viewpoint of the relationship between the frequency of a signal required in the wireless LAN system and the losses of the high-frequency wave. From this aspect, assuming, for example, a standard indoor wireless LAN system used in an office or the like to be a basis, the dielectric layer 2 preferably has a thickness of about 0.1-2.0 mm and a width of about 10-50 mm.

Thus, as the dielectric material of the dielectric layer 2, it is preferable to select a material causing no radiation loss of the high-frequency wave and having a low dielectric loss on the premise of the width and thickness of the dielectric layer 2, which are selected from the above-mentioned preferable ranges. The dielectric material itself is preferably selected from among dielectric resin materials, such as Teflon (registered trademark), polyimide, polyethylene, polystyrene, polycarbonate, vinyl, and Mylar, and is used as a sole or mixed composition of one or more materials each having a low dielectric tangent of not more than 0.02, for example, which is an index (parameter) representing the dielectric loss. Those dielectric resin materials are able to maintain desired flexibility necessary for the high-frequency line of the present invention with proper setting of conditions, such as a composition.

The overall thickness of the high-frequency line is preferably as thin as possible not more than 2 mm for the purpose of reducing the sectional area and volume of the high-frequency line. From this aspect, the thickness of each of the ground layer 3 and the signal line 4 is also preferably as thin as possible. The thickness of the ground layer 3 is preferably not more than 0.2 mm if the strength of a thin plate constituting the ground layer 3 is guarantied. Also, the width of the ground layer 3 is set corresponding to the width of the dielectric layer 2 because the ground layer 3 covers the dielectric layer 2 to suppress the losses of the high-frequency wave.

The conductive material of the ground layer 3 is appropriately selected to be a metallic good conductive material from among metals and alloys, such as copper, aluminum, tin, gold, nickel and solder, and is used in any of various forms including a composite or a layered structure of some of the metals and alloys, or a plating thereof on a resin base or the like. Among those materials, a metallic material is preferable which can be easily machined into a thin plate and which can provide a thin plate having flexibility in match with the dielectric material and exhibiting the required thin-plate strength.

The signal line 4 for inducing a high-frequency wave is formed of a thin wire or a thin plate made of a material also selected from the above-mentioned metallic good conductive materials. The signal line 4 may be disposed to project above or rest on the dielectric layer 2 as in the high-frequency line 1a shown in FIG. 34, or it may be embedded in the dielectric layer 2 and extended in the lengthwise direction of the high-frequency line 1a.

Since the high-frequency micro-strip line constructed as described above is thin and flexible, it can be easily handled in manufacturing, transportation, installation, etc. in the form of a coil into which the long high-frequency line is wound, instead of the long plate-like form. In addition, the high-frequency micro-strip lines has superior basic characteristics as a high-frequency line in points of, e.g., a low loss of the high-frequency wave propagated through the line.

Embodiments and examples of the present invention will be further described below with reference to the attached drawings for clearer understanding of the present invention. Note that the following embodiments and examples are given, just by way of example, to explain the practical modes of the present invention and are not intended to restrict the technical scope of the present invention.

With reference to the drawings, a description is made on embodiments of a wireless-communication RF signal transmission device that is applicable to the high-frequency micro-strip line, the wireless LAN mobile-station terminal antenna, the terminal wireless LAN card, and the wireless LAN system which have been described above.

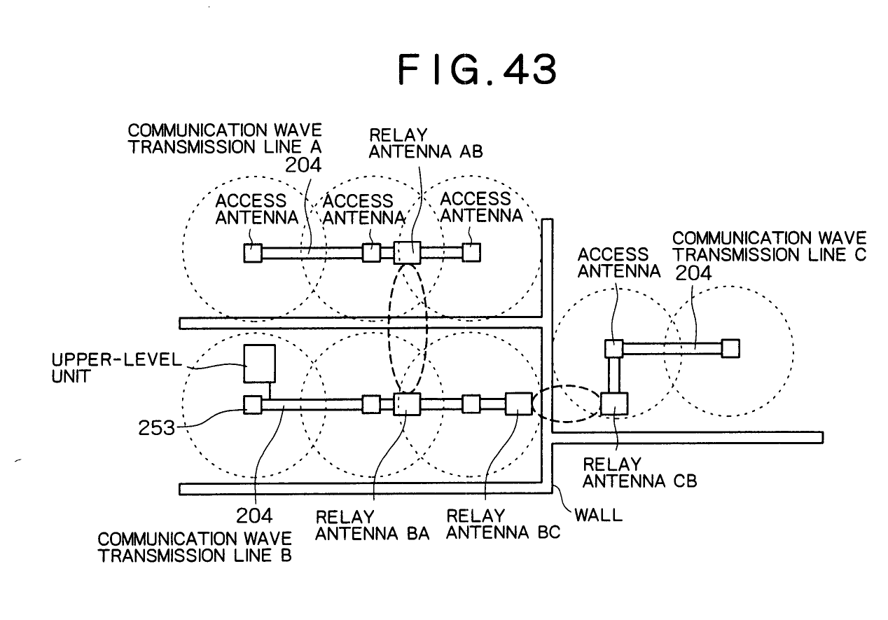

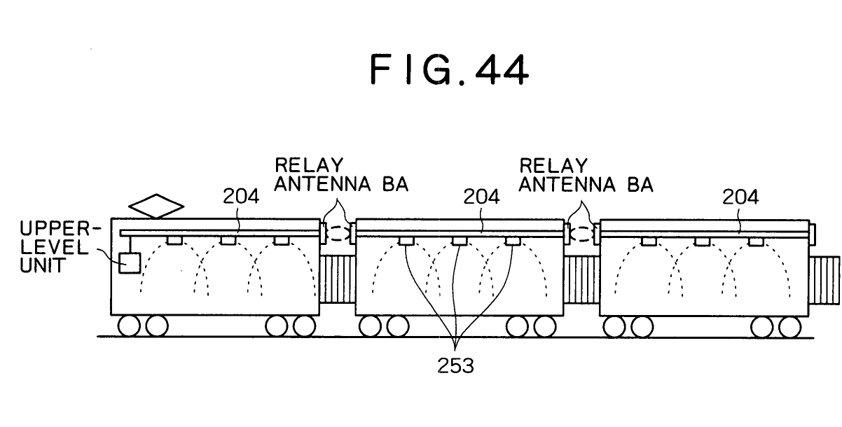

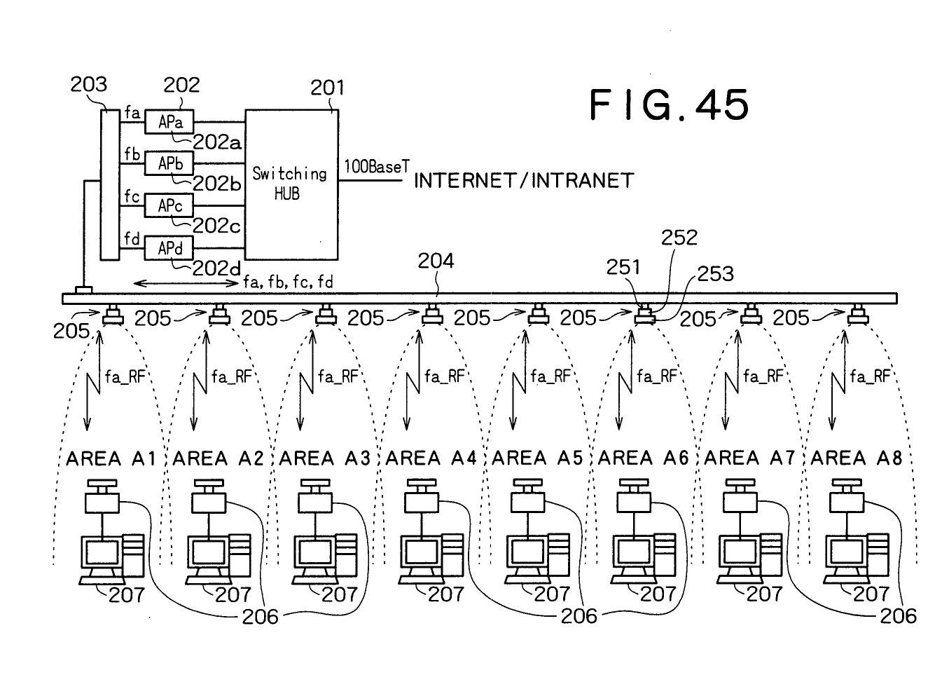

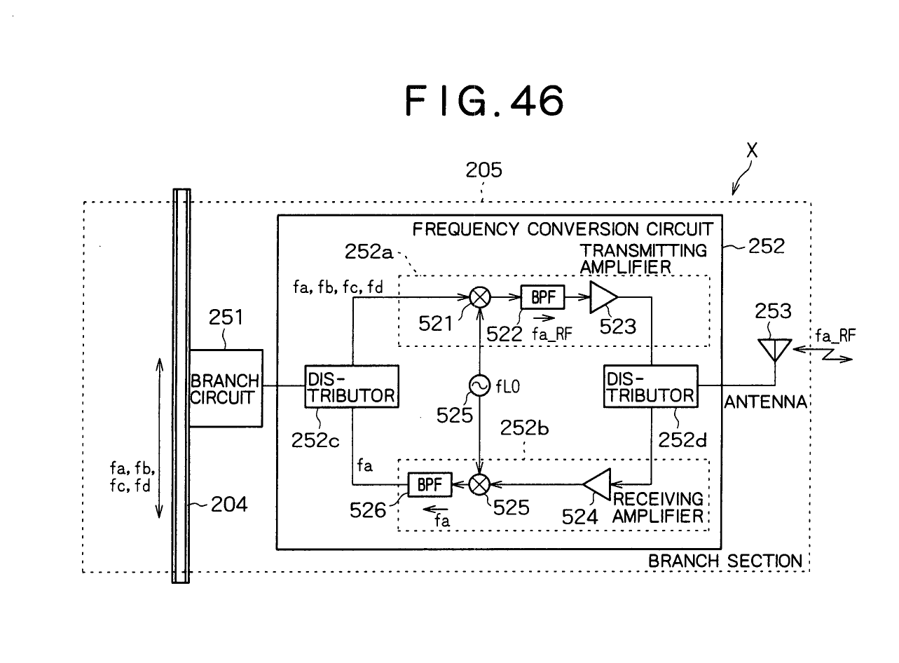

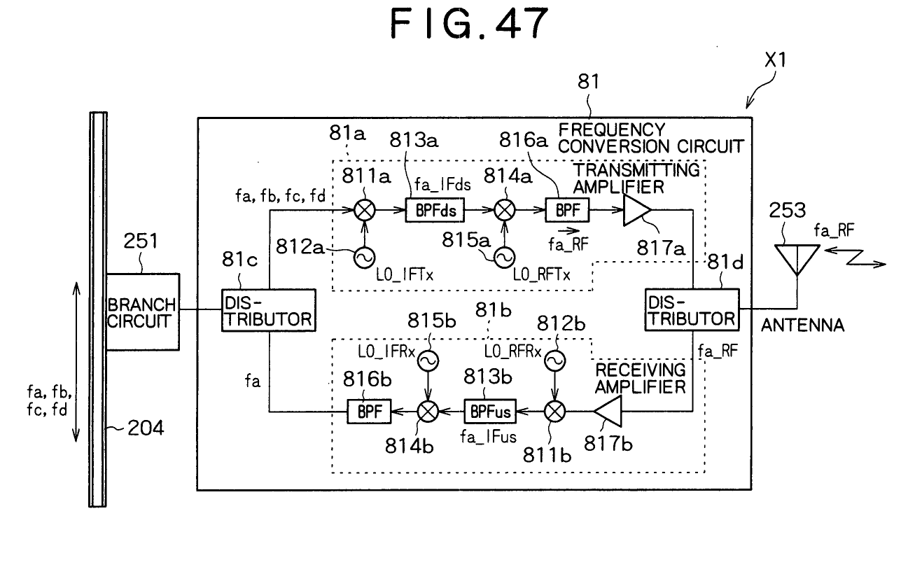

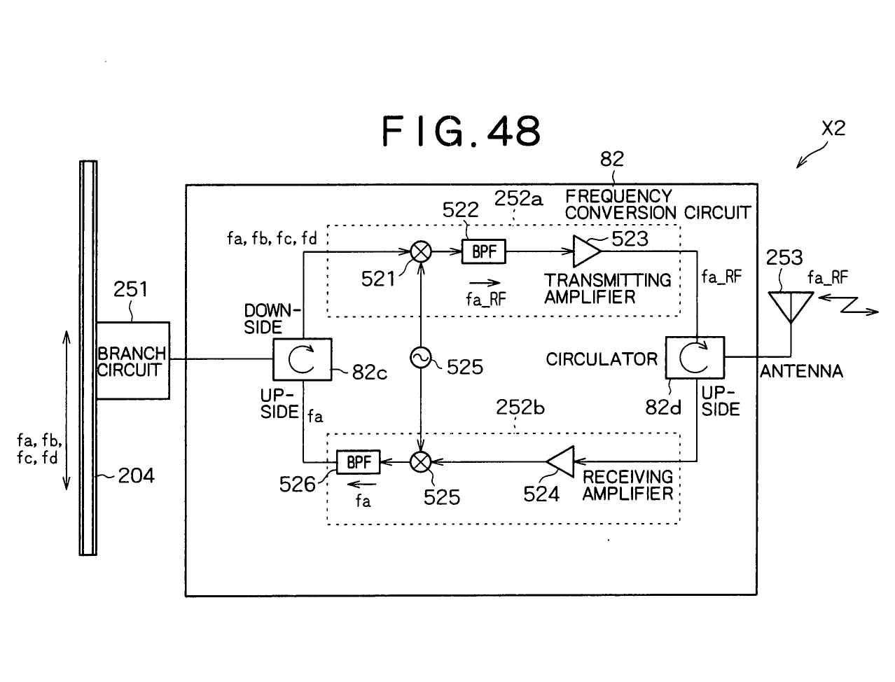

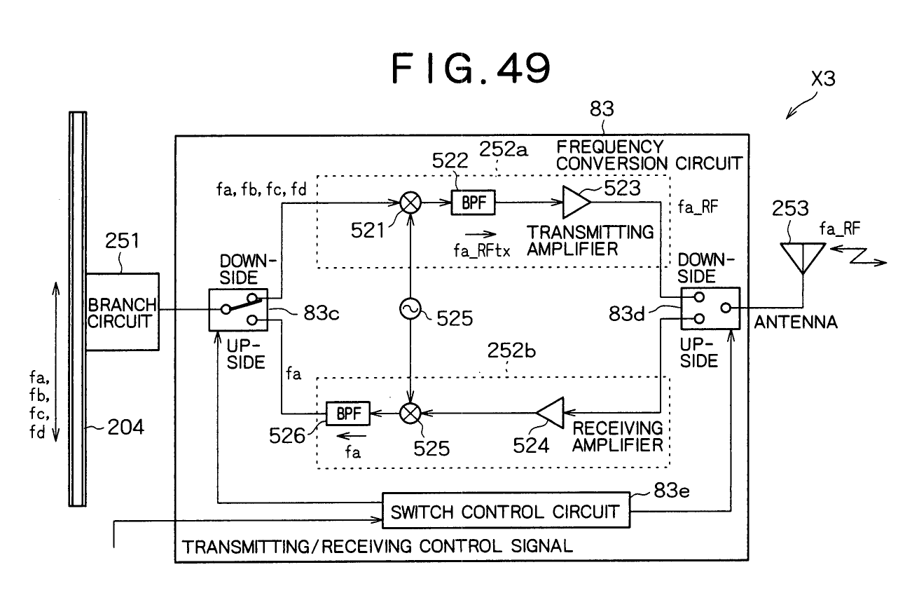

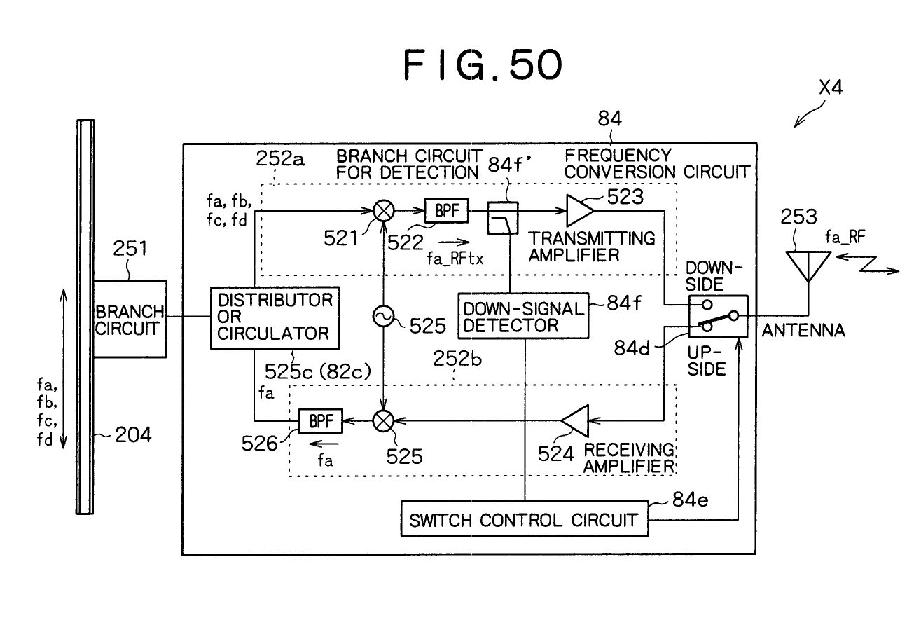

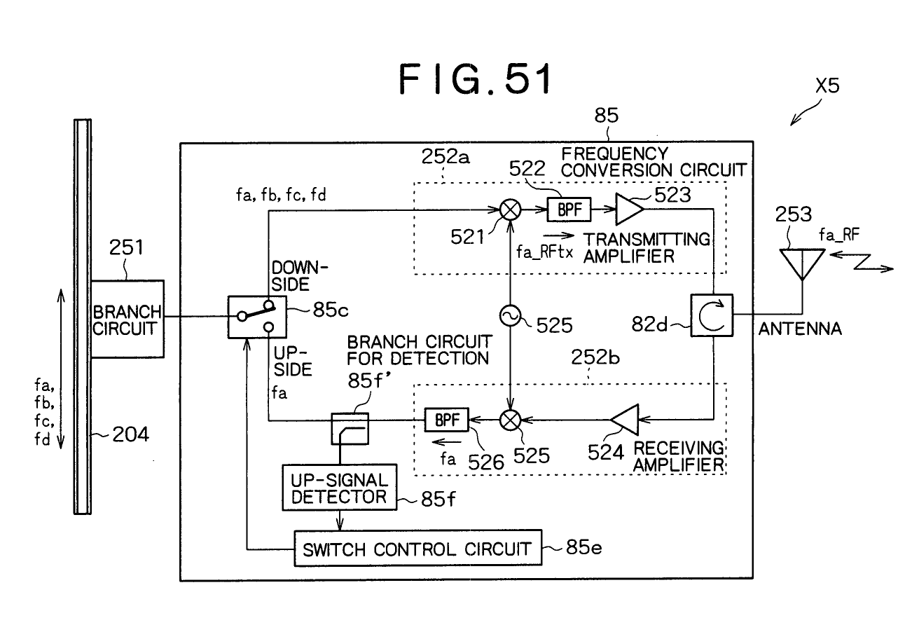

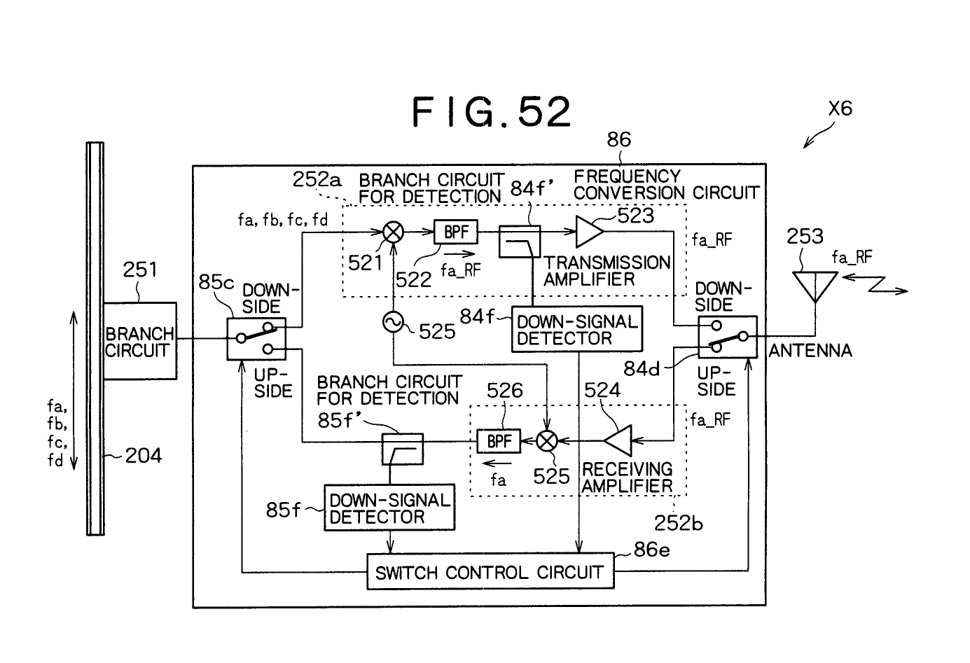

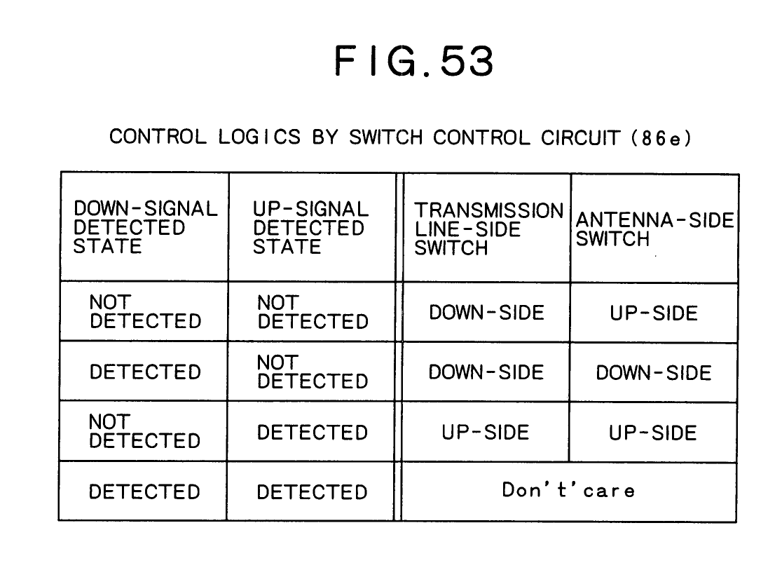

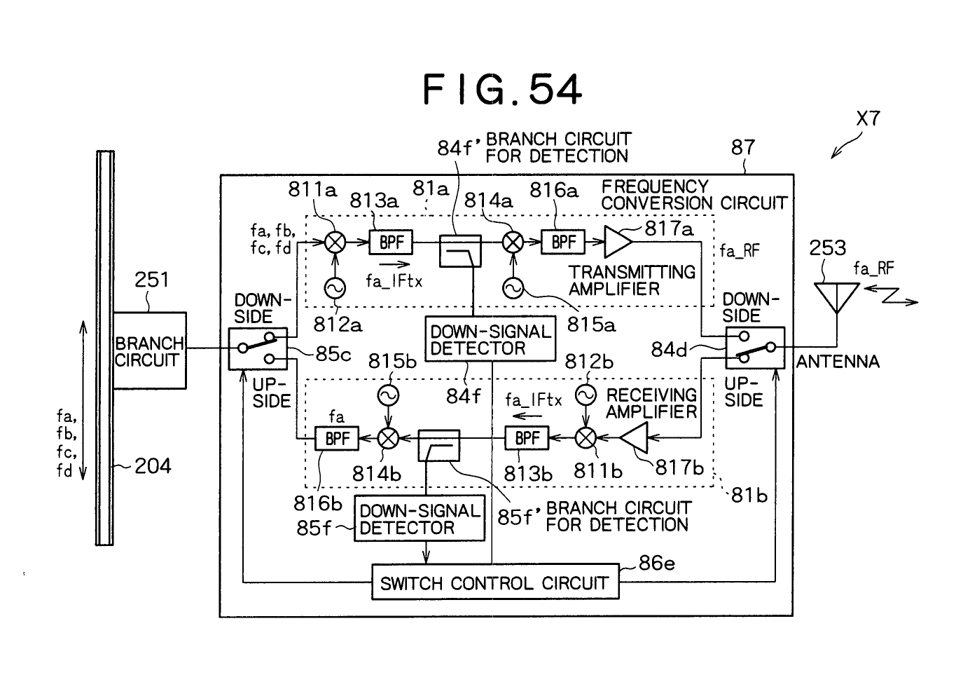

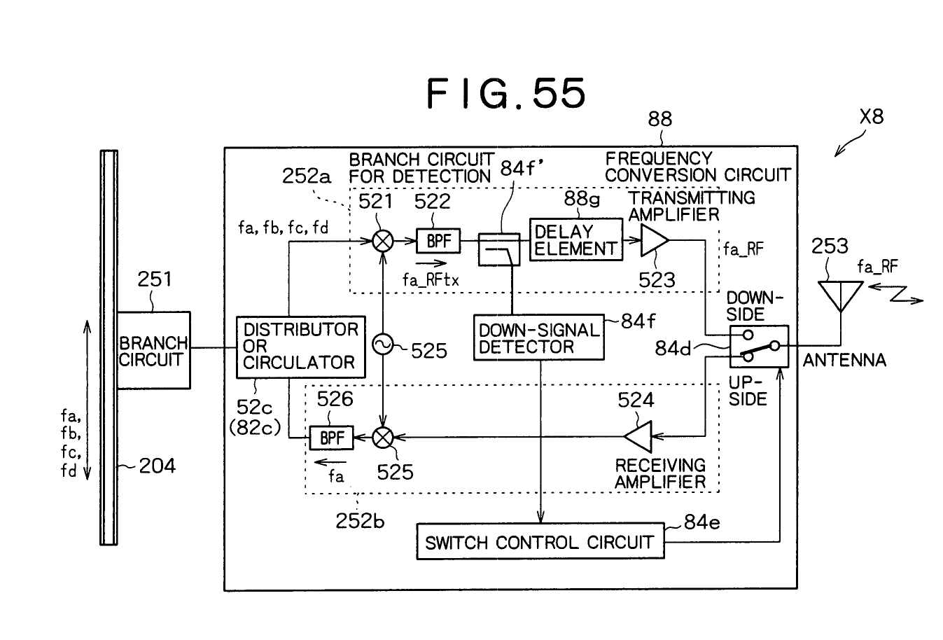

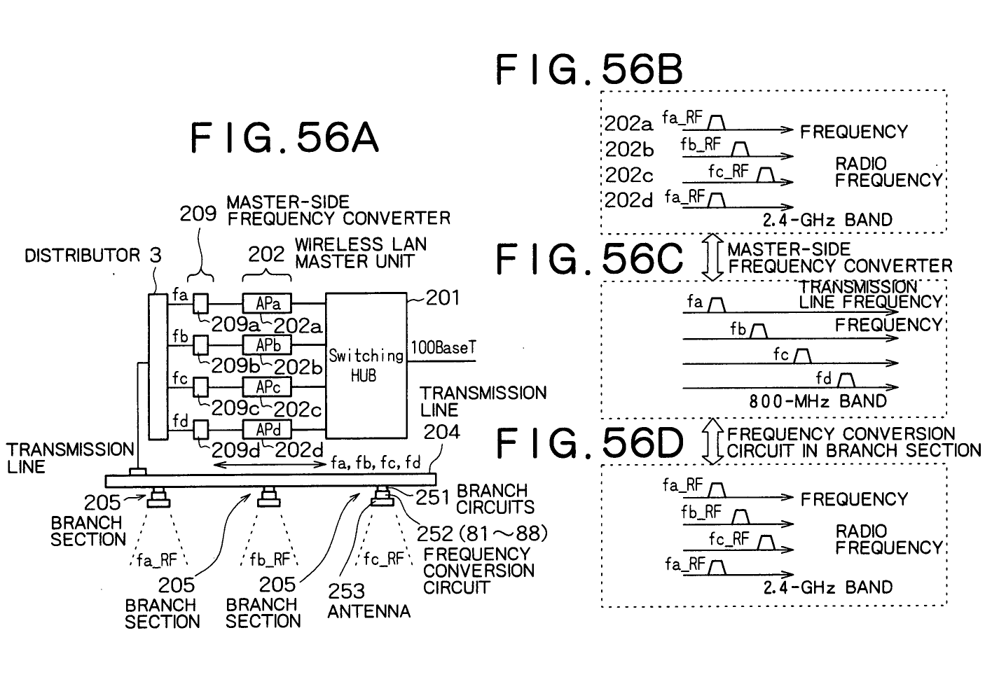

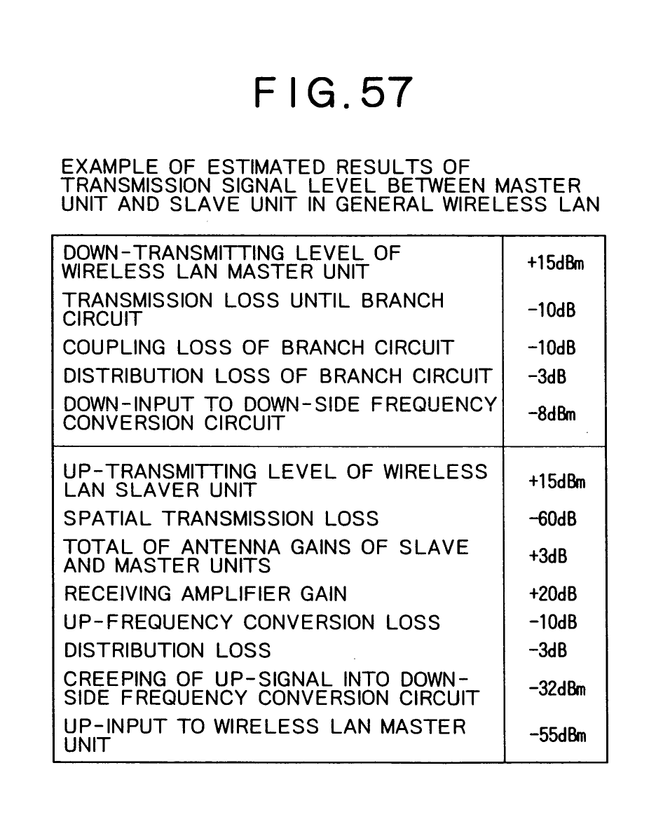

FIG. 43 schematically shows the wireless-communication RF signal transmission device according to one embodiment of the present invention; FIG. 44 schematically shows the wireless-communication RF signal transmission device according to another embodiment of the present invention; FIG. 45 schematically shows a wireless LAN system using a wireless-communication RF signal transmission device X according to an embodiment of the present invention; FIG. 46 is a block diagram schematically showing a branch section in the wireless-communication RF signal transmission device X according to the embodiment of the present invention; FIG. 47 is a block diagram schematically showing a branch section in a wireless-communication RF signal transmission device X1 according to a first embodiment of the present invention; FIG. 48 is a block diagram schematically showing a branch section in a wireless-communication RF signal transmission device X2 according to a second embodiment of the present invention; FIG. 49 is a block diagram schematically showing a branch section in a wireless-communication RF signal transmission device X3 according to a third embodiment of the present invention; FIG. 50 is a block diagram schematically showing a branch section in a wireless-communication RF signal transmission device X4 according to a fourth embodiment of the present invention; FIG. 51 is a block diagram schematically showing a branch section in a wireless-communication RF signal transmission device X5 according to a fifth embodiment of the present invention; FIG. 52 is a block diagram schematically showing a branch section in a wireless-communication RF signal transmission device X6 according to a sixth embodiment of the present invention; FIG. 53 is a table showing logics in changeover of switches in the wireless-communication RF signal transmission device X6 according to the sixth embodiment of the present invention; FIG. 54 is a block diagram schematically showing a branch section in a wireless-communication RF signal transmission device X7 according to a seventh embodiment of the present invention; FIG. 55 is a block diagram schematically showing a branch section in a wireless-communication RF signal transmission device X8 according to an eighth embodiment of the present invention; FIG. 56 schematically shows a wireless LAN system according to a ninth embodiment of the present invention; and FIG. 57 represents one example of estimation results of signal levels of transmission signals between a master unit and a slave unit in a general LAN.

First, one embodiment of the present invention will be described with reference to FIG. 43.

FIG. 43 is a plan view of a wireless-communication RF signal transmission line 204, looking from above, installed in three rooms partitioned by walls indicated by hatching.

The wireless-communication RF signal transmission line 204 is divided for each of the rooms and is made up of three wireless-communication RF signal transmission lines A, B and C. Disposed on each of the wireless-communication RF signal transmission lines are a relay antenna AB (for interconnecting the wireless-communication RF signal transmission lines A and B) which includes branching/joining means and an interconnection radio antenna, a relay antenna BC (for interconnecting the wireless-communication RF signal transmission lines B and C), and a relay antenna AC (for interconnecting the wireless-communication RF signal transmission lines A and C). Details of the branching/joining means and the interconnection radio antenna will be described in detail later. The wireless-communication RF signal transmission lines can be constituted using the high-frequency lines shown in FIGS. 1-39, but its practical forms are not limited to them.

Each of the wireless-communication RF signal transmission. lines includes a plurality of access antennas 253 for making communication with antennas (not shown) of lower-level units, such as terminals disposed in the corresponding room. The access antennas 253 can be each constituted using the above-described antenna 6 (6a, 6b, 6c, . . . ), but it is not limited thereto. The access antennas 253 are employed in combination with the branching/joining means. A communication area of each of the access antennas 253 is represented by a circle, indicated by a thin dotted line, about the access antenna 253. One or more lower-level units are present within the circle to make communication with a higher-level unit connected to any of the wireless-communication RF signal transmission lines 204 (wireless-communication RF signal transmission line B in this embodiment).

In the illustrated Wireless-communication RF signal transmission device, the relay antennas BC and CB are positioned as a pair opposite to each other in the lengthwise direction for relaying RF signals for wireless communication between the wireless-communication RF signal transmission lines B and C. Similarly, the relay antennas AB and BA are positioned as a pair for relaying RF signals for wireless communication between the wireless-communication RF signal transmission lines A and B. Thus, RF signals for wireless communication are relayed between the three wireless-communication RF signal transmission lines in a radio manner so that, as described above, communication is performed between the higher-level unit and any of the lower-level units, i.e., a mobile or other terminal connected to one of the wireless-communication RF signal transmission lines via radio through the access antenna. Of course, radio communication may also be performed between the higher-level unit and the wireless-communication RF signal transmission line B.

Note that, in FIG. 48, a thick dotted line illustrates how an RF signal for wireless communication is transmitted between the relay antennas opposed to each other.

In order to improve the communicating function between the relay antennas opposed to each other and suppress entry of noises, it is preferable to limit a region covered by the radio wave. For that purpose, a relay antenna having directivity toward a corresponding relay antenna is preferably used.

For the same purpose, an amplifying means capable of providing an appropriate amplification rate is preferably installed between the wireless-communication RF signal transmission line and the relay antenna. By interposing the amplifying means, attenuation of the RF signal for wireless communication can be prevented and communication can be performed with good sensitivity even when the length of the wireless-communication RF signal transmission line is increased.

Further, by changing the frequency of the wireless-communication RF signal propagating through each of the wireless-communication RF signal transmission lines, the entire system is adaptable for different frequency bands that can be received by many lower-level units. For that purpose, a frequency converting means is preferably disposed instead of the amplifying means or in combination with the amplifying means. Details of the frequency converting means will be described later.

In this embodiment, the higher-level unit is connected to the wireless-communication RF signal transmission line B. Accordingly, when the lower-level unit connected to the wireless-communication RF signal transmission line A performs communication with the higher-level unit, two-way communication is established with a wireless-communication RF signal propagating through routes of the higher-level unit⇄the wireless-communication RF signal transmission line B⇄the relay antenna BA⇄the relay antenna AB⇄the wireless-communication RF signal transmission line A⇄the access antenna⇄the lower-level unit. Similarly, when the higher-level unit performs communication with the lower-level unit connected to the wireless-communication RF signal transmission line C, two-way communication is established with a wireless-communication RF signal propagating through routes of the higher-level unit⇄the wireless-communication RF signal transmission line B⇄the relay antenna BC⇄the relay antenna CB⇄the wireless-communication RF signal transmission line C⇄the access antenna⇄the lower-level unit. Thus, according to this aspect of the present invention, a plurality of wireless-communication RF signal transmission lines can be connected to each other via radio in a two-way manner, and therefore the wireless-communication RF signal transmission line can be extended with no need of work for penetrating a wall.

FIG. 44 shows an embodiment in which the wireless-communication RF signal transmission lines are installed in cars of a railway train in one-to-one relation and are connected to each other via radio relay antennas. The operation is essentially the same as that in FIG. 43. By thus installing the wireless-communication RF signal transmission lines connected to each other, work for connecting wires while bridging the adjacent cars is no longer required. Further, even when the order of cars interconnected is changed with rearrangement of the cars, time and labor required can be reduced because of no necessity of changing the relationship in physical connections of the installed radio transmission lines.

The embodiments shown in FIGS. 43 and 44 are free optional regarding whether the frequency of a wireless-communication RF signal transmitted through the wireless-communication RF signal transmission line and the frequency of an RF signal for wireless communication outputted from the access antenna 253 connected to that wireless-communication RF signal transmission line are different or equal to each other. In other words, both embodiments include not only the case whether the two frequencies are the same, but also the case where the frequency converting means is interposed between the access antenna 253 and the wireless-communication RF signal transmission line so that a wireless-communication RF signal having a frequency different from that of a wireless-communication RF signal transmitted through the relevant wireless-communication RF signal transmission line is outputted from the access antenna 253 via radio.

With reference to FIG. 45, a description is now made on an outline of a wireless LAN system using a wireless-communication RF signal transmission device X according to an embodiment of the present invention, which is featured in that a wireless-communication RF signal having a frequency different from that of a wireless-communication RF signal transmitted through the wireless-communication RF signal transmission line is outputted from the access antenna 253 via radio. While one wireless-communication RF signal transmission line is used, by way of example, in the following embodiment, it is needless to say that the present invention is applicable to not only the system in which a plurality of wireless-communication RF signal transmission lines are interconnected via radio communicating means as in the above-described embodiment of FIG. 43 or 44, but also the case where the higher-level unit and the wireless-communication RF signal transmission line connected to the higher-level unit are interconnected via radio communicating means. In either case, it is also possible to provide an amplifying or attenuating means and/or a frequency converting means between the transmission lines or in the radio communicating means connecting the transmission line and the higher-level unit to each other. Further, in this embodiment, the radio communicating means is desirably constituted as an antenna with directivity.

Each of the radio antennas for access used in the embodiments shown in FIGS. 43 and 44 has the same structure as the radio antenna for relay. Details of the antenna structure will be described in detail in the embodiments shown in FIG. 45 and subsequent drawings. In a wireless LAN system shown in FIG. 45, the wireless-communication RF signal transmission device X transmits RF signals for wireless communication transmitted and received between a plurality (four in the embodiment of FIG. 45) of wireless LAN master units 202a, 202b, 202c and 202d (hereinafter referred to collectively as “wireless LAN master units 202” (one example of the above-mentioned higher-level unit)), which are interconnected by a switching HUB 201, and wireless LAN slave units 206 (one example of the above-mentioned lower-level unit) performing radio communication with the wireless LAN master units 202 via radio electric waves. The wireless LAN slave units 206 are each the same as the above-described slave unit 9 (9a, 9b, 9c, 9d . . . ).

The wireless-communication RF signal transmission device X comprises a transmission line 204 connected to the wireless LAN master units 202 via a distributor 203, branch circuits 251 (one example of the branching/joining means) disposed in plural points of the transmission line 204 for branching RF signals for wireless communication transmitted from the transmission line 204 and joining RF signals for wireless communication transmitted to the transmission line 204, antennas 253 (radio antennas) disposed in one-to-one relation to the branch circuits 251 for transmitting and receiving RF signals for wireless communication as radio electric waves with respect to the wireless LAN slave units 206, and frequency conversion circuits 252 connected between the branch circuits 251 and the antennas 253 for converting the frequencies of RF signals for wireless communication. In the following, the branch circuits 251, the frequency conversion circuits 252, and the antennas 253 are referred to collectively as a branch section 205.

Further, each of the wireless LAN master units 202 is connected to a higher-level network (not shown), such as an intranet or the Internet, via the switching HUB 201. An information terminal 207, such as a personal computer, is connected to each of the wireless LAN slave units 206 by a 10 Base-T cable or the like.

The down-signals (RF signals for wireless communication) transmitted from the plurality of wireless LAN master units 202 to the lower-level side are combined with each other by the distributor 203 and transmitted to the transmission line 204. Also, the RF signals for wireless communication (communication signals) transmitted (propagated) through the transmission line 204 are tapped (branched) by the branch circuits 251 disposed on the transmission line 204 at appropriate intervals (e.g., a spacing of about 10 m), and are subjected to conversion of the radio frequency by the frequency conversion circuits 252. Thereafter, the RF signals for wireless communication are radiated as radio electric waves into service areas (radio communicable areas) from the antennas 253, and are received by the wireless LAN slave units 206 in the service area.

On the other hand, radio electric waves (RF signals for wireless communication) radiated from the wireless LAN slave units 206 are received by the antennas 253, and their frequencies are converted by the frequency conversion circuits 252 into frequencies adapted for the transmission line 204 (hereinafter referred to as “transmission line frequencies”), followed by being joined into the transmission line 204 thorough the branch circuits 251. Thereafter, those up-signals transmitted through the transmission line 204 are distributed respectively to the plurality of wireless LAN master units 202 by the distributor 203.

Thus, the information terminals 207 connected to the wireless LAN slave units 206, which are present in the service area, are constructed to be communicable with a higher-level network, such as an intranet or the Internet via the wireless-communication RF signal transmission device X.

The wireless LAN system of this embodiment is featured in including the frequency conversion circuits 252. With the provision of the frequency conversion circuits 252, the frequency of the wireless-communication RF signal transmitted from and received by each of the wireless LAN master unit 202 with respect to the lower-level side (i.e., the side of the transmission line 204) can be made different from the frequency of the wireless-communication RF signal transmitted and received, as a radio electric wave from and by the corresponding wireless LAN slave unit 206 with respect to the higher-level side.

(Wireless LAN Master Unit)

The plurality of wireless LAN master units 202 modulate data in accordance with the direct spreading method, for example, and perform communication in accordance with the TDD method. In the following description, signals (RF signals for wireless communication) transmitted from the wireless LAN master units 202 to the wireless LAN slave units 206 are called down-signals, and signals (RF signals for wireless communication) transmitted from the wireless LAN slave units 206 to the wireless LAN master units 202 are called up-signals.

The RF signals for wireless communication used by the plurality of wireless LAN master units 202 have different central frequencies (transmission line frequencies) fa, fb, fc and fd, and these frequencies are set so as not to interfere with one another. In the case using an occupied frequency bandwidth of 22 MHz, for example, the central frequencies fa, fb, fc and fd are allocated (set) at frequency intervals of at least 22 MHz between them. Also, the transmission line frequencies fa through fd are set to frequencies at which the RF signals for wireless communication are less attenuated in the transmission line 204. For example, when a strip-line is used as the transmission line 204, a transmission loss of about 1 dB/m is obtained if fa through fd are set to fall in the 2.4-GHz band, and a transmission loss of about 0.5 dB/m is obtained if fa through fd are set to frequencies near 800 MHz. Thus, since the frequencies of the RF signals for wireless communication in the transmission line 204 can be set to lower frequencies regardless of the frequencies of the radio electric waves (i.e., the frequencies of the RF signals for wireless communication transmitted from and received by the antennas 253 via radio), signal transmission with a small attenuation can be realized.

(Transmission Line)

The transmission line 204 can be formed to have various structures and material properties. Practically, the structure and the material properties are selected to be capable of transmitting the RF signals for wireless communication at a small loss, which are transmitted from and received by the wireless LAN master units 202 with respect to the lower-level side.

Also, even when there are limitations on the structure and the material properties of the transmission line 204 from the viewpoints of manufacturing, mounting, etc. of the transmission line 204, it is possible to set (use) frequencies suitable for the structure and the material properties of the transmission line 204.

For example, when the transmission line 204 is manufactured by forming a strip-line on a substrate made of Teflon (trademark registered by Dupont, this is similarly applied to Teflon in the following description), the transmission loss is about 2.7 dB/m in the 5.2 GHz band, about 1.3 dB/m in the 2.4 GHz band, and about 0.5 dB/m at 800 MHz. Accordingly, even in the case using the 5.2 GHz band for the radio frequencies, the loss can be greatly reduced in comparison with the known system by designing the transmission frequencies for the transmission line 204 so as to fall in the 800-MHz band.

Stated another way, when the radio frequencies and an allowable transmission loss of the transmission line 204 in terms of circuit design are given, the length of the transmission line 204 can be drastically increased in comparison with the case where the radio frequencies are the same as the transmission frequencies in the transmission line 204 as in the known system.

Assume, for example, that the 5.2 GHz band is used for the radio frequencies and the transmission line loss in terms of circuit design is allowed up to 10 dB. In this case, when the transmission line 204 is manufactured by forming a strip-line on a substrate made of Teflon, a maximum transmission length of the transmission line 204 is about 4 m on condition that the radio frequencies are the same as the transmission frequencies in the transmission line 204 as in the known system. In contrast, by using 800 MHz for the frequencies in the transmission line 204, transmission over a distance of 20 m can be realized. The transmission over a longer distance can be realized by using a coaxial line (coaxial cable) as the transmission line.

(Branch Section)

Each of the branch sections 205 comprises the branch circuit 251, the frequency conversion circuit 252, and the antenna 253. Such a structure is similarly employed in the relay antenna or the radio access antenna in the embodiments shown in FIGS. 43 and 44.

The branch circuit 251 couples with a part of the down-signals (electric signals) in the transmission line 204 to introduce (tap) it to the frequency conversion circuit, and also joins the up-signal from the frequency conversion circuit into the transmission line 204.

The frequency conversion circuit 252 discriminates only the desired modulated wave from the down-signals (RF signals for wireless communication) flowing through the transmission line 204 depending on frequency, and selectively converts only the desired modulated wave to the radio frequency. Also, the frequency conversion circuit 252 discriminates only the desired modulated wave from the up-signals (RF signals for wireless communication) received by the antenna 253 depending on frequency, and selectively converts only the desired modulated wave to the transmission line frequency.

The wireless LAN system shown in FIG. 45 represents a system using three kinds of radio frequencies fa_RF, fb_RF and fc_RF (channel frequencies). It is decided in advance which one of the radio frequencies fa_RF, fb_RF and fc_RF is used in each of areas A1-A8. In the embodiment of FIG. 45, the radio frequency fa_RF is used in the areas A1, A2, A7 and A8, the radio frequency fb_RF is used in the areas A3, A4, and the radio frequency fc_RF is used in the areas A5, A6, respectively.

Further, for each of the areas A1-A8, it is decided in advance to which one of the four wireless LAN master units 202 is connected each area for communication. In the embodiment of FIG. 45, the areas A1, A2 are connected for communication to the wireless LAN master unit 202 having the transmission line frequency fa, and the areas A3, A4 are connected for communication to the wireless LAN master unit 202 having the transmission line frequency fb. The areas A5, A6 are connected for communication to the wireless LAN master unit 202 having the transmission line frequency fc, and the areas A7, A8 are connected for communication to the wireless LAN master unit 202 having the transmission line frequency fd.

In other words, the frequency conversion circuits 252 are set in advance as follows. The circuits 252 disposed in the areas A1, A2 execute mutual conversion between the transmission line frequency fa and the radio frequency fa_RF, and the circuits 252 disposed in the areas A3, A4 execute mutual conversion between the transmission line frequency fb and the radio frequency fb_RF. The circuits 252 disposed in the areas A5, A6 execute mutual conversion between the transmission line frequency fc and the radio frequency fc_RF, and the circuits 252 disposed in the areas A7, A8 execute mutual conversion between the transmission line frequency fd and the radio frequency fa_RF.

In the wireless LAN system shown in FIG. 45, because the plurality of wireless LAN master units 202 employ the transmission line frequencies fa through fd differing from each other, no data collisions occur on the transmission line 204 between the RF signals for wireless communication used by the wireless LAN master units 202. Therefore, a larger number (4) of wireless LAN master units 202 than the number (3) of kinds of the radio frequencies can be connected and the transmission capacity can be easily increased. Of course, there possibly occur data collisions between the RF signals for wireless communication used by the plurality of wireless LAN slave units 206 in the area covered by one wireless LAN master unit 202. However, those data collisions can be easily avoided, for example, by employing the communication protocol in the infrastructure mode according to the IEEE 802.11 standards. Further, the occurrence of interference between electric waves can be prevented by setting the radio frequencies in the adjacent areas to differ from each other.

In addition, because the wireless LAN master units 202 (higher-level units) are assigned corresponding to the respective areas and connected for communication, the communication load can be efficiently distributed.

Details of the branch section 205 will be described below.

FIG. 46 is a block diagram schematically showing the branch section 205 in the wireless-communication RF signal transmission device X. The branch section 205 shown in FIG. 46 represents one example of the branch section 205 disposed in each of the areas A1, A2 in FIG. 45. More specifically, the branch section 205 shown in FIG. 46 discriminates, from among the RF signals for wireless communication flowing through the transmission line 204 and having the four channel frequencies fa, fb, fc and fd, the channel signal (RF signal for wireless communication) having the central frequency fa, and executes mutual conversion between the channel frequency fa and the radio frequency fa_RF.

As described above, the branch section 205 comprises the branch circuit 251, the frequency conversion circuit 252, and the antenna 253.

Further, the frequency conversion circuit 252 comprises a down-side frequency conversion circuit 252a (one example of the frequency downconversion means) for executing frequency conversion of the down-signal (wireless-communication RF signal flowing downstream), an up-side frequency conversion circuit 252b (one example of the frequency upconversion means) for executing frequency conversion of the up-signal (wireless-communication RF signal flowing upstream), a distributor 252c for connecting the branch circuit 251 and the up-/down-side frequency conversion circuits 252a, 252b to execute distribution and combination of the RF signals for wireless communication, and a distributor 252d for connecting the antenna 253 and the up-/down-side frequency conversion circuits 252a, 252b to execute distribution and combination of the RF signals for wireless communication.

The down-side frequency conversion circuit 252a comprises a frequency mixer 525 for receiving the RF signals for wireless communication from the distributor 252c, a band-pass filter 522 for receiving output signals from the frequency mixer 521 and allowing passage of only a signal in a band of the radio frequency fa_RF (i.e., inhibiting passage of the other signals in bands of the radio frequencies fb_RF through fd_RF), and a transmitting amplifier 523 for amplifying an output signal of the band-pass filter 522. The signal (RF signal for wireless communication) amplified by the transmitting amplifier 523 is radiated as a radio electric wave from the antenna 253.

Also, the up-side frequency conversion circuit 252b comprises a receiving amplifier 524 for amplifying a signal received by the antenna 253, a frequency mixer 525 for receiving an output signal from the receiving amplifier 524, and a band-pass filter 526 for receiving output signals from the frequency mixer 525 and allowing passage of only a signal in a band of the channel frequency fa (i.e., inhibiting passage of the other signals in bands of the channel frequencies fb through fd). The signal (RF signal for wireless communication) having the frequency discriminated by the band-pass filter 526 is joined into the transmission line 204 via the distributor 252c and the branch circuit 251.

The frequency conversion circuit 252 shown in FIG. 46 is constituted such that the down- and up-side frequency conversion circuits 252a, 252b share one frequency oscillator 525 for generating (outputting) a reference oscillation signal, and the reference oscillation signal from the frequency oscillator 525 is inputted to each of the two frequency mixers 521, 525. A simpler arrangement can be obtained by causing both the down- and up-side frequency conversion circuits 252a, 252b to share the single frequency oscillator 525.

The operation of the frequency conversion circuit 252 will be described below.

Incidentally, the frequency conversion circuit 252 is similar to that used in the relay antenna in the embodiments shown in FIGS. 43 and 44.

(Down-side Frequency Conversion Circuit)

The RF signals for wireless communication (input signals) branched from the transmission line 204 by the branch circuit 251 and inputted to the down-side frequency conversion circuit 252a via the distributor 252c contain signals of all the channel frequencies fa through fd. Those input signals are mixed in the frequency mixer 521 with the oscillation signal (reference oscillation signal) from the frequency oscillator 525 for frequency conversion (output frequency=input frequency±frequency of reference oscillation signal). Here, the frequency (i.e., reference frequency fLO) of the reference oscillation signal from the frequency oscillator 525 is set so that the channel frequency fa is converted into the radio frequency fa_RF. Stated another way, though depending on a passage characteristic of the band-pass filter 522, the reference frequency is set so as to approximately satisfy (fLO=fa_RF−fa) (each of fa_RF and fa represents a central frequency).

Thus, only the signal of the channel frequency fa (i.e., the channel signal) is discriminated from among the RF signals for wireless communication containing the signals of all the channel frequencies fa through fd and is frequency-converted to have the radio frequency fa_RF, followed by being radiated from the antenna 253.

(Up-side Frequency Conversion Circuit)

On the other hand, the frequency of the wireless-communication RF signal (input signal) received by the antenna 253 and inputted to the up-side frequency conversion circuit 252b via the distributor 252d and the receiving amplifier 524 is the radio frequency fa_RF. That input signal is mixed in the frequency mixer 525 with the reference oscillation signal of the reference frequency fLO for frequency conversion. Here, the reference frequency fLO is set so as to approximately satisfy (fLO=fa_RF−fa). Therefore, the frequency mixer 525 outputs signals having frequencies fa±fLO=(fa_RF, 2fa−fa_RF). From among those signals after the frequency conversion, only the signal in the band of the channel frequency fa is discriminated by the band-pass filter 526.

Thus, the wireless-communication RF signal of the radio frequency fa_RF is frequency-converted to have the channel frequency fa and then joined into the transmission line 204.

While the frequency conversion circuit 252 shown in FIG. 46 is designed on an assumption that the transmission line frequency (channel frequency) is fa and the radio frequency is fa_RF, it is similarly applied to the frequency conversion in other patterns.

For example, when the transmission line frequency is fb and the radio frequency is fb_RF, the frequency conversion circuit 252 operates in a similar manner to the above-described operation by modifying the down-side band-pass filter 522 so as to allow passage of the wireless-communication RF signal only in the band of the radio frequency fb_RF, by modifying the up-side band-pass filter 526 so as to allow passage of the wireless-communication RF signal only in the band of the transmission line frequency (channel frequency) fb, and by setting the oscillation frequency of the frequency conversion circuit 252 correspondingly.

The above-described arrangement is advantageous in that the frequency conversion circuit 252 can be constituted using one frequency oscillator 525.

In the branch section 205, active devices such as the amplifiers must be supplied with power. When a coaxial cable or a strip line is used as the transmission line 204, power is supplied to the branch section 205, and therefore power supply to the active devices can be realized by supplying a DC power through the transmission path 204 in a superimposed manner with no need of separately laying a power supply cable.

### First Embodiment of Wireless-Communication RF Signal Transmission Device

A wireless-communication RF signal transmission device X1 according to a first embodiment of the present invention will be described below. The wireless-communication RF signal transmission device X1 is one resulting from modifying the frequency conversion circuit 252 into another arrangement. The remaining arrangement and functions are the same as those in the wireless-communication RF signal transmission device X. In the following, a frequency conversion circuit 81 included in the wireless-communication RF signal transmission device X1 is described with reference to FIG. 47.

The frequency conversion circuit 81 comprises a down-side frequency conversion circuit 81a (one example of the frequency downconversion means) for executing frequency conversion of the down-signal (wireless-communication RF signal flowing downstream), an up-side frequency conversion circuit 81b (one example of the frequency upconversion means) for executing frequency conversion of the up-signal (wireless-communication RF signal flowing upstream), a distributor 81c for connecting the branch circuit 251 and the up-/down-side frequency conversion circuits 81a, 81b to execute distribution and combination of the RF signals for wireless communication, and a distributor 81d for connecting the antenna 253 and the up-/down-side frequency conversion circuits 81a, 81b to execute distribution and combination of the RF signals for wireless communication.

The down-side frequency conversion circuit 81a comprises a first-stage frequency mixer 811a (first frequency mixer) for receiving the RF signals for wireless communication from the distributor 81c and executing frequency conversion, a first-stage frequency oscillator 812a for outputting a first reference oscillation signal to the first-stage frequency mixer 811a, a first-stage band-pass filter 813a for receiving output signals from the first-stage frequency mixer 811a and allowing passage of only a signal falling in a predetermined band with a central frequency given as a predetermined intermediate down-frequency fa_IFds, a second-stage frequency mixer 814a for receiving an output signal from the first-stage band-pass filter 813a and executing frequency conversion, a second-stage frequency oscillator 815a for outputting a second reference oscillation signal to the second-stage frequency mixer 814a, a second-stage band-pass filter 816a for receiving output signals from the second-stage frequency mixer 814a and allowing passage of only a signal in the band fa_RF, fb_RF, fc_RF or fd_RF (high-frequency band) of the radio frequency, and a transmitting amplifier 817a for amplifying an output signal of the second-stage band-pass filter 816a. The signal (RF signal for wireless communication) amplified by the transmitting amplifier 817a is radiated as a radio electric wave from the antenna 253. Here, the width of the frequency passage band of the first-stage band-pass filter 813a is set to a band width just enough to allow passage of only one of the channel frequencies fa, fb, fc and fd. Further, a synthesizer having a variable oscillation frequency is used as each of the frequency oscillators 812a, 815a.

Also, the up-side frequency conversion circuit 81b comprises a receiving amplifier 817b for amplifying a signal received by the antenna 253, a first-stage frequency mixer 811b (first frequency mixer) for receiving an output signal from the receiving amplifier 817b and executing frequency conversion, a first-stage frequency oscillator 812b for outputting a first reference oscillation signal to the first-stage frequency mixer 811b, a first-stage band-pass filter 813b for receiving output signals from the first-stage frequency mixer 811b and allowing passage of only a signal falling in a predetermined band with a central frequency given as a predetermined intermediate up-frequency fa_IFus, a second-stage frequency mixer 814b for receiving an output signal from the first-stage band-pass filter 813b and executing frequency conversion, and a second-stage frequency oscillator 815b for outputting a second reference oscillation signal to the second-stage frequency mixer 814b, a second-stage band-pass filter 816b for receiving output signals from the second-stage frequency mixer 814b and allowing passage of only a signal in the band fa, fb, fc or fd of the transmission line frequency. The output signal (RF signal for wireless communication) from the second-stage band-pass filter 816b is joined into the transmission line 204 via the distributor 81c and the branch circuit 251. Here, the width of the frequency passage band of the first-stage band-pass filter 813b is set to a band width just enough to allow passage of only one of the channel frequencies fa, fb, fc and fd. Further, a synthesizer having a variable oscillation frequency is used as each of the frequency oscillators 812b, 815b.

With the arrangement of the frequency conversion circuit 81 shown in FIG. 47, combinations of the channel frequency selectively used (discriminated) from among the transmission line frequencies fa, fb, fc and fd and the frequency selectively used in the radio communication from among the radio frequencies fa_RF, fb_RF, fc_RF and fd_RF can be optionally set just by changing the setting of respective oscillation frequencies of the first and second frequency oscillators 812a, 816a, 812b and 816b with no need of modifying the details of individual components.

Looking at the down-side frequency conversion circuit 81a, the first-stage band-pass filter 813a can operate so as to discriminate (extract) only the desired channel signal by setting the frequency of the reference oscillation signal from the first-stage frequency oscillator 812a so that desired one (central frequency) of the channel frequencies fa through fd is converted into the intermediate down-frequency fa_IFds. Further, the radio frequency can be obtained as the desired frequency by setting the frequency of the reference oscillation signal from the second-stage frequency oscillator 815a so that the signal (RF signal for wireless communication) after the frequency discrimination is converted into desired one of the radio frequencies fa_RF, fb_RF, fc_RF and fd_RF. The above description is similarly applied to the up-side frequency conversion circuit 81b.

Here, the second-stage band-pass filter 817a in the down-side serves to remove unnecessary lower frequency components generated from the second-stage frequency mixer 814a and is not required to be replaced with another one having different characteristics depending on the radio frequency used. In other words, the second-stage band-pass filter 817a may be, for example, a high-pass filter. Similarly, the second-stage band-pass filter 817b in the up-side is not required to be replaced depending on the transmission line frequency used. The second-stage band-pass filter 817b may be, for example, a low-pass filter.

Thus, the need of replacing the band-pass filter depending on the frequency used can be eliminated with two-stage frequency conversion, i.e., by executing frequency conversion in the first stage to make frequency discrimination and executing frequency conversion in the second stage to establish a match with the frequency in the counterpart side (output side).

As a result, it is possible to optionally set a combination of the transmission line frequency and the radio frequency used in the system with ease for each branch section 205, and to set the combination in site where the wireless-communication RF signal transmission device X1 is disposed.

Further, while the four frequency oscillators 812a, 815a, 812b and 815b are used in the frequency conversion circuit 81 described above, it is possible to share one frequency oscillator by both the first-stage frequency oscillator 812a in the down-side and the second-stage frequency oscillator 815b in the up-side, and to share one frequency oscillator by both the second-stage frequency oscillator 812b in the down-side and the first-stage frequency oscillator 812b in the up-side, if the intermediate down-frequency fa_IFds and intermediate up-frequency fa_IFus are the same.

However, when the down- and up-side frequency conversion circuit 81a, 81b are formed on the same substrate, undesired mutual interference may occur if the intermediate down- and up-frequencies fa_IFds, fa_IFus are the same. In such a case, the mutual interference between the down-signal and the up-signal can be prevented by selecting the band-pass filters 813a, 813b in the arrangement shown in FIG. 47 so that the intermediate down- and up-frequencies fa_IFds, fa_IFus differ from each other.

### Second Embodiment of Wireless-Communication RF Signal Transmission Device

A wireless-communication RF signal transmission device X2 according to a second embodiment of the present invention will be described below. The wireless-communication RF signal transmission device X2 is one resulting from replacing a part of the frequency conversion circuit 252 in the wireless-communication RF signal transmission device X with other components. The remaining arrangement and functions are the same as those in the wireless-communication RF signal transmission device X. In the following, features of the wireless-communication RF signal transmission device X2 differing from the wireless-communication RF signal transmission device X are described with reference to FIG. 48.

In the wireless-communication RF signal transmission device X2, as shown in FIG. 48, the distributors 252c, 252d in the frequency conversion circuit 252 of the wireless-communication RF signal transmission device X are replaced with circulators 82c, 82d, respectively. More specifically, one circulator 82c interconnects the branch circuit 251, the down-side frequency conversion circuit 252a, and the up-side frequency conversion circuit 252b. The other circulator 82d interconnects the antenna 253, the down-side frequency conversion circuit 252a, and the up-side frequency conversion circuit 252b.

When the TDD method using the same radio frequency in the transmitting side and the receiving side is employed as the communication method, there is a possibility in the arrangement of the frequency conversion circuit 252, shown in FIG. 45, that a transmitted signal (wireless-communication RF signal in the down-direction) may creep into the up-side frequency conversion circuit 252b via the distributor 252d. That crept signal may further creep into the down-side frequency conversion circuit 252a via the distributor 252c, thereby forming a loop. If such a loop is formed, communication quality deteriorates as in the event of multi-path fading.

In contrast, the formation of such a loop can be prevented with the arrangement of FIG. 47 in which the circulators 82c, 82d are employed at the connections between the down-side and the up-side.

The circulator 82c has a unidirectional transmission characteristic and is connected so as to allow signal transmission primarily in the direction circulating in the order of the branch circuit 251→the down-side frequency conversion circuit 252a→the up-side frequency conversion circuit 252b→the branch circuit 251.

Also, the other circulator 82d has a unidirectional transmission characteristic and is connected so as to allow signal transmission primarily in the direction circulating in the order of the down-side frequency conversion circuit 252a→the antenna 253→the up-side frequency conversion circuit 252b→the down-side frequency conversion circuit 252a. The circulators 82c, 82d can provide a transmission cutoff characteristic of not less than 20 dB for the signal transmission in a direction opposed to the above-described direction.

With that arrangement, it is possible to prevent signals from creeping from one side to the other side, and to maintain good communication quality.

While the two circulators 82c, 82d are provided in the embodiment of FIG. 48, a similar advantage can also be obtained even with the provision of only one of the two circulators (while the other is replaced with a distributor, for example).

### Third Embodiment of Wireless-Communication RF Signal Transmission Device

A wireless-communication RF signal transmission device X3 according to a third embodiment will be described below. The wireless-communication RF signal transmission device X3 is one resulting from replacing a part of the frequency conversion circuit 252 in the wireless-communication RF signal transmission device X with other components. The remaining arrangement and functions are the same as those in the wireless-communication RF signal transmission device X. In the following, features of the wireless-communication RF signal transmission device X3 differing from the wireless-communication RF signal transmission device X are described with reference to FIG. 49.

In the wireless-communication RF signal transmission device X3, as shown in FIG. 49, the distributors 252c, 252d in the frequency conversion circuit 252 of the wireless-communication RF signal transmission device X are replaced with a switch 83c in the transmission line side and an switch 83d in the antenna side, respectively, and a switch control circuit 83e for changing over the on/off state of each switch 83c, 83d is newly provided. With such an arrangement, signals can be prevented from creeping from one of the up-/down-side frequency conversion circuits 252a, 252b into the other by changing over the switches 83c, 83d at appropriate timings during communication based on the TDD method.

According to the TDD method, transmitting and receiving timings (i.e., timings at which the down-signal and the up-signal are generated) are usually controlled from the side of the wireless LAN master unit 202. In the wireless-communication RF signal transmission device X3, therefore, a changeover signal is outputted from the wireless LAN master unit 202 to each frequency conversion circuit 83, and the switches 83c, 83d are changed over by the switch control circuit 83e in response to the changeover signal. More specifically, when the wireless LAN master unit 202 starts signal transmission, it outputs a changeover signal indicating the start of the signal transmission. Upon receiving the changeover signal, the switch control circuit 83e changes over the switches 83c, 83d such that the branch circuit 251 is connected to the down-side frequency conversion circuit 252a and the down-side frequency conversion circuit 252a is connected to the antenna 253. In the case other than the above, the wireless LAN master unit 202 outputs a changeover signal indicating that it is ready for receiving a signal. Upon receiving the changeover signal, the switch control circuit 83e changes over the switches such that the branch circuit 251 is connected to the up-side frequency conversion circuit 252b and the up-side frequency conversion circuit 252b is connected to the antenna 253. As a result, signals can be prevented from creeping from one side to the other side.

While the two switches 83c, 83d are provided in the embodiment of FIG. 49, a similar advantage can also be obtained even with the provision of only one of the two switches (while the other is replaced with a distributor, for example).

### Fourth Embodiment of Wireless-Communication RF Signal Transmission Device

A wireless-communication RF signal transmission device X4 according to a fourth embodiment of the present invention will be described below with reference to FIG. 50.

The wireless-communication RF signal transmission device X4 differs from the wireless-communication RF signal transmission device X in that the distributor 252d on the side nearer to the antenna 253 in the frequency conversion circuit 252 of the wireless-communication RF signal transmission device X is replaced with an antenna-side switch 84d, and that a switch control circuit 84e for changing over the on/off state of the switch 84d, a signal branch circuit 84f′, and a down-signal detector 84f are newly provided, the latter two detecting the signal intensity (power) of a wireless-communication RF signal in the down-side frequency conversion circuit 252a. Such an arrangement can also prevent signals from creeping from one side to the other side during communication based on the TDD method. The connection to the branch circuit 251 may be obtained with either the distributor 252c or the circulator 82c disposed at an interconnecting point.

The down-signal detector 84f detects the signal intensity of a signal (RF signal for wireless communication) after the discrimination of the desired channel signal (transmission line frequency) in the down-side frequency conversion circuit 252a.

The switch control circuit 84e receives a result detected by the down-signal detector 84f and changes over the antenna-side switch 84d such that the down-side frequency conversion circuit 252a and the antenna 253 are connected to each other when the down-signal intensity not lower than a predetermined level is detected. On the other hand, when the down-signal intensity not lower than the predetermined level is not detected for a period of a certain time or longer, the switch control circuit 84e changes over the antenna-side switch 84d such that the up-side frequency conversion circuit 252b and the antenna 253 are connected to each other. That detection of the presence or absence of a signal depending on the signal intensity may be modified so as to detect not only a magnitude of the signal intensity, but also a change of the signal intensity, etc.

There is a possibility that an up-signal received by the antenna 253 may creep into the down-side frequency conversion circuit 252a via the distributor 252c and may be detected by the down-signal detector 84f. However, because the intensity of the up-signal creeping into the down-side frequency conversion circuit 252a is smaller than that of a down-signal inputted to the down-side frequency converter, the down-signal and the up-signal are usually discernable from each other with a determination process using a threshold of a predetermined level.

For example, power transmitted from a master unit and a slave unit in a general wireless LAN is +15 dBm, while reception sensitivity is about −70 dBm. FIG. 57 shows, by way of example, estimated results of actual level differences.

Though FIG. 57 represents one example, the estimated results are standard ones as transmitting and receiving levels of the wireless LAN master unit. According to this example, a level difference of not smaller than 20 dB exists between an input level of the down-signal entering the down-side frequency conversion circuit 252a, i.e., −8 dBm, and a level of the up-signal creeping into the circuit 252a, i.e., −32 dBm. It is thus understood that the down-signal and the up-signal are discernable from each other with a determination process using a threshold of a predetermined level.

Also, when a sufficient level difference is not ensured between the up- and down-signals in some communication environments, the circulator 82c may be used instead of the distributor 252c for connection to the branch circuit 251. This enables a separation ratio between the down- and up-signals to be further improved by 20 dB or more.

With the wireless-communication RF signal transmission device X4 of this embodiment, as described above, since the switch is changed over depending on whether the wireless-communication RF signal in the down-direction is generated (detected), signals are prevented from creeping from one side to the other side by the frequency converter 84 autonomously changing over the switch with no need of laying a separate signal line extended from the wireless LAN mater unit 202 for supply of the changeover signal.

### Fifth Embodiment of Wireless-Communication RF Signal Transmission Device

A wireless-communication RF signal transmission device X5 according to a fifth embodiment of the present invention will be described below with reference to FIG. 51.

In the wireless-communication RF signal transmission device X5, changeover of the switch depending on the signal intensity in the wireless-communication RF signal transmission device X4 is performed in accordance with a detected result of the intensity of the up-signal.

As shown in FIG. 51, the wireless-communication RF signal transmission device X5 differs from the wireless-communication RF signal transmission device X2 in that the circulator 82c on the side nearer to the transmission line 204 in the frequency conversion circuit 82 of the wireless-communication RF signal transmission device X2 is replaced with a transmission line-side switch 85c, and that a switch control circuit 85e for changing over the on/off state of the switch 85c, and a branch circuit 85f′, and an up-signal detector 85 are newly provided, the latter two detecting the signal intensity (power) of a wireless-communication RF signal in the up-side frequency conversion circuit 252b. Such an arrangement can also prevent signals from creeping from one side to the other side during communication based on the TDD method.

In the wireless-communication RF signal transmission device X5, the switch control circuit 85e receives a result detected by the up-signal detector 85f and changes over the transmission line-side switch 85c such that the up-side frequency conversion circuit 252b and the branch circuit 251 are connected to each other when the up-signal intensity within a predetermined range is detected. On the other hand, when the up-signal intensity within the predetermined range is not detected (when it is below a predetermined lower limit level or exceeds a predetermined upper limit level), the switch control circuit 85e changes over the transmission line-side switch 85c such that the down-side frequency conversion circuit 252a and the branch circuit 251 are connected to each other.

The reason why the connection in the up-side is not always established just on condition of the up-signal intensity being not lower than a predetermined level resides in coping with the following case. Because the down-signal intensity is larger than the up-signal intensity as described above, the intensity of the down-signal intensity having crept into the up-side may be still larger than that of the up-signal even after the down-signal is suppressed by the circulator 82d from creeping into the up-side.

Thus, the arrangement shown in FIG. 51 is practically conceivable depending on balance between the down-signal intensity and the up-signal intensity. In general, the arrangement of the wireless-communication RF signal transmission device X4, shown in FIG. 50, is presumably more preferable.

### Sixth Embodiment of Wireless-Communication RF Signal Transmission Device

Further, as shown in FIG. 52, the wireless-communication RF signal transmission device X4 and the wireless-communication RF signal transmission device X5 may be combined into a wireless-communication RF signal transmission device X6 (sixth embodiment).

In the wireless-communication RF signal transmission device X6 of this embodiment, a switch control circuit 86e changes over the transmission line-side switch 85c and the antenna-side switch 84d in accordance with both the results detected by the down-signal detector 84f and the up-signal detector 85f.

FIG. 53 shows logics in changeover of the switches performed by the switch control circuit 86e. While the shown logics represent a combination of logics in both the switch control circuits 84e, 85e, they are indefinite when the down-signal detector 84f and the up-signal detector detect respective signals at the same time. In such a case, the two switches may be set so as to remain in the current state, for example.

The case where the down-signal and the up-signal are both detected at the same time represents the state in which the down-signal and the up-signal collide with each other between the master unit and the slave unit in the wireless LAN. This means a communication error. Usually, because the wireless LAN master unit and slave unit are designed to be able to overcome such a collision with an random back-off algorithm or the like and to ensure that the state of signal collision will not continue, communication is hardly affected in practical use.

### Seventh Embodiment of Wireless-Communication RF Signal Transmission Device

The down- and up-side frequency conversion circuits 252a, 252b in each of the wireless-communication RF signal transmission devices X2, X3, X4, X5 and X6 may be replaced with the down-and up-side frequency conversion circuits 82a, 82b in the wireless-communication RF signal transmission device X1.

FIG. 54 shows one example of such a case in which the down- and up-side frequency conversion circuits 252a, 252b in the wireless-communication RF signal transmission device X6 are replaced with the down- and up-side frequency conversion circuits 82a, 82b in the wireless-communication RF signal transmission device X1. The operation and advantages are the same as those described above.

### Eighth Embodiment of Wireless-Communication RF Signal Transmission Device

In the wireless-communication RF signal transmission devices X4, X5, X6 and X7 in which the connected and disconnected states of up- and down-signal routes are changed over by the switches in accordance with the signals detected by the signal detectors 84f, 85f, signal delay means for delaying transmission of RF signals for wireless communication may be disposed in respective signal routes extending from the down- and up-signal detectors 84f, 85f to the switches 84d, 85c in the antenna-side and the transmission line side.

FIG. 55 shows, as one example of such a case, the arrangement of a wireless-communication RF signal transmission device X8 in which a signal element 88g for delaying transmission of the RF signal for wireless communication is disposed in the signal route extending from the down-signal detector 84f to the antenna-side switch 84d in the wireless-communication RF signal transmission device X4.

If periods of time from the detection of signals by the signal detectors 84f, 85f to changeover of the switches 84d, 85c into the predetermined on/off states are longer than those required for the signals (RF signals for wireless communication) to reach the switches 84d, 85c, preamble portions at the heads of the signals are not normally transmitted.

With the arrangement of the wireless-communication RF signal transmission device X8 shown in FIG. 54, however, by setting a delay time for transmission of the RF signal for wireless communication, which is given by the delay element 88g, to be correspondent to the time from the detection of the signal by the down-signal detector 84f to changeover of the antenna-side switch 84d into the predetermined on/off state, changeover of the route connection is completed simultaneously or just before arrival of the signal to the antenna-side switch 84d, and therefore missing of the signal head portion can be avoided.

### Ninth Embodiment of Wireless-Communication RF Signal Transmission Device

In the wireless LAN system shown in FIG. 45, the central frequencies (transmission line frequencies) fa, fb, fc and fd of RF signals for wireless communication used by the plurality of wireless LAN master units 202 differ from one another, and also differ from the radio frequencies fa_RF, fb_RF and fc_RF. In the case using an existing universal wireless LAN master unit according to the IEEE 802.11 standards, however, the wireless LAN master unit is assumed to directly make communication with the wireless LAN slave unit, and the frequencies usable by the wireless LAN master unit are the radio frequencies fa, fb and fc. Further, an optionally available range of frequency available in use is limited. Accordingly, when a universal wireless LAN master unit is used as the wireless LAN master unit 202, the arrangement of the wireless LAN system shown in FIG. 45 cannot provide the merit that the length of the transmission line can be increased (or the attenuation of transmission can be reduced) by setting the transmission line frequency to a lower frequency. In addition, the number of channels capable of being transmitted with multiplexing of frequency in the transmission line 204 is limited by the number of options of the radio frequencies fa_RF, fb_RF and fc_RF.

To overcome those limitations, a frequency converter for converting the frequency of an RF signal for wireless communication (hereinafter referred to as a “master-side frequency converter”) may be disposed in a signal route between the wireless LAN master unit 202 and the transmission line 204. FIG. 56A schematically shows a wireless LAN system (ninth embodiment) as one example of such a case.

In the wireless LAN system shown in FIG. 56A, master-side frequency converters 209a, 209b, 209c and 209d are disposed between the distributor 203 and the plurality of wireless LAN master units 202a, 202b, 202c and 202d in the wireless LAN system shown in FIG. 45.

In the embodiment of FIG. 56, the wireless LAN master units 202a, 202b, 202c and 202d employ the radio frequencies fa_RF, fb_RF, fc_RF and fa_RF (the frequency used by 202a is the same as that used by 202d), respectively. Therefore, the master-side frequency converters 209a, 209b, 209c and 209d are constituted so as to perform mutual frequency conversion between fa and fa_RF, between fb and fb_RF, between fc and fc_RF, and between fd and fa_RF. The master-side frequency converters 209a, 209b, 209c and 209d can be each realized with a similar arrangement to those of the frequency conversion circuits 252 and 81-88 in the wireless-communication RF signal transmission devices X and X1-X8.

Thus, each of the four wireless LAN master units 202a, 202b, 202c and 202d employs, as shown in FIG. 56B, one of the three kinds of radio frequencies fa_RF, fb_RF and fc_RF. In spite of partial overlap, the frequency components fa, fb, fc and fd of four channels are mapped in the transmission line 204 as multiplexed RF signals for wireless communication with no overlap (i.e., no signal collision). When the RF signal for wireless communication is transmitted from and received by the antenna 253 in the branch section 205, one of the radio frequencies fa_RF, fb_RF and fc_RF is used.

As a result, the existing wireless LAN unit can be used as it is.

Further, as shown in FIG. 56C, the frequency interval between adjacent two of the transmission line frequencies fa, fb, fc and fd can be widened regardless of the frequency interval between adjacent two of the radio frequencies fa_RF, fb_RF and fc_RF. Accordingly, the channel signals (frequencies) can be discriminated from each other without requiring that the band-pass filters 522, 526, 813a and 813b used in the frequency conversion circuits have so sharp cutoff characteristics. This is effective in preventing a malfunction caused by variations in characteristics of the band-pass filters and realizing a cost reduction of the band-pass filters.

While the above embodiments and examples have been described as transmitting RF signals for wireless communication on which a plurality of channel signals (plurality of signals having different frequencies) are superimposed, the present invention is not limited to them. For example, by setting the transmission line frequency (i.e., the frequency of the wireless-communication RF signal in the transmission line 204) to be lower than the radio frequency, the transmission loss of the wireless-communication RF signal in the transmission line 204 can reduced, thus resulting in at least the advantage that the length of the transmission line 204 can be increased. As a result, it is possible to enlarge a communication area covered by one wireless LAN master unit, and to obtain higher uniformity of the intensity of electric waves within the communication area, for example, by installing the transmission line 204 in a zigzag pattern so as to bypass obstacles within the predetermined communication area.

The above-described wireless LAN system accompanies not only the problem of multi-path fading, but also, from an aspect of the wireless LAN base station side, the problem that when a plurality of independent network groups with respective wireless LAN base stations located at centers are spatially formed within the communication area, an area where each wireless LAN mobile station is communicable is greatly restricted depending on radiation characteristics of a base station antenna.

In the above-described wireless LAN system, when a plurality of independent network groups are spatially formed within the communication area, antennas 302A, 302B constituting a plurality of access points (wireless LAN base stations) are usually installed within the communication area spatially away from each other as shown in, by way of example, a perspective view of FIG. 71. To prevent the multi-path fading caused between electric waves radiated from the plurality of the wireless LAN base stations and to form clearly demarcated areas in such a case, power radiated from the antenna at each access point must be adjusted to be reduced so that the area communicable by the wireless LAN slave station is restricted.

Generally, half-wavelength dipole antennas 302A, 302B, shown in the perspective view of FIG. 71, are used as the antennas at those access points (wireless LAN base stations). In this case, the area communicable by each wireless LAN slave station is given by a circle with the position of the dipole antenna 302A or 302B being the center, as represented by a dotted-line circle A or B.

For that reason, a dead zone inevitably occurs in which the wireless LAN slave station cannot be connected to any of the dipole antennas 302A, 302B (access points). Another problem is that, in the case using dipole antennas, because power lines from the antennas 302A, 302B and data lines must be laid on the floor surface, time and labor required for wiring work are increased.

On the other hand, there is known a method of using, instead of the dipole antennas, a plurality of planar antennas having high directivity, such as the patch antennas used in FIG. 33, and orienting the planar antennas to face in multiple directions so that a wide communication is ensured.

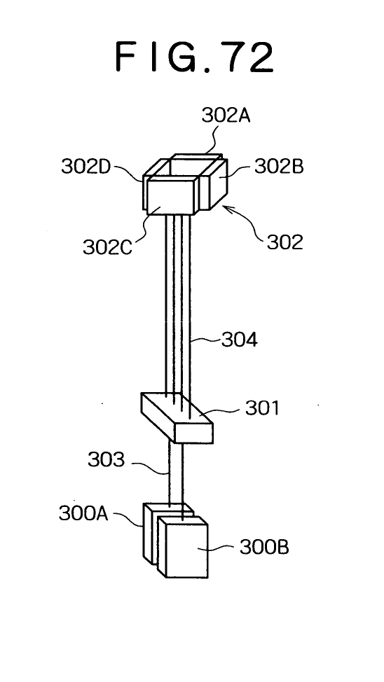

FIG. 72 is a perspective view showing a known example using those planar antennas. In FIG. 72, for example, four planar antennas 302A, 302B, 302C and 302D are disposed in four directions, respectively, and are connected to two access points (wireless LAN base stations) 300A, 300B via a switch-combining/distributing circuit 301 by a connector 303 and a coaxial cable 304.

When the above-mentioned plurality of independent network groups are spatially formed using those planner antennas, the switch-combining/distributing circuit 301 is controlled to perform changeover of selective connection between the two access points 300A, 300B and the four planar antennas 302A, 302B, 302C and 302D.

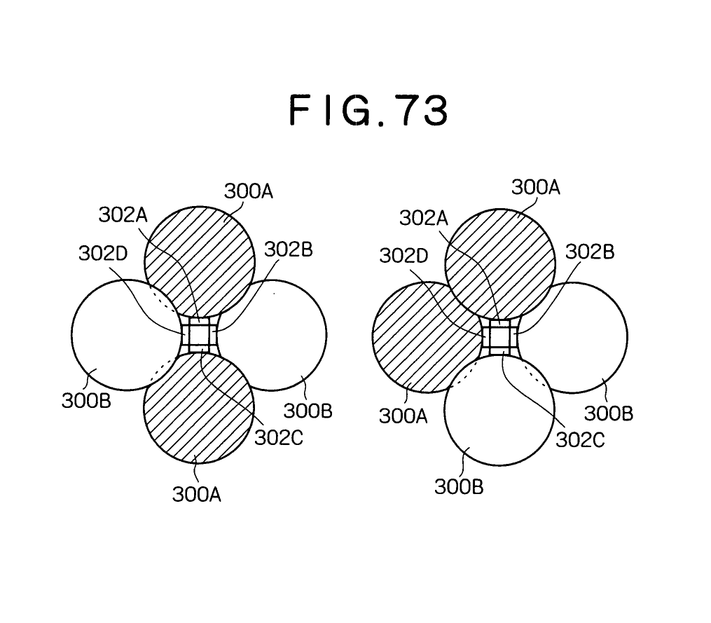

A plan view of FIG. 73 shows communicable areas covered by the two access points 300A, 300B in the form of circles. In FIG. 73, by way of example, the communicable areas covered by the access point 300A are represented by hatched circles, and the communicable areas covered by the access point 300B are represented by plain circles. Further, the switch-combining/distributing circuit 301 connects the access point 3000A to the planar antennas 302A, 302C oriented to face upward and downward as viewed on the drawing, and also connects the access point 300B to the planar antennas 302B, 302D oriented to face leftward and rightward as viewed on the drawing.

Accordingly, when the plurality (two in the example of FIG. 73) of independent network groups are spatially formed by using the access points and the respective coverage areas are changed over, the generation of a dead zone with the use of the dipole antennas can be avoided by using the above-described planner antennas.

A description is now made on the construction of the wireless LAN antenna which does not restrict a communicable area and enables a wireless LAN mobile station to have a wide communication area without noticeably increasing a cost in a wireless LAN system in which a plurality of network groups are spatially formed by using the wireless LAN antenna of the present invention in, particularly, the wireless LAN base station.

(Wireless LAN System Forming Plurality of Network Groups)

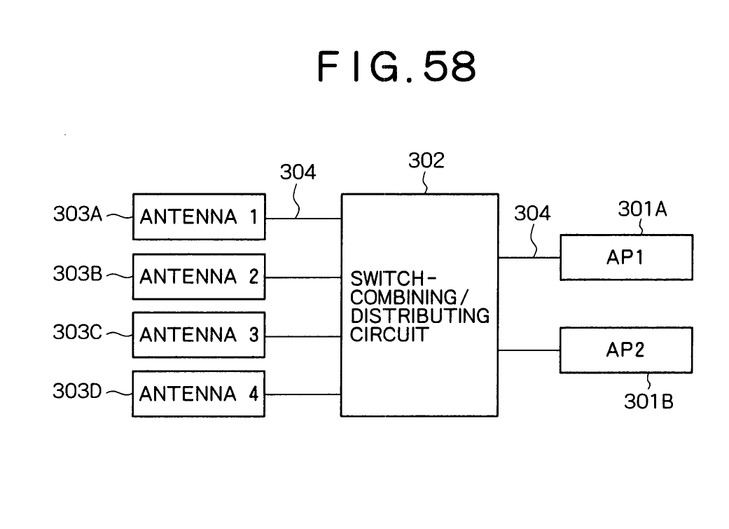

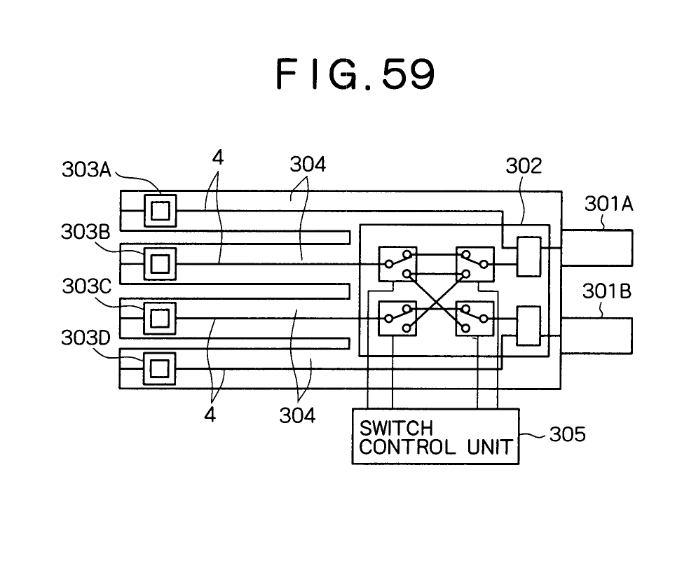

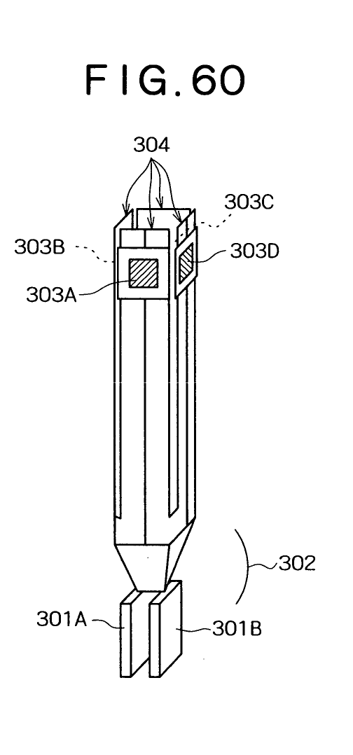

FIG. 58 is a block diagram showing an example of a system in the wireless LAN base station side in which a plurality of independent network groups are spatially formed. FIG. 59 is a view showing an antenna structure embodying the system in the wireless LAN base station side shown in FIG. 58. FIG. 60 is a perspective view showing the wireless LAN base station side in FIG. 59 with the antenna structure being in an assembled state.

In FIG. 58, two access points (wireless LAN base stations) 301A, 301B are connected to four antenna elements 303A, 303B, 303C and 303D via a switch-combining/distributing circuit 302 by high-frequency lines 304, which have the same structure as the micro-strip line 1a shown in FIG. 34, etc., instead of the connector 303 and the coaxial cable 304 used in the related art shown in FIG. 72.

In FIG. 59, the four antenna elements 303A, 303B, 303C and 303D of the wireless LAN base station are each formed of a patch antenna having the same structure as the patch antenna shown in FIG. 35. Those patch antennas 303A, 303B, 303C and 303D are disposed on respective signal lines 4 of the high-frequency lines 304 at one ends (left ends as viewed on the drawing) of the high-frequency lines 304 and are electrically coupled to the signal lines 4.

In FIG. 58, numeral 305 denotes a control circuit (that is the same as the antenna control circuit 124 in FIG. 39) for the switch-combining/distributing circuit 302.

In FIG. 60 showing the wireless LAN base station side in the assembled state of those components, the two access points (wireless LAN base stations) 301A, 301B are connected, by the high-frequency lines 304, to the four antenna elements 303A, 303B, 303C and 303D disposed at the respective ends of the high-frequency lines 304 via the switch-combining/distributing circuit 302. Further, the four antenna elements 303A, 303B, 303C and 303D are oriented to face four directions (forward, backward, leftward and rightward as viewed on the drawing) so that a wide communication area is ensured in the four directions.

With the structure described above, signals from the two access points 301A, 301B are controlled by the switch-combining/distributing circuit 302 such that those signals are selectively transmitted for communication from which ones of the antenna elements 303A, 303B, 303C and 303D. Then, the signals are transmitted through the high-frequency lines 304 and radiated in the four directions from the four antenna elements 303A, 303B, 303C and 303D disposed at the ends of the high-frequency lines 304. Accordingly, the wireless LAN base stations arranged to be capable of transmitting and receiving the wireless LAN signals in the four directions can be assembled as desired.

As a result, it is possible to prevent the generation of a dead zone in the wireless LAN mobile station side, to ensure a wide communication area, and to spatially form a plurality of network groups as desired. Further, because the connector 303 and the coaxial cable 304 used in the related art, shown in FIG. 72, are not used, the cost is avoided from increasing with an increase in amount of wiring, and a practically realistic wireless LAN system can be provided even in a wide communication area.

On that occasion, by controlling the communication states with the switch-combining/distributing circuit 302 so as to change over the transmitting/receiving states of a plurality of circular polarized antenna elements which are disposed on the high-frequency lines and differ in polarization-plane rotating directions from each other, the plurality of independent network groups can be spatially formed, as desired, so that high-frequency waves for the wireless LAN system can be transmitted between the wireless LAN base stations and the wireless LAN mobile stations at a higher bit-rate in a wider communication area.

The above-mentioned effect is further enhanced by changing over the transmitting/receiving states of the plurality of circular polarized antenna elements in units of a set given by at least one pair of the circular polarized antenna elements differing in polarization-plane rotating directions from each other.

(Double-Sided Antenna)

The antenna elements 303A-303D each disposed on one side of the high-frequency line 304 have directivity of about ±45° and therefore hardly have directivity toward the backside of the antenna elements. By arranging the antenna elements on both sides of the high-frequency lines 304, an antenna having directivity originating from both the sides of the high-frequency lines 304 can be formed and a more efficient antenna can be constituted in comparison with the case where the antenna elements are disposed on one side (hereinafter referred to as a “one-sided antenna”).

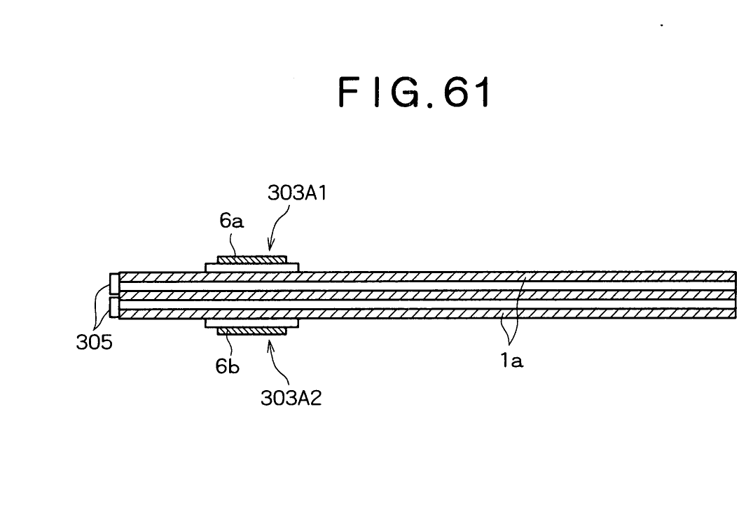

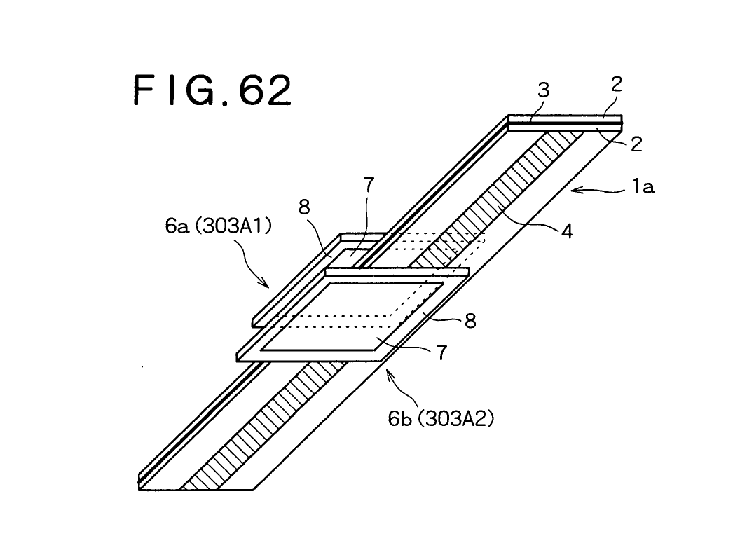

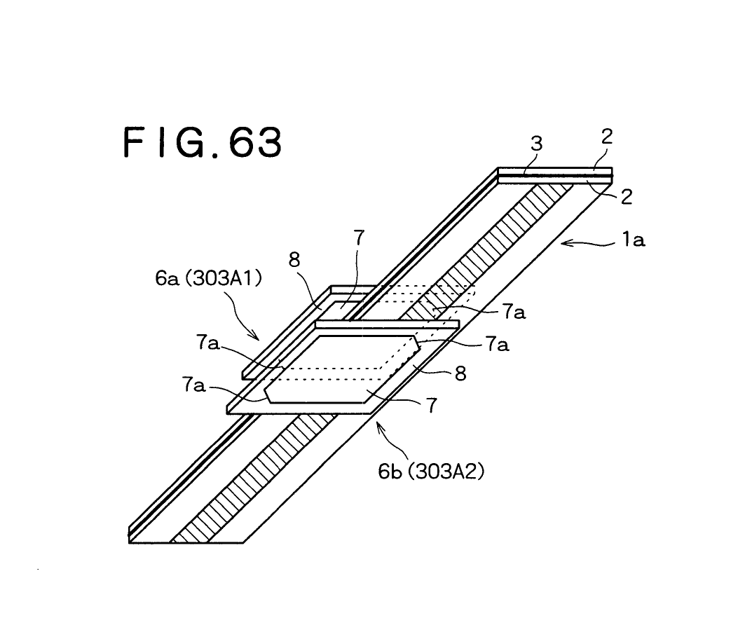

Detailed structures of such a both-sided antenna including the antenna elements on both the sides of the high-frequency lines will be described below with reference to FIGS. 61-63. FIG. 61 is a sectional view of the double-sided antenna, FIG. 62 is a perspective view of the double-sided antenna shown in FIG. 61, and FIG. 63 is a perspective view showing another example of the double-sided antenna.

Referring to FIG. 61, numerals 1a, 1a denote two high-frequency micro-strip lines, and 305, 305 denote terminators of the lines 1a, 1a. Numerals 303A1 and 303A2 denote antenna elements disposed respectively on the lines 1a, 1a, and 6a, 6b denote patch antennas of the antenna elements 303A1, 303A2.

As shown in FIGS. 62 and 63, the double-sided antenna has a structure resulting from bonding two one-sided antennas, each shown in FIG. 35, in back-to-back relation with the antenna elements faced outward. More specifically, two high-frequency micro-strip lines, each shown in FIG. 35, are bonded to each other such that the two lines share a ground layer 3 (FIG. 62) and the antenna elements 303 are disposed on the respective lines substantially in the same positions.

As seen from FIG. 62, the structure of the high-frequency line 1a in the direction of section (thickness) thereof is the same as that shown in FIG. 34. More specifically, on the ground layer 3 made of a conductive material, a dielectric layer 2 made of a dielectric material and a signal line 4 made of a conductive material and inducing a high-frequency wave are successively laid. Also, the antenna elements 303A1, 303A2 are constituted by the patch antennas 6a, 6b having the same structure as that shown in FIG. 59 or 35. More specifically, each of the patch antennas 6a, 6b comprises a dielectric plate 8 made of a dielectric material and a patch (radiation plate) 7 made of a conductive material, which are successively laid into a layered structure. Then, each patch antenna is disposed on the signal line 4 and is electrically coupled to the signal line 4.

The antenna and the patch antennas 6a, 6b shown in FIG. 63 have the same basic structure as that shown in FIG. 62. To make each patch antenna serve as a circular polarized antenna with a proper polarization-plane rotating direction, however, two diagonal corners of the patch 7 having a quadrilateral (rectangular) shape is cut out as indicated by 7a similarly to the patch antenna shown in FIG. 35. In FIG. 63, the patch antennas 6a, 6b on both the sides are each constituted as a leftward circular polarized antenna element with a left-handed rotating direction.

In the case using the both-sided antenna described above, one or more kinds of signals from the same or different wireless LAN access points (e.g., 301A, 301B) can be transmitted to the high-frequency lines 1a, 1a. Another advantage is that the both-sided antenna has a smaller size than the one-sided antennas shown in FIGS. 36-42 and the one-sided antenna shown in FIGS. 58-60, and more compact antenna elements can be realized in each of the wireless LAN base station side and the wireless LAN mobile station terminal side.

In addition, the antenna made up of the circular polarized antenna elements arranged alternately as described above is advantageous in not causing a point between the antenna elements where the intensity of an electric field is so sharply reduced as compared with the ordinary horizontal and vertical polarization (linear polarization) antenna elements.

### Embodiments in Use of Both-Sided Antenna

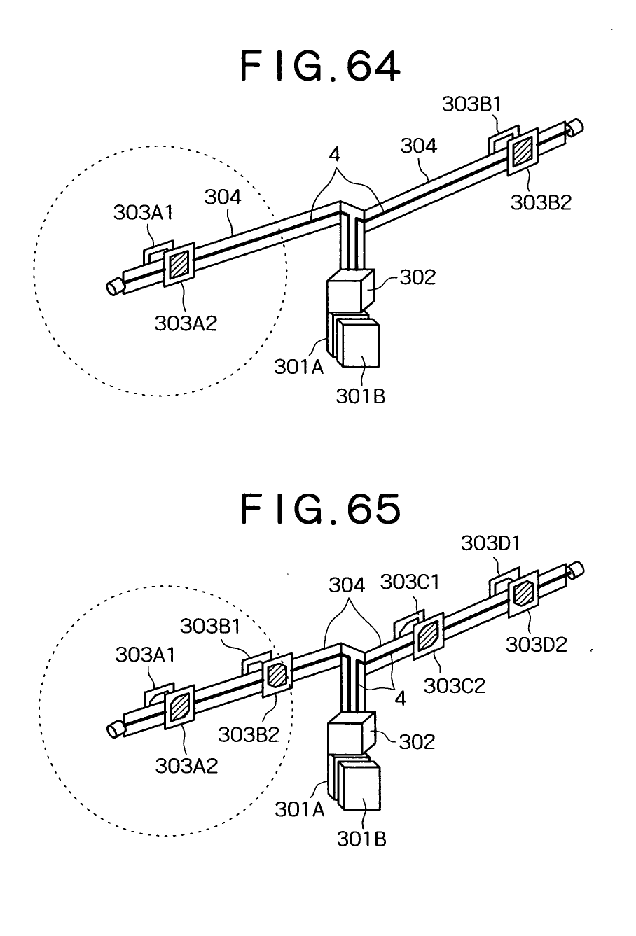

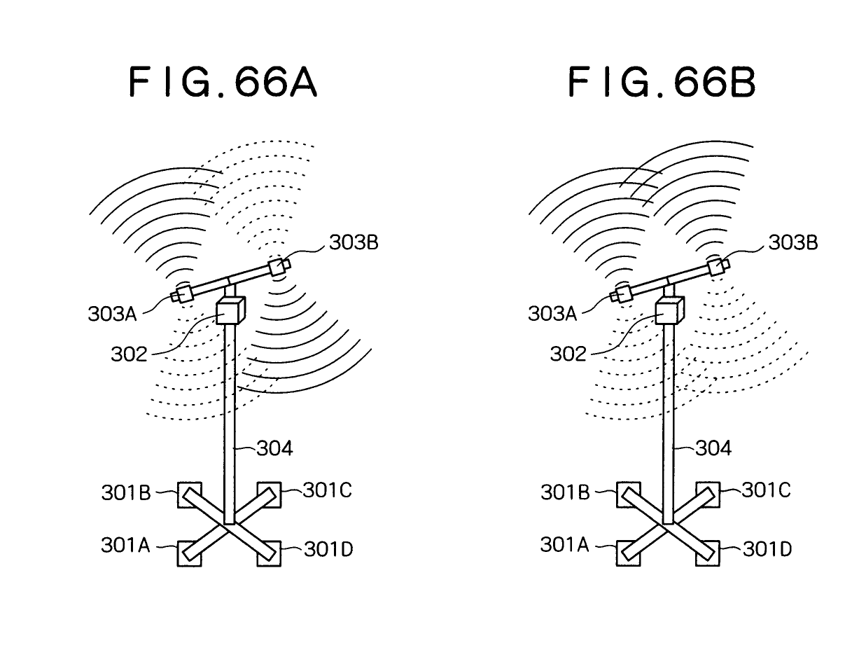

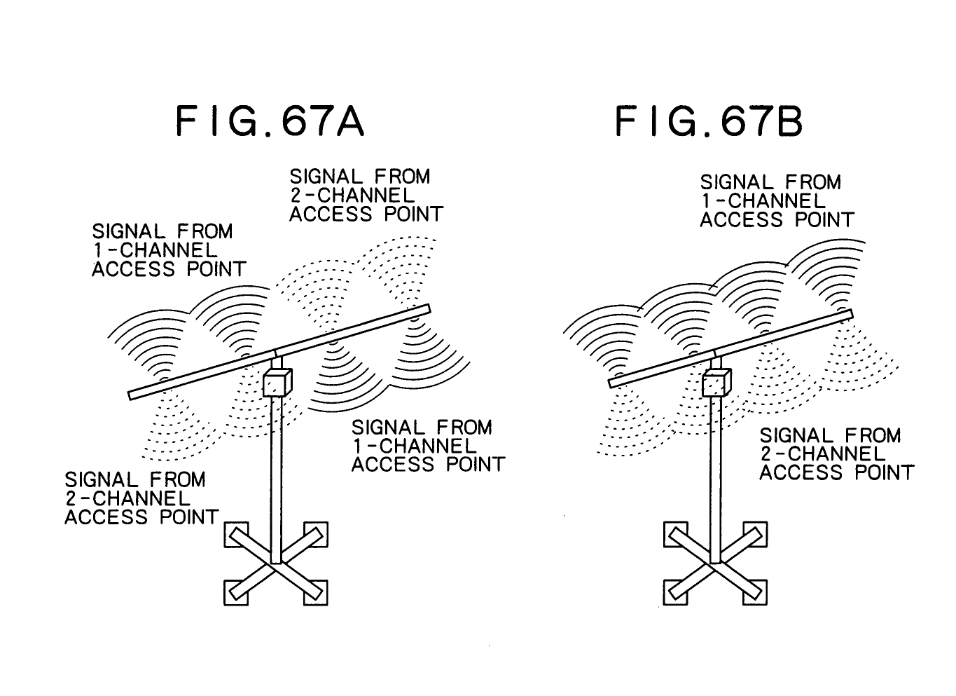

FIGS. 64 and 65 are perspective views showing embodiments of the wireless LAN base station using the both-sided antennas. Also, FIGS. 66 and 67 are perspective views showing respective patterns of electric waves radiated from the wireless LAN base stations shown in FIGS. 64 and 65.

In each of the embodiments shown in FIGS. 64 and 65, the high-frequency lines 304 connected to the two access points (wireless LAN base stations) 301A, 301B is branched to extend in the directions differing 180° from each other, i.e., to the left and right as viewed on the drawings. Then, on both sides of each of the branched high-frequency lines 304, two pairs of antenna elements 303A1-303A2 and 303B1-303B2, or four pairs of antenna elements including additional two pairs 303C1-303C2 and 303D1-303D2 in FIG. 65, are disposed substantially in the same positions for each pair at certain intervals between the pairs.

Thus, the antenna elements 303A, 303B, 303C and 303D are located far away from each other in the directions to the left and right, as viewed on the drawings, depending on the length of the branched high-frequency lines 304, thereby ensuring a wider communication area in the directions in which both the sides of each high-frequency line 304 face (i.e., in the directions to the front and back as viewed on the drawings).

With the arrangement described above, signals from the two access points 301A, 301B are controlled by the switch-combining/distributing circuit 302 such that those signals are selectively transmitted for communication from which ones of the antenna elements 303A, 303B, 303C and 303D. Then, the signals are transmitted through the branched high-frequency lines 304 and radiated in the directions to the left and right or to the front and back, as viewed on the drawings, from the four antenna elements 303A, 303B, 303C and 303D disposed on both the sides of the high-frequency lines 304, as shown in the perspective views of FIGS. 66A, 66B, 67A and 67B.

FIGS. 66A, 66B, 67A and 67B show the states of radiation signals when communication areas are changed over by the switch-combining/distributing circuit 302 while using the two base stations (access points 301A, 301B) shown in FIGS. 64 and 65. When the two base stations transmit signals in the same direction, they can be operated as one network group. When the two base stations transmit signals in the directions differing 180° from each other, they can be operated as two separate network groups.

In FIGS. 66A, 66B, 67A and 67B, concentrically spreading waves indicated by solid lines represent the signals radiated from, e.g., the two access points 301A, 301B, and concentrically spreading waves indicated by dotted lines represent the signals radiated from, e.g., the access point 301B.

Stated another way, FIGS. 66A and 67A show the case where the access points 301A, 301B operate as the same network group (i.e., constitute one group). FIGS. 66B and 67B show the case where a network group constituted by the access point 301A and a network group constituted by the access point 301B are separated into two different groups.

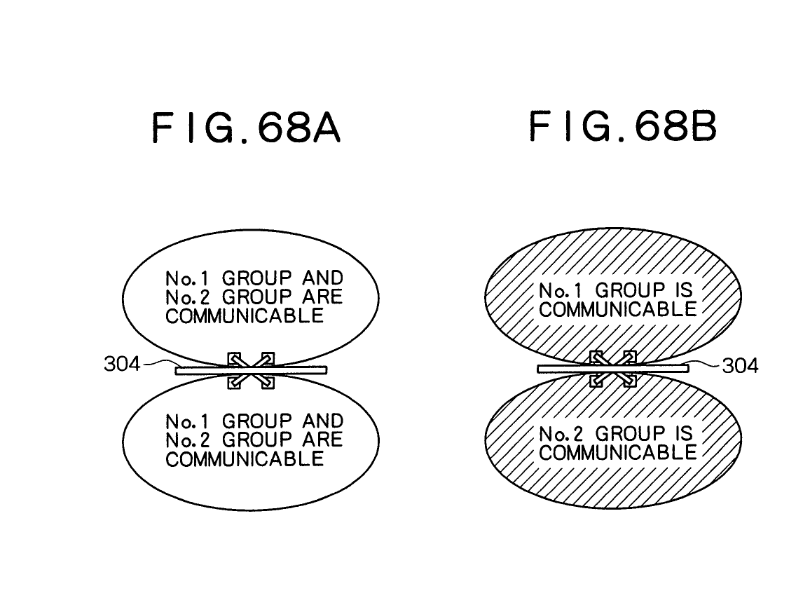

FIGS. 68A represents electric wave patterns of signals radiated from the respective access points when the two access points constitute one group (same group) as shown in FIGS. 66A and 67A. FIG. 68B represents those electric wave patterns when the two access points constitute two groups (different groups) as shown in FIGS. 66B and 67B. When the two access points constitute one group (same group) as shown in FIGS. 66A and 67A, wireless LAN mobile stations belonging to the same network group constituted by the access points 301A, 301B are capable of performing communication on both the sides of the high-frequency line 304 as shown in FIG. 68A.

Also, when the two access points constitute two groups (different groups) as shown in FIGS. 66B and 67B, only wireless LAN mobile station (No. 1 or No. 2 group) belonging to the same network group constituted by the access point 301A or 301B is capable of performing communication on one of both the sides of the high-frequency line 304 as shown in FIG. 68B.

As described above, by using the double-sided antenna, one or two kinds of signals from the same or different access points can be selectively transmitted to each of the high-frequency lines 1a, 1a bonded to each other. Therefore, the antenna according to this embodiment can more freely select from which ones of the antenna elements 303A, 303B, 303C and 303D the signals radiated from the access points 301A, 301B are to be transmitted for communication. Also, it is possible to more flexibly select the arrangement of wireless LAN base stations capable of transmitting and receiving wireless LAN signals, and to constitute a wireless LAN network group with a particular wireless LAN base station serving as the center.

The above-described double-sided antenna can be used as the antenna element shown in FIG. 33 in both of the wireless LAN base station and the wireless LAN mobile station terminals in order to prevent the multi-path fading caused depending on communication environments and the wireless LAN base station. Further, applying the double-sided antenna to the wireless LAN system shown in FIG. 38 results in the effect of restraining a reduction in transmitting and reception power caused depending on the position of the mobile station terminal antenna. Application of the double-sided antenna to the embodiments using the terminal wireless LAN card 105 in the wireless LAN mobile station as shown in FIG. 33 and utilizing the wireless LAN system shown in FIG. 38 can be realized by replacing the antennas used in those embodiments with the double-sided antennas.

(Materials of Antenna Element)

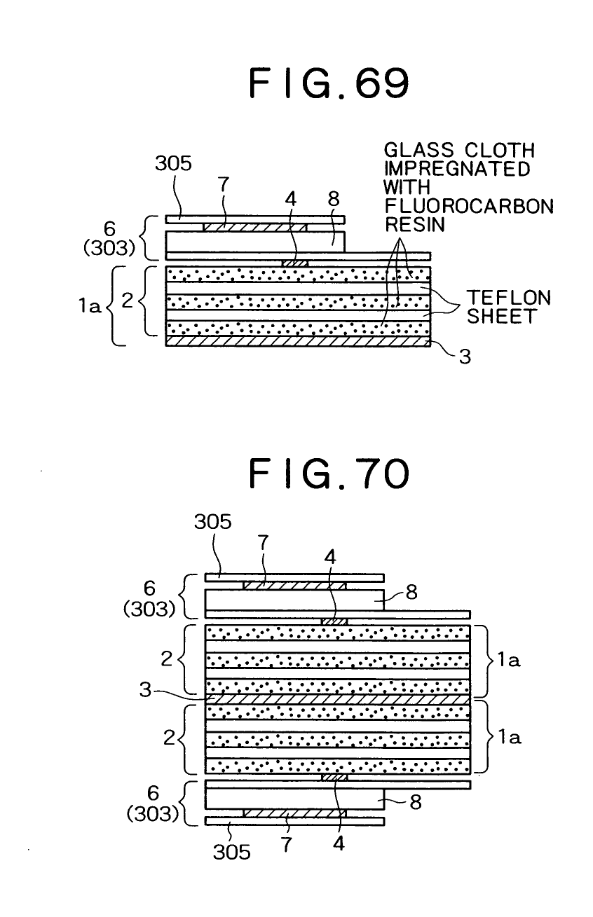

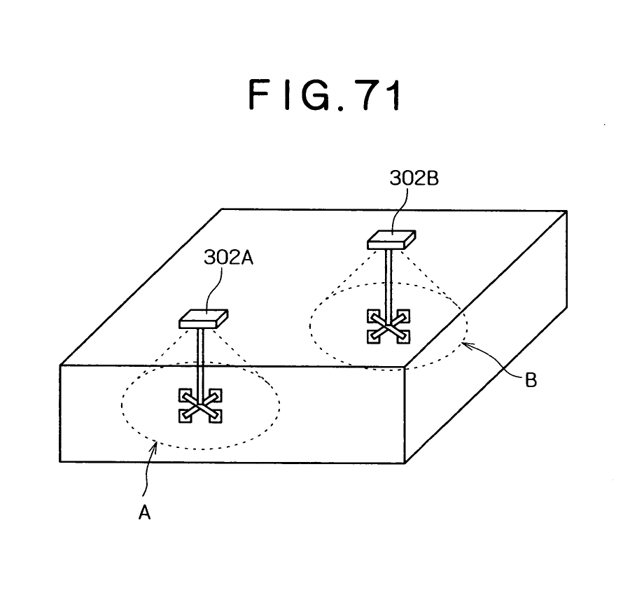

Although the materials of the antenna elements and the high-frequency lines used in this embodiment have been described above, preferable examples of those materials will be described below with reference to the drawings in connection with the case where a plurality of network groups are spatially formed using the wireless LAN antennas. FIG. 69 is a sectional view of the one-sided antenna according to the embodiment in the direction of section (thickness), and FIG. 70 is a sectional view showing the double-sided antenna according to the embodiment in the direction of section (thickness).

Referring to FIG. 69, a layered structure includes, from below, the ground layer 3 made of a conductive material and formed of a copper foil, the dielectric layer 2 made of a dielectric material and formed of a laminate of a Teflon sheet and a piece of glass cloth impregnated with a fluorocarbon resin, and the signal line 4 made of a conductive material and formed of a copper foil. That layered structure constitutes the high-frequency micro-strip line (high-frequency line) 1a.

In the antenna element 6 (303) in FIG. 69, the dielectric plate 8 made of a dielectric material is in the form of a Teflon sheet, and the patch (radiation plate) 7 made of a conductive material is in the form of a copper foil. Further, a top cover 305, which is selectively provided, is in the form of a Teflon sheet.

FIG. 70 shows a structure in which two high-frequency micro-strip lines (high-frequency lines) 1a, each shown in FIG. 69, are bonded in back-to-back relation on both sides of the ground layer 3 as a common layer with the respective antenna elements 6 (303) faced outward. The antenna elements 303 are disposed on opposite sides of the lines 1a in each pair substantially in the same positions.

As described above, the embodiment can provide a wireless LAN antenna, a control method for the wireless LAN antenna, a wireless LAN base station antenna, a wireless LAN mobile-station terminal antenna, a wireless LAN card for a terminal, and a wireless LAN system, which have succeeded in solving not only the problem caused by the multi-path fading, i.e., the restriction on communication areas coverable by the wireless LAN mobile stations, but also the problem of the restriction on communication areas of the wireless LAN mobile stations from the wireless LAN base station side, and hence which give rise no restrictions on communicable areas of the wireless LAN mobile stations. Accordingly, great industrial values can be obtained with capabilities of, e.g., eliminating serious restrictions that have been inevitable in the known wireless LAN system, and widely increasing applications of the wireless LAN system.

### INDUSTRIAL APPLICABILITY

The present invention provides a wireless-communication RF signal transmission device suitably applicable to the case where communication environments are set for each of building rooms, or the case where communication environments are set for each of partitioned unit spaces, such as cars of a train. Also, the present invention can provide a high-frequency line for use in a wireless LAN system, which has superior basic characteristics as a high-frequency line in points such as capable of being easily manufactured in long size and allowing a high-frequency wave to propagate with a low loss. Consequently, the restrictions on the wireless LAN system attributable to the structure of the known high-frequency line are eliminated, and a wireless-communication RF signal transmission line can be provided which has a great industrial value in points such as being able to widely increase applications of the wireless LAN system.

1. A high-frequency micro-strip line for transmitting a high-frequency wave for a wireless LAN system, wherein said high-frequency micro-strip line has a layered structure in which a dielectric layer made of a dielectric material and a signal line made of a conductive material are successively laid on a ground layer made of a conductive material, and said signal line is electrically coupled to patch antennas each comprising a dielectric plate made of a dielectric material and a patch made of a conductive material which are successively laid into a layered structure.

2. The high-frequency micro-strip line according to claim 1, wherein said patch antennas are disposed just upward of said signal line.

3. The high-frequency micro-strip line according to claim 1, wherein said patch antennas are disposed near said signal line, and said patch antennas are coupled to said signal line by a feeder.

4. The high-frequency micro-strip line according to claim 1, wherein a coupling ratio between predetermined one or more of said patch antennas and said signal line is adjusted by changing a relative position of a center axis of the predetermined patch antenna with respect to a center axis of said signal line.

5. The high-frequency micro-strip line according to claim 4, wherein said relative position of the center axis of the predetermined patch antenna is changed by changing a direction of the predetermined patch antenna in a plane.

6. The high-frequency micro-strip line according to claim 1, wherein directivity of the predetermined patch antenna is controlled by giving a phase difference to high-frequency waves fed to said patch antennas.

7. The high-frequency micro-strip line according to claim 6, wherein said phase difference is given by adjusting an interval between predetermined ones of said patch antennas.

8. The high-frequency micro-strip line according to claim 6, wherein said phase difference is given by adjusting a length of said feeder for the predetermined patch antenna.

9. The high-frequency micro-strip line according to claim 1, wherein an end of said high-frequency micro-strip line is shaped to have a predetermined slope angle in plan view, and two high-frequency micro-strip lines are spliced to each other at respective ends each having the predetermined slope angle.

10. The high-frequency micro-strip line according to claim 1, wherein said high-frequency micro-strip line has a bent portion in match with a shape of a service area.

11. The high-frequency micro-strip line according to claim 1, wherein a certain spacing is left between a surface of said patch antenna and an installation surface of said high-frequency micro-strip line, and a radiating section of said patch antenna is isolated at surroundings thereof.

12. The high-frequency micro-strip line according to claim 1, wherein said high-frequency micro-strip line propagates high-frequency waves having different frequencies, and said patch antennas are constituted as two or more kinds of patch antennas for transmitting and receiving the high-frequency waves having different frequencies, respectively.

13. The high-frequency micro-strip line according to claim 1, wherein said high-frequency micro-strip line propagates high-frequency waves having different frequencies, and said patch antennas are constituted as rectangular patch antennas for transmitting and receiving the high-frequency waves having different frequencies, respectively.

14. The high-frequency micro-strip line according to claim 1, wherein opposite ends of said high-frequency micro-strip line including said patch antennas electrically coupled thereto are connected to coaxial cables via coaxial connectors, and said high-frequency micro-strip line thus connected serves as a high-frequency micro-strip line type antenna in the interconnected coaxial cables.

15. The high-frequency micro-strip line according to claim 14, wherein a plurality of said high-frequency micro-strip line type antennas and a plurality of said coaxial cables are alternately connected, and a high-frequency terminator or said patch antenna is connected to a terminal end of the alternately connected antennas and coaxial cables.

16. The high-frequency micro-strip line according to claim 1, wherein a patch generating a circularly polarized wave is used in the patch antenna constituting said high-frequency micro-strip line type antenna, and patches generating a right-handed circularly polarized wave and a left-handed circularly polarized wave are alternately connected.

17. A wireless LAN antenna adapted for a wireless LAN mobile-station terminal antenna for communicating a high-frequency wave for a wireless LAN system with respect to a wireless LAN base station including antennas constituted as a plurality of circular polarized antenna elements which differ in polarization-plane rotating directions from each other and are disposed on a high-frequency line at intervals between said antenna elements, wherein said wireless LAN antenna has a structure in which high-frequency micro-strip lines each having a dielectric layer and a signal line successively laid on a ground layer are arranged adjacent to each other substantially in parallel, wherein the plurality of circular polarized antenna elements differing in polarization-plane rotating directions are arranged alternately at intervals therebetween on each of said high-frequency micro-strip lines, and wherein said circular polarized antenna elements differing in polarization-plane rotating directions are arranged adjacent to each other on said high-frequency micro-strip lines substantially in the same positions.

18. The wireless LAN antenna according to claim 17, wherein said high-frequency line for said wireless LAN base station antenna has a high-frequency micro-strip line structure in which a dielectric layer and a signal layer are successively laid on a ground layer.

19. The wireless LAN antenna according to claim 17, wherein said circular polarized antenna elements in said wireless LAN base station antenna are disposed to face in different normal directions from each other.

20. The wireless LAN antenna according to claim 17, wherein said wireless LAN system includes a switch for electrically controlling transmitting/receiving states of said circular polarized antenna elements.

21. The wireless LAN antenna according to claim 17, wherein said wireless LAN antenna is the wireless LAN mobile-station terminal antenna.

22. The wireless LAN antenna according to claim 17, wherein said wireless LAN antenna is the wireless LAN base station antenna.

23. A wireless LAN antenna used in a wireless LAN system for communicating a high-frequency wave for a wireless LAN system between a wireless LAN base station and a wireless LAN mobile station, wherein said wireless LAN antenna comprises a high-frequency line having a high-frequency micro-strip line structure in which a dielectric layer and a signal layer are successively laid on a ground layer, and a plurality of circular polarized antenna elements which are disposed on said high-frequency line and differ in polarization-plane rotating directions from each other, wherein said plurality of circular polarized antenna elements differing in polarization-plane rotating directions are disposed on said high-frequency line at intervals therebetween, said circular polarized antenna elements being disposed on both sides of said high-frequency line.

24. The wireless LAN antenna according to claim 23, wherein said high-frequency line has a high-frequency micro-strip line structure in which a plurality of signal lines are laid on a base plate made up of a ground layer and a dielectric layer.

25. The wireless LAN antenna according to claim 24, wherein said circular polarized antenna elements are arranged on said plurality of signal lines substantially in the same positions.

26. The wireless LAN antenna according to claim 25, wherein said circular polarized antenna elements arranged on said plurality of signal lines substantially in the same positions are the circular polarized antenna elements differing in polarization-plane rotating directions from each other.

27. The wireless LAN antenna according to claim 23, wherein said wireless LAN system includes a control unit for controlling transmitting/receiving states of said plurality of said circular polarized antenna elements.

28. The wireless LAN antenna according to claim 27, wherein said control unit is a control circuit for changing over the transmitting/receiving states of said plurality of circular polarized antenna elements.

29. The wireless LAN antenna according to claim 27, wherein said high-frequency line has a high-frequency micro-strip line structure in which a plurality of signal lines are laid on a base plate made up of a ground layer and a dielectric layer, and said control unit is a control circuit for changing over connected/disconnected states of said plurality of signal lines disposed on said base plate.

30. A wireless LAN card for a terminal wherein a terminal antenna has a structure in which high-frequency micro-strip lines each having a dielectric layer and a signal line successively laid on a ground layer are arranged adjacent to each other substantially in parallel, wherein the plurality of circular polarized antenna elements differing in polarization-plane rotating directions are arranged alternately at intervals therebetween on each of said high-frequency micro-strip lines, and wherein said circular polarized antenna elements differing in polarization-plane rotating directions are arranged adjacent to each other on said high-frequency micro-strip lines substantially in the same positions is incorporated in said card.

31. A wireless LAN system forming a radio communication network between a wireless LAN mobile station including a terminal antenna that has a structure in which high-frequency micro-strip lines each having a dielectric layer and a signal line successively laid on a ground layer are arranged adjacent to each other substantially in parallel, wherein the plurality of circular polarized antenna elements differing in polarization-plane rotating directions are arranged alternately at intervals therebetween on each of said high-frequency micro-strip lines, and wherein said circular polarized antenna elements differing in polarization-plane rotating directions are arranged adjacent to each other on said high-frequency micro-strip lines substantially in the same positions and a wireless LAN base station including antennas constituted as a plurality of circular polarized antenna elements which differ in polarization-plane rotating directions from each other and are alternately disposed on a high-frequency line at intervals between said antenna elements.

32. A wireless-communication RF signal transmission device for transmitting RF signals for wireless communication transmitted and received between predetermined higher-level unit and lower-level unit, said wireless-communication RF signal transmission device comprising:
a transmission line connected to said higher-level unit and transmitting RF signals for wireless communication;
branching/joining means disposed on said transmission line at a plurality of points for branching and joining RF signals for wireless communication with respect to said transmission line;
a radio antenna disposed for each of said branching/joining means for transmitting and receiving RF signals for wireless communication with respect to said lower-level unit via radio;
frequency downconversion means connected between each of said branching/joining means and the corresponding radio antenna, converting a frequency of the wireless-communication RF signal branched by said branching/joining means, and outputting the frequency-converted wireless-communication RF signal to said radio antenna; and
frequency upconversion means connected between each of said branching/joining means and the corresponding radio antenna, converting a frequency of the wireless-communication RF signal received by said radio antenna, and outputting the frequency-converted wireless-communication RF signal to said branching/joining means.

33. A wireless-communication RF signal transmission device for transmitting RF signals for wireless communication transmitted and received between predetermined higher-level unit and lower-level unit, said wireless-communication RF signal transmission device comprising:
one or more transmission lines directly or indirectly connected to said higher-level unit and transmitting RF signals for wireless communication;
branching/joining means disposed on said transmission lines at a plurality of points for branching and joining RF signals for wireless communication with respect to said transmission lines;
a radio antenna disposed for each of said branching/joining means for transmitting and receiving RF signals for wireless communication with respect to said lower-level unit via radio; and
a radio antenna disposed at one or more points between said predetermined higher-level unit and said one or more transmission lines and between said plurality of transmission lines for transmitting and receiving wireless-communication RF signals communicated therebetween.

34. The wireless-communication RF signal transmission device according to claim 33, further comprising:
frequency upconversion means and/or up-signal amplifying or attenuating means connected between said higher-level unit or said transmission line and said radio antenna, said frequency upconversion means converting a frequency of the wireless-communication RF signal of a transmitted up-signal and outputting the frequency-converted wireless-communication RF signal, said up-signal amplifying or attenuating means changing the intensity of the up-signal; and
frequency downconversion means and/or down-signal amplifying or attenuating means connected between said higher-level unit or said transmission line and said radio antenna, said frequency downconversion means converting a frequency of the wireless-communication RF signal of a transmitted down-signal and outputting the frequency-converted wireless-communication RF signal, said down-signal amplifying or attenuating means changing the intensity of the down-signal.

35. A wireless-communication RF signal transmission device for transmitting RF signals for wireless communication transmitted and received between predetermined higher-level unit and lower-level unit, said wireless-communication RF signal transmission device comprising:
a transmission line connected to said higher-level unit and transmitting RF signals for wireless communication;
branching/joining means disposed on said transmission line at a plurality of points for branching and joining RF signals for wireless communication with respect to said transmission line;
a radio antenna disposed for each of said branching/joining means for transmitting and receiving RF signals for wireless communication with respect to said lower-level unit via radio;
frequency downconversion means connected between each of said branching/joining means and the corresponding radio antenna, converting a frequency of the wireless-communication RF signal branched by said branching/joining means, and outputting the frequency-converted wireless-communication RF signal to said radio antenna; and
frequency upconversion means connected between each of said branching/joining means and the corresponding radio antenna, converting a frequency of the wireless-communication RF signal received by said radio antenna, and outputting the frequency-converted wireless-communication RF signal to said branching/joining means.

36. The wireless-communication RF signal transmission device according to any one of claims 32 to 35, wherein said frequency downconversion means and said frequency upconversion means comprise:
one frequency oscillator;
separate frequency mixers for mixing inputted RF signals for wireless communication and an oscillation signal from said one frequency oscillator; and
separate band-pass filters for receiving output signals from said frequency mixers.

37. The wireless-communication RF signal transmission device according to any one of claims 32 to 35, wherein each of said frequency downconversion means and said frequency upconversion means comprises:
first and second frequency oscillators variable in oscillation frequency;
a first frequency mixer for mixing an inputted RF signal for wireless communication and an oscillation signal from said first frequency oscillator;
a band-pass filter for receiving output signals from said first frequency mixer; and
a second frequency mixer for mixing an output signal from said band-pass filter and an oscillation signal from said second frequency oscillator.

38. The wireless-communication RF signal transmission device according to claim 35, further comprising one or both of a first circulator and a second circulator,
said first circulator interconnecting said branching/joining means, said frequency downconversion means, and said frequency upconversion means,
said second circulator interconnecting said radio antenna, said frequency downconversion means, and said frequency upconversion means.

39. The wireless-communication RF signal transmission device according to any one of claims 32 to 35, further comprising one or both of a transmission line-side switch and an antenna-side switch,
said transmission line-side switch changing over connection of said branching/joining means to one of said frequency downconversion means and said frequency upconversion means,
said antenna-side switch changing over connection of said radio antenna to one of said frequency downconversion means and said frequency upconversion means,
each of said switches being changed over in accordance with a predetermined changeover signal from said higher-level unit.

40. The wireless-communication RF signal transmission device according to any one of claims 32 to 35, further comprising:
an antenna-side switch for changing over connection of said radio antenna to one of said frequency downconversion means and said frequency upconversion means,
signal intensity detecting means for detecting the signal intensity of the wireless-communication RF signal in said frequency downconversion means; and
switch control means for changing over said antenna-side switch in accordance with a result detected by said signal intensity detecting means.

41. The wireless-communication RF signal transmission device according to claim 38, further comprising a circulator for interconnecting said branching/joining means, said frequency downconversion means, and said frequency upconversion means.

42. The wireless-communication RF signal transmission device according to any one of claims 32 to 35, further comprising:
a transmission line-side switch for changing over connection of said branching/joining means to one of said frequency downconversion means and said frequency upconversion means;
a circulator interconnecting said radio antenna, said frequency downconversion means, and said frequency upconversion means;
signal intensity detecting means for detecting the signal intensity of the wireless-communication RF signal in said frequency upconversion means; and
switch control means for changing over said transmission line-side switch in accordance with a result detected by said signal intensity detecting means.

43. The wireless-communication RF signal transmission device according to any one of claims 32 to 35, further comprising:
a transmission line-side switch for changing over connection of said branching/joining means to one of said frequency downconversion means and said frequency upconversion means;
an antenna-side switch for changing over connection of said radio antenna to one of said frequency downconversion means and said frequency upconversion means,
first signal intensity detecting means for detecting the signal intensity of the wireless-communication RF signal in said frequency downconversion means;
second signal intensity detecting means for detecting the signal intensity of the wireless-communication RF signal in said frequency upconversion means; and
switch control means for changing over said switches in accordance with results detected by said first and second signal intensity detecting means.

44. The wireless-communication RF signal transmission device according to claim 38, further comprising delay means disposed at one or both of points between said frequency downconversion means and said antenna-side switch and between said frequency upconversion means and said transmission line-side switch for delaying transmission of the RF signal for wireless communication.

45. The wireless-communication RF signal transmission device according to any one of claims 32 to 35, wherein said transmission line is one of a tubular waveguide, a coaxial cable, and a strip line.

46. The wireless-communication RF signal transmission device according to any one of claims 32 to 35, wherein communication between said higher-level unit and said lower-level unit is performed based on the TDD method.

47. The wireless-communication RF signal transmission device according to any one of claims 32 to 35, wherein said radio antenna is an antenna with directivity.

48. The wireless-communication RF signal transmission device according to claim 36, further comprising one or both of a first circulator and a second circulator,
said first circulator interconnecting said branching/joining means, said frequency downconversion means, and said frequency upconversion means,
said second circulator interconnecting said radio antenna, said frequency downconversion means, and said frequency upconversion means.

49. The wireless-communication RF signal transmission device according to claim 37, further comprising one or both of a first circulator and a second circulator,
said first circulator interconnecting said branching/joining means, said frequency downconversion means, and said frequency upconversion means,
said second circulator interconnecting said radio antenna, said frequency downconversion means, and said frequency upconversion means.

50. The wireless-communication RF signal transmission device according to claim 48, further comprising a circulator for interconnecting said branching/joining means, said frequency downconversion means, and said frequency upconversion means.

51. The wireless-communication RF signal transmission device according to claim 49, further comprising a circulator for interconnecting said branching/joining means, said frequency downconversion means, and said frequency upconversion means.

52. The wireless-communication RF signal transmission device according to claim 48, further comprising delay means disposed at one or both of points between said frequency downconversion means and said antenna-side switch and between said frequency upconversion means and said transmission line-side switch for delaying transmission of the RF signal for wireless communication.

53. The wireless-communication RF signal transmission device according to claim 49, further comprising delay means disposed at one or both of points between said frequency downconversion means and said antenna-side switch and between said frequency upconversion means and said transmission line-side switch for delaying transmission of the RF signal for wireless communication.

54. The wireless-communication RF signal transmission device according to claim 39, further comprising delay means disposed at one or both of points between said frequency downconversion means and said antenna-side switch and between said frequency upconversion means and said transmission line-side switch for delaying transmission of the RF signal for wireless communication.

55. The wireless-communication RF signal transmission device according to claim 40, further comprising delay means disposed at one or both of points between said frequency downconversion means and said antenna-side switch and between said frequency upconversion means and said transmission line-side switch for delaying transmission of the RF signal for wireless communication.

56. The wireless-communication RF signal transmission device according to claim 41, further comprising delay means disposed at one or both of points between said frequency downconversion means and said antenna-side switch and between said frequency upconversion means and said transmission line-side switch for delaying transmission of the RF signal for wireless communication.
